(19) United States
(12) Patent Application Publication
(10) Pub. No.: US 2019/0056315 A1
(43) Pub. Date: Feb. 21, 2019

(54) SPECTRAL BLENDER

(71) Applicant: Verifood, Ltd., Herzliya (IL)

(72) Inventors: Uri KINROT, Hod HaSharon (IL); Damian GOLDRING, Tel-Aviv (IL); Sagee ROSEN, Netzer Sireni (IL); Omer KEILAF, Kfar Saba (IL); Oren BUSKILA, Givataim (IL); Eli ZLATKIN, Tel-Aviv (IL); Idan BAKISH, Petah-Tikva (IL); Liron Nunez WEISSMAN, Rosh-Haayin (IL); Assaf CARMI, Modiin (IL); Mor WILK, Tel Aviv-Yafo (IL); Elyaqim Oster OSTER, Modiin (IL)

(21) Appl. No.: 15/917,439

(22) Filed: Mar. 9, 2018

Related U.S. Application Data
(63) Continuation of application No. PCT/IL2016/051059, filed on Sep. 25, 2016.
(60) Provisional application No. 62/233,057, filed on Sep. 25, 2015.
(60) Provisional application No. 62/240,376, filed on Oct. 12, 2015.

(51) Int. Cl. G01N 21/31; G01J 3/02; G01J 3/28; B01F 15/00

(52) U.S. Cl. CPC G01N 21/3151; G01J 3/0291; G01J 2003/2866; B01F 15/00207; G01J 2003/2806; G01J 3/2803

(57) ABSTRACT

A compact spectrometer system comprising a light source and a spectrometer module and methods of using a spectrometer to determine information related to a property of a mixture are provided. One or more light sources are used to direct light into a mixture. One or more spectrometer modules are used to receive light from a mixture. One or more spectra are measured in response to the received light. A property of the mixture is determined in response to measured spectra.

### CROSS-REFERENCE

This application is a bypass continuation of PCT Application Serial No. PCT/IL2016/051059, filed Sep. 25, 2016, entitled “Spectral Blender” (attorney docket no. 45151-714.601), which claims the benefit of U.S. Provisional Application No. 62/233,057, filed Sep. 25, 2015, entitled “Spectral Blender” (attorney docket no. 45151-714.101) and U.S. Provisional Application No. 62/240,376, filed Oct. 12, 2015, entitled “Spectral Blender” (attorney docket no. 45151-714.102), the entire disclosures of which are incorporated herein by reference for all purposes.

The subject matter of the present application is related to U.S. Provisional Application Ser. No. 62/112,553, filed on Feb. 5, 2015, entitled “Spectrometry System with Visible Aiming Beam” (attorney docket no. 45151-706.101), U.S. Provisional Application Ser. No. 62/154,585, filed on Apr. 29, 2015, entitled “Spectrometry System with Visible Aiming Beam” (attorney docket no. 45151-706.102), U.S. Provisional Application Ser. No. 62/161,728, filed on May 14, 2015, entitled “Spectrometry System with Visible Aiming Beam” (attorney docket no. 45151-706.103), each of which is incorporated herein by reference in its entirety.

The subject matter of the present application is related to U.S. patent application Ser. No. 14/702,422, filed May 1, 2015, entitled “Spectrometry System with Diffuser”, (attorney docket number 45151-702.301); U.S. Pat. App. Ser. No. 62/112,592, filed Feb. 5, 2015, entitled “Accessories for Handheld Spectrometer” (attorney docket no. 45151-705.103), the entire disclosures of which are incorporated herein by reference.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND OF THE INVENTION

Mixing or blending ingredients to attain a desired mixture is used in many industrial fields, including chemical manufacturing, pharmaceutical manufacturing, and materials engineering. These industrial mixing processes, however, are generally large and complex and not well suited to be integrated into smaller, more accessible applications. Also, there is a need for improved spectral methods and apparatus that can be used with a wide variety of materials, such as both low and high scattering materials.

Prior methods and apparatus for blending food can be less than ideal in at least some respects. For example, people can be interested in the nutrients they eat, and it would be helpful if people had more information about the food that they eat. Prior blenders, however, are less than ideally suited for providing information about the food they contain. For example, in at least some instances, people will weigh or measure food to determine an estimate of the calories and nutrients. Measuring food and calculating calories and nutrients can be time consuming. Also, determining nutrients from such measurements are based on assumptions of the contents of the food and generally do not measure the ingredients of the food. In at least some instances, the actual contents of the food may not be what are assumed to be present. In addition food borne illnesses make many people sick each year, and prior art blenders are less than ideally suited to detect pathogens and degraded food. Food may also contain impurities such as melamine, for example, and prior blenders are not well suited to detect impurities in food.

Although spectrometers have been proposed for use with blenders for industrial applications and pharmaceuticals, such prior blenders and spectrometers may not be well suited for household blenders and can be overly complex. Also, food preparations can present a wide variety of materials, which can include both low scattering and highly scattering materials, as well as translucent, transparent, or opaque food preparations. For example, food can include materials such as fruits, vegetables, and flours which can be highly scattering, or transparent materials such as water.

In light of the above it would be desirable to provide improved blenders with spectrometers that overcome at least some of the aforementioned problems with the prior art.

### SUMMARY OF THE INVENTION

The spectrometer methods and apparatus disclosed herein are capable of measuring one or more properties of a mixture. The methods and apparatus can be configured in many ways to measure a property of a mixture reliably, conveniently, invasively or non-invasively, with ease of use, and in real time or with a small time delay of approximately a few seconds or minutes or less. The spectrometer methods and apparatus disclosed herein can determine information related to a property of a mixture from measured spectra that include information associated with the mixture. The spectral data can be used to determine a property of a mixture, such as food composition and nutrients. Although specific reference is made to a spectrometer apparatus for use with a blender to prepare food at home, the methods and apparatus disclosed herein will find applications in many fields, such as industrial mixers, laboratory equipment, chemical mixers, and cement mixers.

The methods and apparatus can be configured in many ways. The mixer may comprise a spectrometer configured with a light beam to illuminate the mixture and an optics component configured to provide spectral data of scattered light received from the mixture to a detector such as an array detector. A remote or local processor coupled to the array detector can be configured with instructions to determine a property of the mixture. The light beam can be configured to illuminate one or more regions of a mixture inside the blender. The one or more regions may comprise a region such as an area illuminated with a measurement beam or a plurality of separate regions illuminated with a plurality of beams. The plurality of separate beams can illuminate the mixture within a field of view of the spectrometer, or away from the field of view of the spectrometer such as away from an aperture of the spectrometer. The one or more illumination regions can be on the same side of the mixture or mixer as the measurement region or an opposite side of the measurement region. The one or more beams may illuminate the mixture at regions away from a field of view of the spectrometer to provide spectral data of light traveling through the mixture. The one or more beams may comprise a predetermined spectral energy profile distribution over a range of wavelengths in order to improve accuracy of the measurements.

According to one aspect of the invention there are provided methods and apparatus comprising a miniature spectrometer system integrated into a blender. One or more spectrometer components such as the light source, the spectrometer or associated circuitry can be integrated with the housing of the blender or a base of the blender, and combinations thereof.

The processor can be configured in many ways with instructions to determine the one or more properties of the mixture in response to light received from a measurement region of the mixture. The processor can be configured with instructions to determine the property of the mixture in response to spectral data received from a one or more illumination regions corresponding to one or more regions of the mixture. Alternatively or in combination, the processor can be configured to determine the property of the mixture in response to a plurality of spectral measurements of a plurality of wavelengths from a plurality of times. The processor can be configured to determine a property of the mixture in response to the plurality of spectral signals and to isolate one or more spectral components related to one or more ingredients or properties.

In some instances, one or more light sources are used to direct light into a mixture. One or more spectrometer modules may be used to receive light from a mixture. One or more spectra may be measured in response to the received light.

The blenders disclosed herein may be used to prepare food blends and different types of drinks including, but not limited to, smoothies, shakes, etc. In some cases, users are generally consumers such as home cooks or professional consumers (“prosumers”) or producers like restaurants, food vendors, and professional chefs. Consumers may be interested to know, for example in real-time while blending, the content of the blend, for example, fat, carbohydrates, protein, water, calories, salt, alcohol, vitamins, etc. and accordingly add or remove ingredients in the blend.

Accordingly, one aspect of the present disclosure provides a method for determining a property of a mixture, the method comprising: mixing a mixture in a mixing container, the mixing container comprising a housing and a mixing component, wherein the mixing the mixture comprises contacting the mixture with the mixing component as the mixing component moves, wherein the mixing component is separate from the housing and movable independent of the housing; directing a light from a light source into the mixture in the mixing container; receiving, at a spectrometer module, a portion of the light from the mixture in the mixing container; and determining a property of the mixture in response to the received light.

One aspect of the present disclosure provides a method for determining a property of a mixture, the method comprising: mixing a mixture in a mixing container; pouring at least a portion of the mixture out of the mixing container; directing a light from the light source into the mixture as the mixture is poured; receiving, at the spectrometer module, a portion of the light from the mixture as the mixture is poured; and determining a property of the mixture in response to the received light.

One aspect of the present disclosure provides a method for determining a property of a mixture, the method comprising: positioning a light source and a spectrometer module within a mixing container; mixing a mixture in the mixing container; directing a light from the light source into the mixture; receiving, at a spectrometer module, a portion of the light from the mixture; and determining a property of the mixture in response to the received light.

One aspect of the present disclosure provides a method for determining a property of a mixture, the method comprising: mixing a mixture in the mixing container; directing a light from a light source into the mixture; receiving, at a spectrometer module, a portion of the light from the mixture, wherein a light blocker is located between the light source and the spectrometer module; and determining a property of the mixture in response to the received light.

In some instances, for any one of the methods described herein, a housing of the mixing container remains substantially fixed during the mixing the mixture. In some instances, for any one of the methods described herein, the mixing container comprises a housing. In some instances, for any one of the methods described herein, the mixing container comprises a mixing component. In some instances, for any one of the methods described herein, the mixing the mixture comprises contacting the mixture with a mixing component. In some instances, for any one of the methods described herein, the mixing component is a blade. In some instances, for any one of the methods described herein, the mixing container comprises a light blocker located between a housing of the mixing container and the light source and/or the spectrometer module. In some instances, for any one of the methods described herein, the mixing container comprises a diffuser. In some instances, for any one of the methods described herein, the mixing container comprises a reflective element.

In some instances, for any one of the methods described herein, the method further comprises positioning the light source with respect to the mixing container. In some instances, for any one of the methods described herein, the method further comprises positioning the light source within the mixing container. In some instances, for any one of the methods described herein, the light source is coupled to a lid of the apparatus through a moveable rod.

In some instances, for any one of the methods described herein, the method further comprises positioning the spectrometer module with respect to the mixing container. In some instances, for any one of the methods described herein, the method further comprises positioning the spectrometer module within the mixing container. In some instances, for any one of the methods described herein, the spectrometer module is coupled to a lid of the apparatus through a moveable rod.

In some instances, for any one of the methods described herein, a light blocker is positioned with respect to the mixing container between the light source and the spectrometer. In some instances, for any one of the methods described herein, the method further comprises positioning a light blocker within the mixing container.

In some instances, for any one of the methods described herein, the method further comprises measuring a spectrum of the received light. In some instances, for any one of the methods described herein, the property of the mixture is determined in response to the measured spectrum of the received light.

In some instances, for any one of the methods described herein, the method further comprises calibrating the light source or spectrometer module.

In some instances, for any one of the methods described herein, the method further comprises adding one or more ingredients of the mixture to the mixing container.

In some instances, for any one of the methods described herein, the method further comprises directing a second light into the mixture and receiving a portion of the second light from the mixture.

In some instances, for any one of the methods described herein, the separation distance of the light is within the range from 5 mm to 30 mm. In some instances, for any one of the methods described herein, the separation distance of the second light is within the range from 5 mm to 30 mm.

In some instances, for any one of the methods described herein, the light and second light are directed from one light source. In some instances, for any one of the methods described herein, the light and second light are directed from different light sources. In some instances, for any one of the methods described herein, the first light and second light are directed at different times.

In some instances, for any one of the methods described herein, the method further comprises measuring a second spectrum of the received second light.

In some instances, for any one of the methods described herein, the light comprises a wavelength within the range from 350 nm to 1100 nm. In some instances, for any one of the methods described herein, the light source has a power within the range from 0.1 mW to 500 mW.

In some instances, for any one of the methods described herein, the directing a light into the mixture and the receiving a portion of the light from the mixture are repeated one or more times. In some instances, for any one of the methods described herein, the directing a second light into the mixture and the receiving a portion of the second light from the mixture are repeated one or more times. In some instances, for any one of the methods described herein, the method further comprises directing a third light into the mixture and receiving a portion of the third light from the mixture.

In some instances, for any one of the methods described herein, the directing a light into the mixture and the receiving a portion of the light from the mixture are repeated at a measurement rate of at least 1 per second. In some instances, for any one of the methods described herein, the measurement rate is at least 10 per second, such as at least 30 per second.

In some instances, for any one of the methods described herein, the method further comprises using a separate sensor to determine a temperature of the mixture. In some instances, for any one of the methods described herein, the method further comprises using a separate sensor to determine an orientation of the mixing container.

In some instances, for any one of the methods described herein, the method further comprises measuring a property selected from the group consisting of composition, phase, homogeneity, heterogeneity, stability, solubility, uniformity, density, concentration, consistency, particle size, viscosity, dispersion, miscibility, nutrient content, and any combination thereof.

In some instances, for any one of the methods described herein, the mixture comprises a liquid. In some instances, for any one of the methods described herein, the mixture comprises a solid. In some instances, for any one of the methods described herein, the mixture comprises water.

In some instances, for any one of the methods described herein, the light source and the spectrometer module are coupled to the mixing container.

One aspect of the present disclosure provides an apparatus for determining a property of a mixture in a mixing container, the apparatus comprising: a mixing container comprising a housing and a mixing component, wherein the mixing component is separate from the housing and movable independent of the housing; one or more light sources to direct a light into the mixture; one or more spectrometer modules to receive a portion of the light from the mixture; and a processor configured with instructions to determine the property of the mixture.

One aspect of the present disclosure provides an apparatus for determining a property of a mixture in a mixing container, the apparatus comprising: a mixing container comprising a housing; one or more light sources to direct a light into the mixture, and wherein the one or more light sources are positioned on a spout of the housing; one or more spectrometer modules to receive a portion of the light from the mixture, wherein the one or more spectrometer modules are positioned on the spout; and a processor configured with instructions to determine the property of the mixture.

One aspect of the present disclosure provides an apparatus for determining a property of a mixture in a mixing container, the apparatus comprising: a mixing container; one or more light sources to direct a light into the mixture, wherein the one or more light sources are positioned within the mixing container, and wherein the positions of the one or more light sources are adjustable within the mixing container; one or more spectrometer modules to receive a portion of the light from the mixture, wherein the one or more spectrometer modules are positioned within the mixing container, and wherein the positions of the one or more spectrometer modules are adjustable within the mixing container; and a processor configured with instructions to determine the property of the mixture.

One aspect of the present disclosure provides an apparatus for determining a property of a mixture in a mixing container, the apparatus comprising: a mixing container comprising one or more light blockers; one or more light sources to direct a light into the mixture; one or more spectrometer modules to receive a portion of the light from the mixture, wherein one or more light blockers is arranged to block light from the one or more sources to the one or more spectrometer modules; and a processor configured with instructions to determine the property of the mixture.

In some instances, for any one of the apparatuses described herein, the apparatus is hand held. In some instances, for any one of the apparatuses described herein, the apparatus is battery powered. In some instances, for any one of the apparatuses described herein, the apparatus comprises a blender. In some instances, for any one of the apparatuses described herein, the apparatus is washable.

In some instances, for any one of the apparatuses described herein, the one or more light sources are positioned with respect to the mixing container. In some instances, for any one of the apparatuses described herein, the one or more light sources are positioned within the mixing container. In some instances, for any one of the apparatuses described herein, the one or more light sources are positioned externally to the mixing container. In some instances, for any one of the apparatuses described herein, the one or more light sources are coupled to the mixing container. In some instances, for any one of the apparatuses described herein, the one or more light sources are coupled to a lid of the apparatus. In some instances, for any one of the apparatuses described herein, the one or more light sources are coupled to a lid of the apparatus through a moveable rod. In some instances, for any one of the apparatuses described herein, the one or more light sources are positioned near a spout of the housing. In some instances, for any one of the apparatuses described herein, the one or more light sources are integrated into the housing of the mixing container. In some instances, for any one of the apparatuses described herein, the positions of the one or more light sources are adjustable.

In some instances, for any one of the apparatuses described herein, the one or more spectrometer modules are positioned with respect to the mixing container. In some instances, for any one of the apparatuses described herein, the one or more spectrometer modules are positioned within the mixing container. In some instances, for any one of the apparatuses described herein, the one or more spectrometer modules are positioned externally to the mixing container. In some instances, for any one of the apparatuses described herein, the one or more spectrometer modules are coupled to the mixing container. In some instances, for any one of the apparatuses described herein, the one or more spectrometer modules are coupled to a lid of the apparatus. In some instances, for any one of the apparatuses described herein, the one or more spectrometer modules are coupled to a lid of the apparatus through a moveable rod. In some instances, for any one of the apparatuses described herein, the one or more spectrometer modules are positioned near a spout of the housing. In some instances, for any one of the apparatuses described herein, the one or more spectrometer modules are integrated into the housing of the mixing container. In some instances, for any one of the apparatuses described herein, the positions of the one or more spectrometer modules are adjustable.

In some instances, for any one of the apparatuses described herein, the mixing container comprises a housing.

In some instances, for any one of the apparatuses described herein, the mixing container comprises one or more light blockers. In some instances, for any one of the apparatuses described herein, the one or more light blockers are positioned with respect to the mixing container. In some instances, for any one of the apparatuses described herein, the one or more light blockers are positioned within the mixing container. In some instances, for any one of the apparatuses described herein, the one or more light blockers are positioned externally to the mixing container. In some instances, for any one of the apparatuses described herein, the one or more light blockers are coupled to the mixing container. In some instances, for any one of the apparatuses described herein, the one or more light blockers are integrated into the housing of the mixing container. In some instances, for any one of the apparatuses described herein, the positions of the one or more light blockers are adjustable.

In some instances, for any one of the apparatuses described herein, the apparatus further comprises a diffuser. In some instances, for any one of the apparatuses described herein, the apparatus further comprises a reflective element. In some instances, for any one of the apparatuses described herein, the apparatus further comprises a mixing component shield.

In some instances, for any one of the apparatuses described herein, the apparatus comprises one light source. In some instances, for any one of the apparatuses described herein, the apparatus comprises more than one light source.

In some instances, for any one of the apparatuses described herein, the apparatus comprises one spectrometer module. In some instances, for any one of the apparatuses described herein, the apparatus comprises more than one spectrometer module.

In some instances, for any one of the apparatuses described herein, the determining the property of the mixture comprises measuring a spectrum in response to the portion of the light from the mixture.

In some instances, for any one of the methods or apparatuses described herein, the light source and the spectrometer are arranged with a blocker to inhibit internal reflections of the housing. In some cases, the blocker prevents transmission of light from the illumination module or light source to the spectrometer module without passing through the measured substance (e.g., the mixture, flowable material, and/or fluid). In some instances, for any one of the methods or apparatuses described herein, the light source and the spectrometer are arranged with a blocker to inhibit internal reflections of one or more of a window or a transparent housing. In some instances, for any one of the methods or apparatuses described herein, the light source module and the spectrometer module are arranged to engage the blocker to inhibit internal reflections of the one or more of the window or the transparent housing.

In some instances, for any one of the methods or apparatuses described herein, the container comprises an annular channel and the light source and the spectrometer are arranged to measure the mixture within the annular channel. In some instances, for any one of the methods or apparatuses described herein, the annular channel is located below the mixing component, and wherein the annular channel located at the bottom of the mixing container, and wherein the illumination module directs the light towards the spectrometer module. In some instances, for any one of the methods or apparatuses described herein, the light source is positioned on an outer wall of the annular channel, and wherein the spectrometer module is located on an inner wall of the annular channel. In some instances, for any one of the methods or apparatuses described herein, the light source is positioned on an inner wall of the annular channel, and wherein the spectrometer module is located on an outer wall of the annular channel.

In some instances, for any one of the methods or apparatuses described herein, one or more optical fibers, optical light pipes, or optical light guides are coupled to the illumination module to guide light from the illumination module to the mixture. In some instances, for any one of the methods or apparatuses described herein, one or more optical fibers, optical light pipes, or optical light guides are coupled to the spectrometer to guide light from the mixture to the spectrometer module.

In some instances, for any one of the methods or apparatuses described herein, a processor is configured with instructions to calibrate the spectrometer coupled to the container. In some instances, for any one of the methods or apparatuses described herein, a processor coupled to a user interface comprises instructions for a user to place a calibration material within the container to calibrate the spectrometer module and to remove the calibration material from the container to measure the mixture. In some instances, for any one of the methods or apparatuses described herein, a calibration cover comprises a calibration material to reflect light from the illumination module toward the spectrometer module and wherein the calibration cover comprises an opaque material to block ambient light from reaching the spectrometer module. In some instances, for any one of the methods or apparatuses described herein, a calibration cover comprises a calibration material to reflect light from the illumination module toward the spectrometer module and wherein the calibration cover comprises a lid comprising an opaque material to block ambient light from reaching the spectrometer module. In some instances, for any one of the methods described herein, a calibration material is placed in an optical path within the container to calibrate the spectrometer and removed from the container to measure the mixture. In some instances, for any one of the methods or apparatuses described herein, the container is a cup or bottle. In some instances, for any one of the methods or apparatuses described herein, the processor is external to the apparatus, mixing container, or container. In some instances, for any one of the methods or apparatuses described herein, the processor is located in an external mobile device (e.g., smart phone or tablet). In some instances, for any one of the methods or apparatuses described herein, the processing or the determining the property may be performed in the cloud, by the mobile device, or by the apparatus.

In some instances, for any one of the methods described herein, the directing a light occurs during the mixing. In some instances, for any one of the methods described herein, the receiving a portion of the light occurs during the mixing. In some instances, for any one of the methods described herein, the determining a property of the mixture occurs during the mixing. In some instances, for any one of the methods described herein, the method further comprises indicating completion of the mixing in response to spectral data.

One aspect of the present disclosure provides a method for determining a property of a flowable material and/or fluid, the method comprising: providing a flowable material and/or fluid in a container; directing a light from a light source into the flowable material and/or fluid in the container; receiving, at a spectrometer module, a portion of the light from the flowable material and/or fluid in the container; and determining a property of the flowable material and/or fluid in response to the received light.

One aspect of the present disclosure provides a method for determining a property of a flowable material and/or fluid, the method comprising: providing a flowable material and/or fluid in a container; pouring at least a portion of the flowable material and/or fluid out of the container; directing a light from the light source into the flowable material and/or fluid as the flowable material and/or fluid is poured; receiving, at the spectrometer module, a portion of the light from the flowable material and/or fluid as the flowable material and/or fluid is poured; and determining a property of the flowable material and/or fluid in response to the received light.

One aspect of the present disclosure provides a method for determining a property of a flowable material and/or fluid, the method comprising: positioning a light source and a spectrometer module within a container; providing a flowable material and/or fluid in a container; directing a light from the light source into the flowable material and/or fluid; receiving, at a spectrometer module, a portion of the light from the flowable material and/or fluid; and determining a property of the flowable material and/or fluid in response to the received light.

One aspect of the present disclosure provides a method for determining a property of a flowable material and/or fluid, the method comprising: providing a flowable material and/or fluid in a container; directing a light from a light source into the flowable material and/or fluid; receiving, at a spectrometer module, a portion of the light from the flowable material and/or fluid, wherein a light blocker is located between the light source and the spectrometer module; and determining a property of the flowable material and/or fluid in response to the received light.

One aspect of the present disclosure provides an apparatus for determining a property of a flowable material and/or fluid in a container, the apparatus comprising: a container; one or more light sources to direct a light into the flowable material and/or fluid; one or more spectrometer modules to receive a portion of the light from the flowable material and/or fluid; and a processor configured with instructions to determine the property of the flowable material and/or fluid.

One aspect of the present disclosure provides an apparatus for determining a property of a flowable material and/or fluid in a container, the apparatus comprising: a container; one or more light sources to direct a light into the flowable material and/or fluid, and wherein the one or more light sources are positioned on a spout, recessed channel, wall, or base of the container; one or more spectrometer modules to receive a portion of the light from the flowable material and/or fluid, wherein the one or more spectrometer modules are positioned on the spout, recessed channel, wall, or base; and a processor configured with instructions to determine the property of the flowable material and/or fluid.

One aspect of the present disclosure provides an apparatus for determining a property of a flowable material and/or fluid in a container, the apparatus comprising: a container; one or more light sources to direct a light into the flowable material and/or fluid, wherein the one or more light sources are positioned within the container, and wherein the positions of the one or more light sources are adjustable within the container; one or more spectrometer modules to receive a portion of the light from the flowable material and/or fluid, wherein the one or more spectrometer modules are positioned within the container, and wherein the positions of the one or more spectrometer modules are adjustable within the container; and a processor configured with instructions to determine the property of the flowable material and/or fluid.

One aspect of the present disclosure provides an apparatus for determining a property of a flowable material and/or fluid in a container, the apparatus comprising: a container comprising one or more light blockers; one or more light sources to direct a light into the flowable material and/or fluid; one or more spectrometer modules to receive a portion of the light from the flowable material and/or fluid, wherein one or more light blockers is arranged to block light from the one or more sources to the one or more spectrometer modules; and a processor configured with instructions to determine the property of the flowable material and/or fluid.

One aspect of the present disclosure provides a cup for determining a property of a flowable material and/or fluid located in the cup, the cup comprising: one or more light sources to direct a light into the flowable material and/or fluid; one or more spectrometer modules to receive a portion of the light from the flowable material and/or fluid; and a processor configured with instructions to determine the property of the flowable material and/or fluid, wherein the processor is external to the cup or located within the sides or base of the cup. In some instances, the processor is external to the cup and is located in an external mobile device (e.g., smart phone or tablet). In some instances, the processing or the determining the property may be performed in the cloud, by the mobile device, or by the cup. In some instances, the one or more light sources are positioned at a bottom of the cup. In some instances, the one or more spectrometer modules are positioned at a bottom of the cup. In some instances, the one or more light sources and one or more spectrometer modules are positioned at a bottom of the cup.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an isometric view of a blender, in accordance with examples.

FIG. 2 shows a schematic diagram of a spectrometer system, in accordance with examples.

FIG. 3 shows a schematic diagram of a compact spectrometer, in accordance with examples.

FIG. 4 shows a schematic diagram of an optical layout in accordance with examples.

FIG. 5 shows a schematic diagram of a spectrometer head, in accordance with examples.

FIG. 6 shows a schematic drawing of cross-section A of the spectrometer head of FIG. 5, in accordance with examples.

FIG. 7 shows a schematic drawing of cross-section B of the spectrometer head of FIG. 5, in accordance with examples.

FIG. 8 shows an isometric view of a spectrometer module in accordance with examples.

FIG. 9 shows the lens array within the spectrometer module, in accordance with examples.

FIG. 10 shows a schematic diagram of an alternative embodiment of the spectrometer head, in accordance with examples.

FIG. 11 shows a schematic diagram of an alternative embodiment of the spectrometer head, in accordance with examples.

FIG. 12 shows a schematic diagram of a cross-section of the spectrometer head of FIG. 11, in accordance with examples.

FIG. 13 shows an array of LEDs of the spectrometer head of FIG. 11 arranged in rows and columns, in accordance with examples.

FIG. 14 shows a schematic diagram of a radiation diffusion unit of the spectrometer head of FIG. 11, in accordance with examples.

FIGS. 15A and 15B show examples of design options for the radiation diffusion unit of FIG. 13, in accordance with examples.

FIG. 16 shows a schematic diagram of a light directed from an externally positioned light source to an externally positioned spectrometer module, in accordance with examples.

FIG. 17 shows a schematic diagram of a light directed from an internally positioned light source to an internally positioned spectrometer module, in accordance with examples.

FIG. 18 shows a schematic diagram of a light directed from an externally positioned light source to an externally positioned spectrometer module after contacting an externally positioned optical element, in accordance with examples.

FIG. 19 shows a schematic diagram of a light directed from an internally positioned light source to an internally positioned spectrometer module after reflecting off an internally positioned optical element, in accordance with examples.

FIG. 20 shows a schematic diagram of a light directed from an externally positioned light source to an externally positioned spectrometer module at a mixing container spout, in accordance with examples.

FIG. 21 shows a schematic diagram of a light directed from an internally positioned light source to an internally positioned spectrometer positioned near a mixing container spout, in accordance with examples.

FIG. 22 shows a schematic diagram of a light directed from an externally positioned light source to an externally positioned spectrometer module after reflecting from an externally positioned optical element at a mixing container spout, in accordance with examples.

FIG. 23 shows a schematic diagram of a light directed from an internally positioned light source to an internally positioned spectrometer module after contacting an internally positioned optical element at a mixing container spout, in accordance with examples.

FIG. 24 shows a schematic diagram of a light source and spectrometer module coupled to a moveable rod, in accordance with examples.

FIG. 25 shows another schematic diagram of a light source and spectrometer module coupled to a moveable rod, in accordance with examples.

FIG. 26 shows a schematic diagram of a light source and spectrometer module coupled to a moveable rod, in accordance with examples.

FIG. 27 shows a schematic diagram of a light blocker, in accordance with examples.

FIG. 28 shows a schematic diagram of a cross section of a mixing container with a recessed channel, in accordance with examples.

FIG. 29 shows a schematic diagram of a top view of a mixing container with a recessed channel, in accordance with examples.

FIG. 30 shows a schematic diagram of another cross section of a mixing container with a recessed channel, in accordance with examples.

FIG. 31 shows a computer control system that is programmed or otherwise configured to implement methods provided herein, in accordance with examples.

FIG. 32 shows a flowchart of a method of determining a property of a mixture, in accordance with examples.

FIG. 33A shows a schematic diagram of a mixing container with a horizontally positioned optical head, in accordance with examples.

FIG. 33B shows a schematic diagram of a mixing container with a vertically positioned optical head, in accordance with examples.

FIG. 34 shows a mixer wherein the optical head is positioned in the mixer box, in accordance with examples.

FIG. 35 shows a mixer wherein a locking mechanism is used to activate the calibration process, in accordance with examples.

FIG. 36 shows a mixer comprising a holder for holding the optical head or the optical element above the mixing component, in accordance with examples.

FIG. 37 shows a schematic diagram of a cup comprising a light source and spectrometer module, in accordance with examples.

FIGS. 38A and 38B show cutaway diagrams of a cup comprising a light source and spectrometer module, in accordance with examples.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of said claims.

The methods and apparatus as disclosed herein are well suited for combination with commercially available blenders used to mix food. The blenders can be used in many places, such as in home, at restaurants and fast food vendors. The methods and apparatus disclosed herein are well suited to measure spectral data of food within the blender, and the data can be combined with other data for an end user to monitor caloric intake and to identify impurities, for example.

Methods and devices are provided for measuring one or more properties of a mixture, flowable material, or fluid during consumption, preparation, pouring, mixing, or blending. Properties of a mixture, flowable material, or fluid include, but are not limited to, composition, phase, homogeneity, heterogeneity, stability, solubility, uniformity, density, concentration (e.g., of a particular component, ingredient, or molecule), consistency, particle size, viscosity, dispersion, miscibility, and nutrient content (e.g., fat, trans fat, saturated fat, unsaturated fat, cholesterol, carbohydrate, sugar, protein, water, calorie, salt, sodium, alcohol, nutrient, dietary fiber, calcium, iron, vitamin A, vitamin C, vitamin D, mineral, vitamin content). In some cases, 2 or more, 3 or more, 4 or more, 5 or more, or 10 or more properties are measured.

The methods and apparatus disclosed herein can be used in many ways. Although reference is made to food, the methods and apparatus disclosed herein can allow monitoring of pharmaceutical or other blending processes to establish the characteristics of the blended mixture. The blender can optionally be equipped with a computer controlled drive mechanism that is slowed down to assess the progress of the blending through an imaging window mounted on the blender. The imaging device can be provided directly on the blender to view the blend through an imaging window, or can be placed in a fixed position relative to the rotating blender. The spectral data of the blend may be captured in many ways and at a many locations, such as at the top or near the bottom of the blender, and can be measured synchronously or asynchronously with the blender's rotation. The spectral information acquired from the blend at each rotation or after several rotations can be used to assess whether the nominal blend composition is achieved, or to reveal uniformity of the blend.

The methods and apparatus disclosed herein can be used and readily integrated with home or kitchen appliances such as blenders and food processors. The methods and apparatus disclosed herein are generally not limited to specific types of ingredients, for example, a solid mixture or a solution mixture. The methods and apparatus disclosed herein allow measurement of properties of a mixture without limited or complex procedures. Additionally, methods and apparatus disclosed herein can reduce unwanted reflections and scattering light from the mixing container. The systems and methods disclosed herein provide reliable, accurate, and easy to use calibration process.

The methods disclosed herein may be used to measure one or more properties of a mixture in a manner that is fast, reliable, convenient, and easy to use. In particular, a spectrometer may be used to measure one or more properties of a mixture. The spectrometers disclosed herein can detect radiation from a sample and process the resulting signal to obtain and present information about the sample that includes spectral, physical, and chemical information about the sample. The spectrometers disclosed herein can comprise a spectrally selective element to separate wavelengths of radiation received from the sample, and a first-stage optic, such as a lens, to focus or concentrate the radiation onto an imaging array. The methods and apparatus disclosed herein provide a mixer (e.g., a kitchen appliance such as a blender or food processor) comprising a spectrometer coupled to the mixer. The spectrometer may be small in size and low in cost and may be integrated within the mixer, for example within a mixing container of the mixer. The mixer may be a standard blender including a small sized, low cost integrated spectrometer. In operation, a user can insert one or more ingredients for mixing or blending and receive spectra about the mixture in real time, for example continuously, when inserting ingredients into the blend, or when pouring a blended mixture out of the mixer.

The results may be presented on the mixer display or on a user mobile device or tablet or other device having a display. The results may be further analyzed on a database or on a cloud based server. The results may be received in real time utilizing the mixer's resources such as power source and processing capabilities. In examples, a spectrometer is used to measure spectra of light that passes into a mixture and is associated with measuring a property of the mixture.

Although specific reference is made to a spectrometer configured a stand-alone device that is coupled to or ‘added on’ to the blender, the miniature spectrometer system as disclosed herein can be integrated into the blender. For example, each of the components described herein can be integrated into one or more of the blender housing or the base, and combinations thereof.

A better understanding of the features and advantages of the present disclosure will be obtained by reference to the following detailed description that sets forth illustrative embodiments, in which the principles of embodiments of the present disclosure are utilized, and the accompanying drawings.

As used herein the terms “mixer” and “blender” are interchangeable.

As used herein the terms “first” and “second” encompass alternatives that can be provided in any order.

As used herein, like characters refer to like elements.

As used herein, the term “light” encompasses electromagnetic radiation having wavelengths in one or more of the ultraviolet, visible, or infrared portions of the electromagnetic spectrum.

As used herein, the term “about” when referring to a number or a numerical range means that the number or numerical range referred to is an approximation within experimental variability (or within statistical experimental error), and thus the number or numerical range may vary from, for example, between 1% and 15% of the stated number or numerical range. In examples, the term “about” refers to ±10% of a stated number or value. In examples, properties of a mixture may be measured with optical spectroscopy using the methods, spectrometers, apparatuses, and systems described herein.

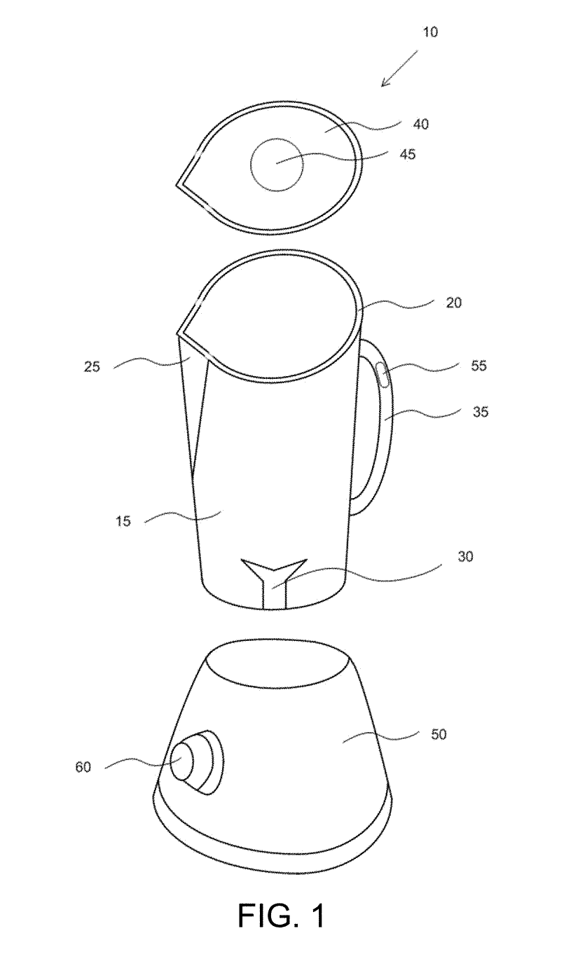

FIG. 1 shows an isometric view of a mixing apparatus or mixer 10, suitable for combination with one or more of the light source, the spectrometer sensor, or measurement module as disclosed herein. Each of the examples disclosed herein can be combined with one or more other examples as disclosed herein. A mixer may comprise a mixing container 15, within which one or more ingredients or components of a mixture are mixed or blended. The mixing container may comprise a housing 20, which may comprise the walls of the mixing container. The housing may also include a spout 25. The spout may be within the housing and/or detachably coupled to the housing. In some cases, the housing of the mixing container is optically transparent. Mixing may occur using a mixing component 30. The mixing component may be a blade, flat beater, dough hook, wire whip, spiral, gear, plate, or other mechanism. The mixing component may mix, blend, rotate, revolve, tumble, cut, grind, crush, shred, slice, shake, chop, dice, core, spiralize, peel, roll, press, puree, juice, strain, filter, knead, whisk, beat, whip, grate, stuff, heat, chill, generate shear forces, generate mechanical forces, generate collision forces, generate compressive forces, generate attrition forces, or any combination thereof. Operation of the mixing component may be powered by a motor. The mixture may be poured out of a spout 25. The mixing container may comprise a handle 35 to aid pouring and portability. The mixing container may comprise a lid 40. The lid may optionally comprise a removable lid cap 45, through which ingredients may be analyzed or added to or removed from the mixing container during operation. The mixer may comprise a base 50, on which the mixing container is positioned. The mixer may comprise components that users may utilize to control the operation of the mixer, such as an operating button 55 or 60. The mixer may comprise a spectrometer, which may be coupled to one or more locations on the mixer such as the mixing container, lid, pipe, or spout.

A mixer includes, but is not limited to, a blender, countertop blender, hand blender, immersion blender, immersion hand blender, food processor, stand mixer, hand mixer, professional mixer, grinder, mill, burr mill, burr grinder, manual grinder, coffee grinder, spice grinder, pepper mill, eggbeater, juicer, centrifugal juicer, masticating juicer, bread machine, bread maker, deep fryer, ice cream machine, rice cooker, slow cooker, waffle iron, coffee machine, coffee maker, espresso machine, soda maker, egg cooker, chocolate fountain, dehydrator, crepe maker, food grinder, food mill, pizzelle maker, popcorn popper, yogurt maker, oven, toaster oven, convection oven, microwave oven, pressure cooker, rotisserie, grill, steamer, garbage disposal, immersion circulator, water oven, water bath, rotary evaporator, distiller, frother, and other home, kitchen, or industrial appliances. A mixer or mixing container may comprise one or more of a lid, cap, fill cap, center cap, feed tube, plunger, rod, cover, base, housing, jar, mixing container, bowl, cup, pot, blade, mixing component, mixing component shield, shaft, beaker, spout, pipe, and any combination thereof.

A mixture may comprise one or more ingredients. A mixture may comprise a liquid, solid, gas, or any combination thereof. A liquid mixture can comprise a clear or opaque liquid. A liquid mixture can comprise a solution, a slurry, a Newtonian fluid, a non-Newtonian fluid, a homogenous mixture, or an inhomogeneous mixture. In some cases, a liquid mixture can comprise gas bubbles. A liquid mixture can comprise a liquid that can be consumed by an animal (e.g., milk, water, carbonated beverage, alcoholic beverage, or juice).

A flowable material and/or fluid may comprise one or more ingredients. A flowable material and/or fluid may comprise a liquid, solid, gas, or any combination thereof. A flowable material and/or fluid can comprise a clear or opaque liquid. A flowable material and/or fluid can comprise a solution, a slurry, a Newtonian fluid, a non-Newtonian fluid, a homogenous mixture, or an inhomogeneous mixture. In some cases, a flowable material and/or fluid can comprise gas bubbles. A flowable material and/or fluid can comprise a liquid that can be consumed by an animal (e.g., milk, water, carbonated beverage, alcoholic beverage, or juice).

A spectrometer can be used as a general purpose material analyzer for many applications. In particular, the spectrometer can be used to identify materials or objects, provide information regarding certain properties of the identified materials, and accordingly provide users with actionable insights regarding the identified materials. The spectrometer comprises a spectrometer module 160 as described herein configured to be directed towards a mixture or a mixer and/or configured to obtain spectral information associated with the mixture. The spectrometer module may comprise one or more optical components, such as optical filters, diffusers, or lenses, as well as one or more detectors or sensors. The spectrometer module may further comprise a spectrometer window 162 as described herein, through which incident light from the mixture can enter the spectrometer, to be subsequently measured by the optical components of the spectrometer module. The spectrometer may further comprise an illumination module 140 as described herein, comprising a light source configured to direct an optical beam or a light to the mixture within the field of view of the detector. The mixer or spectrometer may further comprise a sensor module 130 as described herein, which may, for example, comprise a temperature sensor, pH sensor, altimeter, flowmeter, accelerometer, and/or gyroscope. The spectrometer may comprise components that users may utilize to control the operation of the spectrometer, such as an operating button. The compact size of the spectrometer can provide a hand held device that can be directed (e.g., pointed) at a material or mixture to rapidly obtain information about the material or mixture. For example, the spectrometer may be sized to fit on a countertop or portable mixer.

In some cases, a user can power a mixer or spectrometer on and off by manipulating the operating button. An operating button can be a compressible button, switch, or touchscreen (e.g., capacitive screen). In many instances, a user can push the operating button to complete an electrical circuit such that the circuit is closed when a user pushes the button and the battery provides power to one or more components in the mixer or spectrometer. The user can push the button again to open the circuit and prevent the battery from providing power to one or more components in the mixer or spectrometer. In some cases, the operating button can be pressed in a predetermined sequence to program one or more features of the mixer or spectrometer. The button can be accessible through an opening on one or more of the housing pieces.

In an embodiment, the blender may not include a battery and can be connected to the 110/220V power.

### Spectrometer Systems

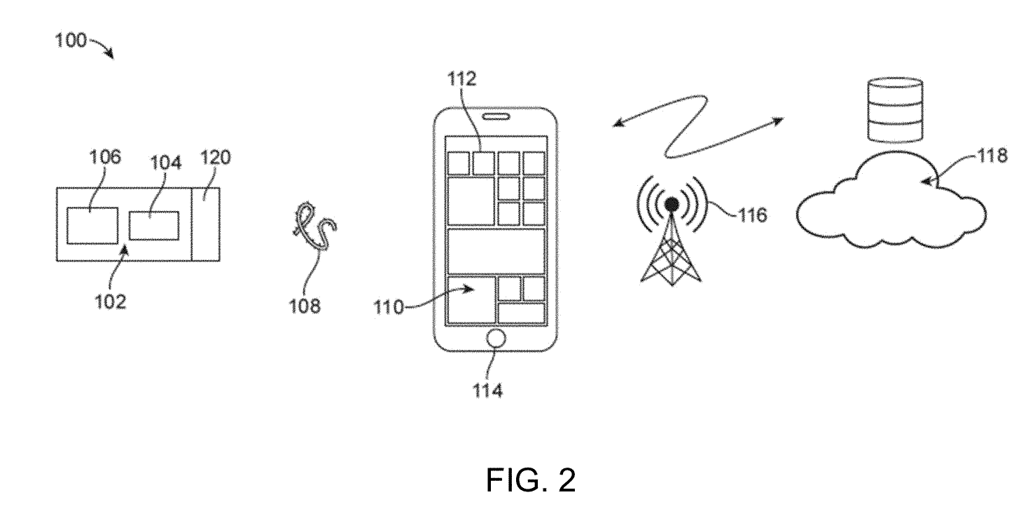

FIG. 2 shows a schematic diagram of a spectrometer system having components suitable for combination in accordance with examples of the present disclosure. In many instances, the spectrometer system 100 comprises a spectrometer 102 as described herein and a hand held device 110 in wireless communication 116 with a cloud based server or storage system 118. The spectrometer 102 can acquire the data as described herein. The spectrometer 102 may comprise a processor 106 and communication circuitry 104 coupled to the spectrometer head 120 having spectrometer components such as a light source, spectrometer module, illumination module, or optical element as described herein. The spectrometer can transmit the data to the hand held device 110 with communication circuitry 104 with a communication link, such as a wireless serial communication link, for example Bluetooth™. The hand held device can receive the data from the spectrometer 102 and transmit the data to the cloud based storage system 118. The data can be processed and analyzed by the cloud based server 118, and transmitted back to the hand held device 110 to be displayed to the user. In addition, the analyzed spectral data and/or related additional analysis results may be dynamically added to a universal database operated by the cloud server 118, where spectral data associated with mixtures may be stored. The spectral data stored on the database may comprise data generated by one or more users of the spectrometer system 100, and/or pre-loaded spectral data of materials or mixtures with known spectra. The cloud server may comprise a memory having the database stored thereon.

The spectrometer system may allow multiple users to connect to the cloud based server 118 via their hand held devices 110, as described in further detail herein. In some instances, the server 118 may be configured to simultaneously communicate with up to millions of hand held devices 110. The ability of the system to support a large number of users and devices at the same time can allow users of the system to access, in some instances in real-time, large amounts of information relating to a material or mixture of interest. Access to such information may provide users with a way of making informed decisions relating to a material or mixture of interest.

The hand held device 110 may comprise one or more components of a smart phone, such as a display 112, an interface 114, a processor, a computer readable memory and communication circuitry. The device 110 may comprise a substantially stationary device when used, such as a wireless communication gateway, for example. The hand held device 110 may provide a user interface (UI) for controlling the operation of the spectrometer 102 and/or viewing data.

The processor 106 may comprise a tangible medium embodying instructions, such as a computer readable memory embodying instructions of a computer program. Alternatively or in combination the processor may comprise logic such as gate array logic in order to perform one or more logic steps.

Because of its small size and low complexity, the compact spectrometer system herein disclosed can be integrated into a home or kitchen appliances such as blenders and food processors. The home or kitchen appliance can be capable of mobile communication. The spectrometer system can either be enclosed within the appliance itself, or mounted on the appliance and connected to it by wired or wireless means for providing power and a data link. By incorporating the spectrometer system into an appliance with mobile communication capabilities, the spectra obtained can be uploaded to a remote location, analysis can be performed there, and the user notified of the results of the analysis. The spectrometer system can also be equipped with a GPS device and/or altimeter so that the location of the sample being measured can be reported. The spectrometer system can also be equipped with an accelerometer and/or gyroscope so that the mixture is measured and spectra are obtained when the appliance is positioned appropriately, for instance, when the mixture is poured out or the mixing container or when the mixture is being mixed in a stationary mixing container. Further non-limiting examples of such components include a camera for recording the visual impression of the sample and sensors for measuring such environmental variables as temperature and humidity.

The spectrometer can be configured in many ways in accordance with the present disclosure, and may comprise one or more spectrometers, structures, components or methods as described in U.S. Patent Pub. No. US20100182598, U.S. Patent Pub. No. US20130044321, U.S. Publication No. 2014/0061486, U.S. Pat. Pub. No. US20130308045, and U.S. Patent Pub. No. US20020163641, each of which is incorporated herein by reference in its entirety.

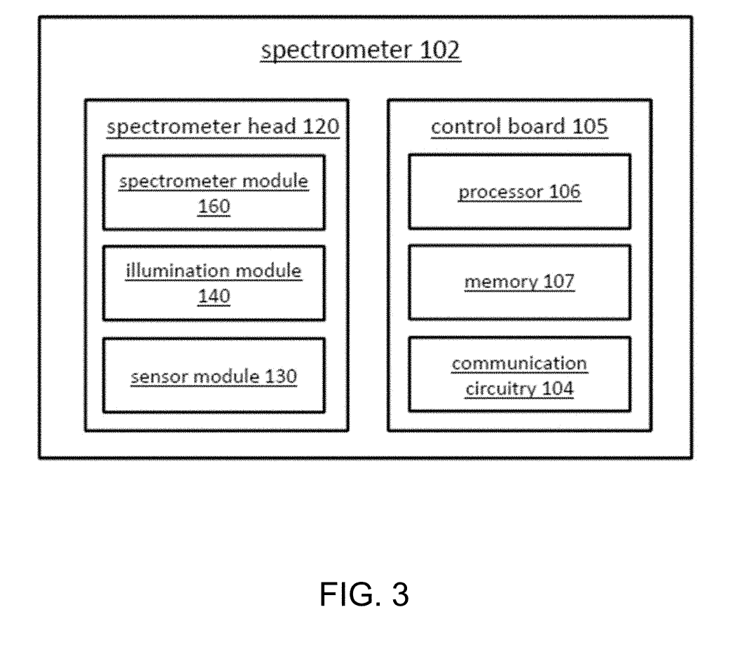

FIG. 3 shows a schematic diagram of a compact spectrometer, in accordance with examples. The spectrometer 102 may comprise a spectrometer head 120 and a control board 105. The spectrometer head 102 may comprise one or more of a spectrometer module 160 and an illumination module 140, which together can be configured to measure spectroscopic information relating to a sample mixture. The spectrometer head 102 may further comprise one or more of a sensor module 130, which can be configured to measure non-spectroscopic information relating to a sample mixture. The control board 105 may comprise one or more of a processor 106, communication circuitry 104, and memory 107. Components of the control board 105 can be configured to transmit, store, and/or analyze data, as described in further detail herein.

The sensor module 130 can enable the identification or characterization of the mixture in response to non-spectroscopic information in addition to the spectroscopic information measured by the spectrometer module 160. Such a dual information system may enhance the accuracy of detection or identification of the material. The sensor element of sensor module 130 may comprise any sensor configured to generate a non-spectroscopic signal associated with at least one aspect of the environment, including the material being analyzed. For example, the sensor element may comprise one or more of a camera, temperature sensor, electrical sensor (e.g., capacitance, resistance, conductivity, inductance), altimeter, GPS unit, turbidity sensor, pH sensor, accelerometer, gyroscope, vibration sensor, biometric sensor, chemical sensor, color sensor, clock, ambient light sensor, microphone, penetrometer, durometer, barcode reader, flowmeter, speedometer, magnetometer, and another spectrometer.

The sensor module can be coupled to the container in many ways. The sensor module can be placed on or attached to the housing of the container, such as near the spout or on the lid as described herein. Alternatively or in combination, the sensor module can be provided on the end of an elongate member such as a rod and inserted into the mixture for measurement, for example through a hole of the lid.

The output of the sensor module 130 may be associated with the output of the spectrometer module 160 via at least one processing device of the spectrometer system. The processing device may be configured to receive the outputs of the spectrometer module and sensor module, analyze both outputs, and in response to the analysis provide information relating to at least one characteristic of the material to a display unit. A display unit may be provided on the device or mixer in order to allow display of such information. Additionally, a mixer or spectrometer may also include a power source (e.g., a battery or power supply). In some cases, the spectrometer is powered by a power supply (e.g., from a consumer hand held device such as a cell phone or from a home appliance such as a blender). In some cases, the spectrometer has an independent power supply. In some cases, a power supply from the spectrometer can supply power to a consumer hand held device. In some cases, a blender or a spectrometer does not include a battery. In some cases, a blender or a spectrometer is connected to a 110V or 220V power supply.

In many instances, the spectrometer module comprises one or more lens elements. Each lens can be made of two surfaces, and each surface may be an aspheric surface. In designing the lens for a fixed-focus system, it may be desirable to reduce the system's sensitivity to the exact location of the optical detector on the z-axis (the axis perpendicular to the plane of the optical detector), in order to tolerate larger variations and errors in mechanical manufacturing. To do so, the point-spread-function (PSF) size and shape at the nominal position may be traded off with the depth-of-field (DoF) length. For example, a larger-than-optimal PSF size may be chosen in return for an increase in the DoF length. One or more of the aspheric lens surfaces of each lens of a plurality of lenses can be shaped to provide the increased PSF size and the increased DoF length for each lens. Such a design may help reduce the cost of production by enabling the use of mass production tools, since mass production tools may not be able to meet stringent tolerance requirements associated with systems that are comparatively more sensitive to exact location of the optical detector.

In some instances, the measurement of the sample is performed using scattered ambient light.

The spectrometers as described herein can be adapted, with proper choice of light source, detector, and associated optics, for a use with a wide variety of spectroscopic techniques. Non-limiting examples include Raman, fluorescence, and IR or UV-VIS reflectance and absorbance spectroscopies. A compact spectrometer system may separate a Raman signal from a fluorescence signal, and in some examples, the same spectrometer is used for both spectroscopies.

In some instances, the spectrometer does not comprise a monochromator. Additionally, a spectrometer may comprise one or more spectrometer modules. In some cases, a spectrometer comprises 1, 2, 3, 4, 5, 6, 7, 8, 9, 10, 11, 12, 13, 14, 15, 16, 17, 18, 19, 20, 25, 30, or more than 30 spectrometer modules. A spectrometer may also comprise one or more illumination modules. In some cases, a spectrometer comprises 1, 2, 3, 4, 5, 6, 7, 8, 9, 10, 11, 12, 13, 14, 15, 16, 17, 18, 19, 20, 25, 30, or more than 30 illumination modules, for example.

An illumination module may further comprise one or more light sources. In some cases, an illumination module comprises 1, 2, 3, 4, 5, 6, 7, 8, 9, 10, 11, 12, 13, 14, 15, 16, 17, 18, 19, 20, 25, 30, or more than 30 light sources. The wavelength, power, and intensity of light generated by each light source may be independently selected and may be equal, different, variable, or any combination thereof. A light source can be of any type (e.g., laser or light-emitting diode) known in the art appropriate for the spectral measurements to be made. A light source may direct and/or generate a light. The wavelength(s), power, and/or intensity of the light may depend on the particular use for the spectrometer. In some cases, a wavelength of a light is in the infrared, near-infrared, visible, white, red, orange, yellow, green, blue, violet, ultraviolet, ultraviolet A, near ultraviolet, or any combination thereof. In some cases, a wavelength of a light is not in the microwave. In some cases, a wavelength of a light is within the range from about 350 nm to about 1350 nm, such as within the range from about 350 nm to about 1100 nm. In some cases, a wavelength of a light is about 350, about 375, about 400, about 425, about 450, about 475, about 500, about 525, about 550, about 575, about 600, about 610, about 620, about 630, about 640, about 650, about 660, about 670, about 680, about 690, about 700, about 710, about 720, about 730, about 740, about 750, about 760, about 770, about 780, about 790, about 800, about 810, about 820, about 830, about 840, about 850, about 860, about 870, about 880, about 890, about 900, about 910, about 920, about 930, about 940, about 950, about 1000, about 1050, about 1060, about 1070, about 1080, about 1090, about 1100, about 1110, about 1120, about 1130, about 1140, about 1150, about 1175, about 1200, about 1225, about 1250, about 1275, about 1300, about 1325, about 1350, more than 1350 nm, or any combination thereof.

In some cases, the power of a light source is within the range from about 0.1 mW to about 500 mW. In some cases, the power of a light source may be about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, about 100, about 110, about 120, about 130, about 140, about 150, about 175, about 200, about 225, about 250, about 275, about 300, about 325, about 350, about 375, about 400, about 425, about 450, about 475, about 500, or more than 500 mW.

An illumination module or light source may provide illumination bandwidth within a range, either continuous spectrum (e.g., using an incandescent bulb or LED-activated phosphor) or multi-wavelength spectrum (e.g., using a set of LEDs with different wavelengths).

In some cases, the intensity, irradiance, or power per unit area of a light is about 0.1 mW/cm², about 1 mW/cm², about 10 mW/cm², about 100 mW/cm², about 1 W/cm², about 10 W/cm², or more than 10 W/cm². In some cases, the intensity, irradiance, or power per unit area of a light is within the range from about 0.1 mW/cm² to about 100 mW/cm².

Light that is directed from a light source may pass through a mixture to arrive at the spectrometer module in many ways. As the light travels through a mixture, it may interact with the mixture, and a spectral signature may be measured in response to the light that arrives at the spectrometer module. This signature may contain information about the molecules and particles that make up the mixture. Part of that information may indicate the properties of the mixture or the properties of the mixture molecules. Optical spectroscopy may generate a signal that includes information about the mixture properties, for example with a spectral signature.

The path of a light entering one or more apertures and received by a spectrometer module can arrive at the spectrometer in many ways. For example, light from the source can be one or more of scatter or absorbed between the source and the spectrometer. Depending on the amount of light scatter of the mixture, the light path may be approximately described by a line that starts from the light source in an illumination module and ends at a spectrometer module, such as when the mixture has relatively decreased amounts of light scatter. Alternatively or in combination, light can be scattered along the path from the source to the spectrometer. A measurement may contain information from different locations in the mixture where a light has traveled through along the path.

An illumination module comprises a light source configured to emit light, and may comprise one or more optical components such as a lens to direct light. A light source may direct light at a mixture, at a mixer, or at a location on a mixer containing a mixture. In some cases, a light, a light directed into a mixture, or a portion of the light from the mixture may be absorbed, scattered, reflected, diffracted, transmitted, or any combination thereof. The spectral signature can be determined in response to the light received at the spectrometer travelling at least partially through the mixture.

Spectrometer Using Secondary Emission Illumination with Filter-Based Optics

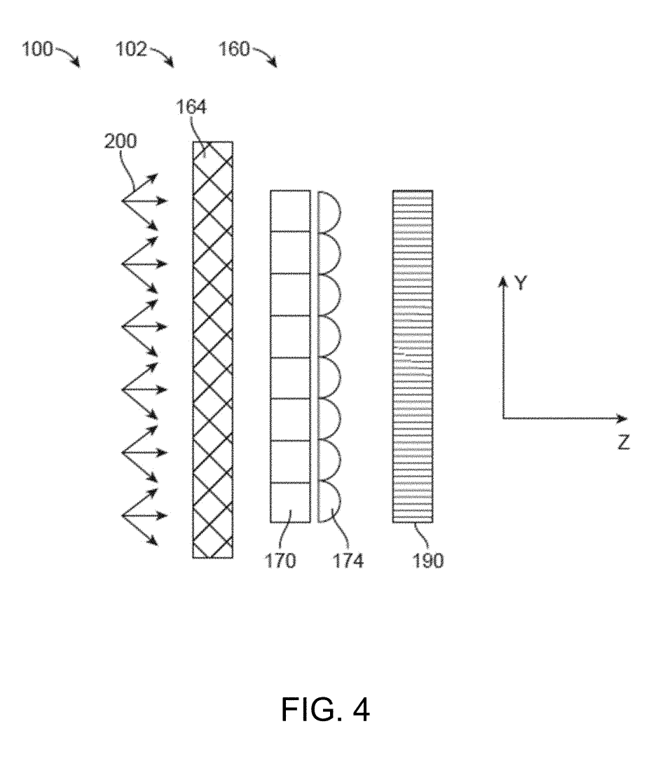

Reference is now made to FIG. 4, which illustrates non-limiting embodiments of the compact spectrometer system 100 herein disclosed. The system comprises a spectrometer 102, which comprises various modules such as a spectrometer module 160. As illustrated, the spectrometer module 160 may comprise a diffuser 164, a filter matrix 170, a lens array 174 and a detector 190.

The spectrometer system can comprise a plurality of optical filters of filter matrix 170. The optical filter can be of any type known in the art. Non-limiting examples of suitable optical filters include Fabry-Perot (FP) resonators, cascaded FP resonators, and interference filters. For example, a narrow bandpass filter (e.g., <10 nm) with a wide blocking range outside of the transmission band (e.g., at least 200 nm) can be used. The center wavelength (CWL) of the filter can vary with the incident angle of the light impinging upon it.

In many instances, the central wavelength of the central band can vary by 10 nm or more, such that the effective range of wavelengths passed with the filter is greater than the bandwidth of the filter. In many instances, the central wavelength varies by an amount greater than the bandwidth of the filter. For example, the bandpass filter can have a bandwidth of no more than 10 nm and the wavelength of the central band can vary by more than 10 nm across the field of view of the sensor.

In many instances, the spectrometer system comprises a filter matrix. The filter matrix can comprise one or more filters, for example a plurality of filters. The use of a single filter can limit the spectral range available to the spectrometer. A filter can be an element that only permits transmission of a light signal with a predetermined incident angle, polarization, wavelength, and/or other property. For example, if the angle of incidence of light is larger than 30°, the system may not produce a signal of sufficient intensity due to lens aberrations and the decrease in the efficiency of the detector at large angles. For an angular range of 30° and an optical filter center wavelength (CWL) of ˜850 nm, the spectral range available to the spectrometer can be about 35 nm, for example. As this range can be insufficient for some spectroscopy based applications, embodiments with larger spectral ranges may comprise an optical filter matrix composed of a plurality of sub-filters. Each sub-filter can have a different CWL and thus covers a different part of the optical spectrum. The sub-filters can be configured in one or more of many ways and be tiled in two dimensions, for example.

Depending on the number of sub-filters, the wavelength range accessible to the spectrometer can reach hundreds of nanometers. In embodiments comprising a plurality of sub-filters, the approximate Fourier transforms formed at the image plane (i.e. one per sub-filter) overlap, and the signal obtained at any particular pixel of the detector can result from a mixture of the different Fourier transforms.

In some instances, the filter matrixes are arranged in a specific order to inhibit cross talk on the detector of light emerging from different filters and to minimize the effect of stray light. For example, if the matrix is composed of 3×4 filters then there are 2 filters located at the interior of the matrix and 10 filters at the periphery of the matrix. The 2 filters at the interior can be selected to be those at the edges of the wavelength range. Without being bound by a particular theory the selected inner filters may experience the most spatial cross-talk but be the least sensitive to cross-talk spectrally.

In many instances, the spectrometer module comprises a lens array 174. The lens array can comprise a plurality of lenses. The number of lenses in the plurality of lenses can be determined such that each filter of the filter array corresponds to a lens of the lens array. Alternatively or in combination, the number of lenses can be determined such that each channel through the support array corresponds to a lens of the lens array. Alternatively or in combination, the number of lenses can be selected such that each region of the plurality of regions of the image sensor corresponds to an optical channel and corresponding lens of the lens array and filter of the filter array.

In many instances, the spectrometer system comprises detector 190, which may comprise an array of sensors. In many instances, the detector is capable of detecting light in the wavelength range of interest. The compact spectrometer system disclosed herein can be used from the UV to the IR, depending on the nature of the spectrum being obtained and the particular spectral properties of the sample being tested. The detector can be sensitive to one or more of ultraviolet wavelengths of light, visible wavelengths of light, or infrared wavelengths of light. In some instances, a detector that is capable of measuring intensity as a function of position (e.g. an array detector or a two-dimensional image sensor) is used.

In some instances, the spectrometer does not comprise a cylindrical beam volume hologram (CVBH).

The detector can be located in a predetermined plane. The predetermined plane can be the focal plane of the lens array. Light of different wavelengths (X1, X2, X3, X4, etc.) can arrive at the detector as a series of substantially concentric circles of different radii proportional to the wavelength. The relationship between the wavelength and the radius of the corresponding circle may not be linear.

The detector, in some instances, receives non-continuous spectra, for example spectra that can be unlike a dispersive element would create. The non-continuous spectra can be missing parts of the spectrum. The non-continuous spectrum can have the wavelengths of the spectra at least in part spatially out of order, for example. In some instances, first short wavelengths contact the detector near longer wavelengths, and second short wavelengths contact the detector at distances further away from the first short wavelengths than the longer wavelengths.

The detector may comprise a plurality of detector elements, such as pixels for example. Each detector element may be configured so as to receive signals of a broad spectral range. The spectral range received on a first and second pluralities of detector elements may extend at least from about 10 nm to about 400 nm. In many instances, spectral range received on the first and second pluralities of detector elements may extend at least from about 10 nm to about 700 nm. In many instances, spectral range received on the first and second pluralities of detector elements may extend at least from about 10 nm to about 1600 nm. In many instances, spectral range received on the first and second pluralities of detector elements may extend at least from about 400 nm to about 1600 nm. In many instances, spectral range received on the first and second pluralities of detector elements may extend at least from about 700 nm to about 1600 nm.

The spectrometer system or spectrometer module may comprise a diffuser. A diffuser may generate internal illumination in all angles of interest, irrespective of the angular distribution of the incoming illumination. The diffuser can provide improved measurement of the scattering material. The diffuser can decrease sensitivity of the spectrometer to changes in amounts of light scattering of the mixture, and can allow the spectrometer to work well with both substantially transparent low scattering materials and highly scattering materials such as blended foods. In many configurations, a diffuser can be placed in front of other elements of the spectrometer. The diffuser can be placed in a light path between a light source and a spectrometer module, detector, and/or filter. Collimated (or partially collimated light) can impinge on the diffuser, which then produces diffuse light which then impinges on other aspects of the spectrometer, e.g., an optical filter or spectrometer module. The diffuser may comprise any material well-known in the art to have light-diffusing properties, such as opal glass, Spectralon™, Polytetrafluoroethylene (PTFE), sandblasted glass, and ground glass. The diffuser may comprise a diffusing layer deposited, coated, fused, or otherwise coupled to an optical substrate such as glass.

In many instances, the lens array, the filter matrix, and the detector are not centered on a common optical axis. In many instances, the lens array, the filter matrix, and the detector are aligned on a common optical axis.

In many instances, the principle of operation of compact spectrometer comprises one or more of the following attributes. Light impinges upon the diffuser and at least a fraction of the light is transmitted through the diffuser. The light next impinges upon the filter matrix at a wide range of propagation angles and the spectrum of light passing through the sub-filters is angularly encoded. The angularly encoded light then passes through the lens array (e.g., Fourier transform focusing elements) which performs (approximately) a spatial Fourier transform of the angle-encoded light, transforming it into a spatially-encoded spectrum. Finally the light reaches the detector. The location of the detector element relative to the optical axis of a lens of the array corresponds to the wavelength of light, and the wavelength of light at a pixel location can be determined in response to the location of the pixel relative to the optical axis of the lens of the array. The intensity of light recorded by the detector element such as a pixel as a function of position (e.g. pixel number or coordinate reference location) on the sensor corresponds to the resolved wavelengths of the light for that position.

In some instances, an additional filter is placed in front of the compact spectrometer system in order to block light outside of the spectral range of interest (e.g., to prevent unwanted light from reaching the detector).

In instances in which the spectral range covered by the optical filters is insufficient, additional sub-filters with differing CWLs can be used.

In some instances, shutters allow for the inclusion or exclusion of light from part of the spectrometer 102. For example, shutters can be used to exclude particular sub-filters. Shutters may also be used to exclude individual lens.

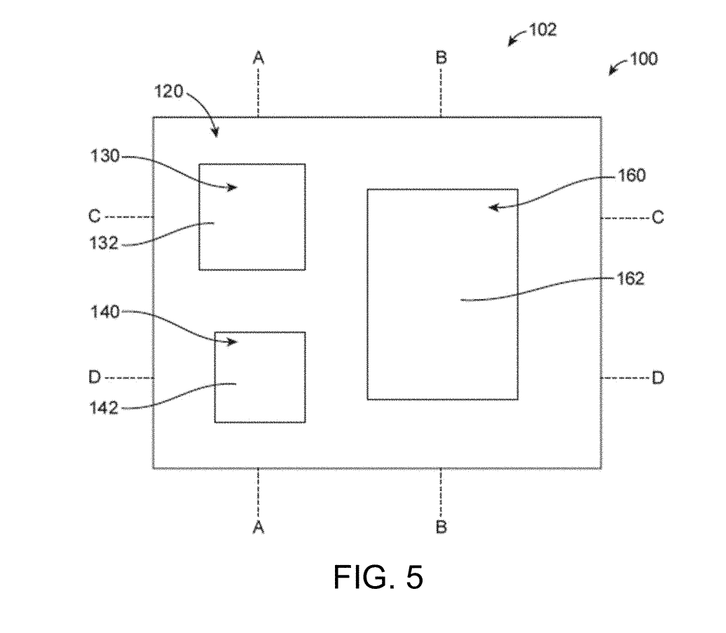

FIG. 5 shows a schematic diagram of spectrometer head in accordance with examples. In many instances, the spectrometer 102 comprises a spectrometer head 120. The spectrometer head comprises one or more of a spectrometer module 160, a temperature sensor module 130, and an illumination module 140. Each module, when present, can be covered with a module window. For example, the spectrometer module 160 can comprise a spectrometer window 162, the temperature sensor module 130 can comprise a sensor window 132, and the illumination module 140 can comprise an illumination window 142.

In many instances, the illumination module and the spectrometer module are configured to have overlapping fields of view at the sample. The overlapping fields of view can be provided in one or more of many ways. For example, the optical axes of the illumination source, the temperature sensor and the matrix array can extend in a substantially parallel configuration. Alternatively, one or more of the optical axes can be oriented toward another optical axis of another module.

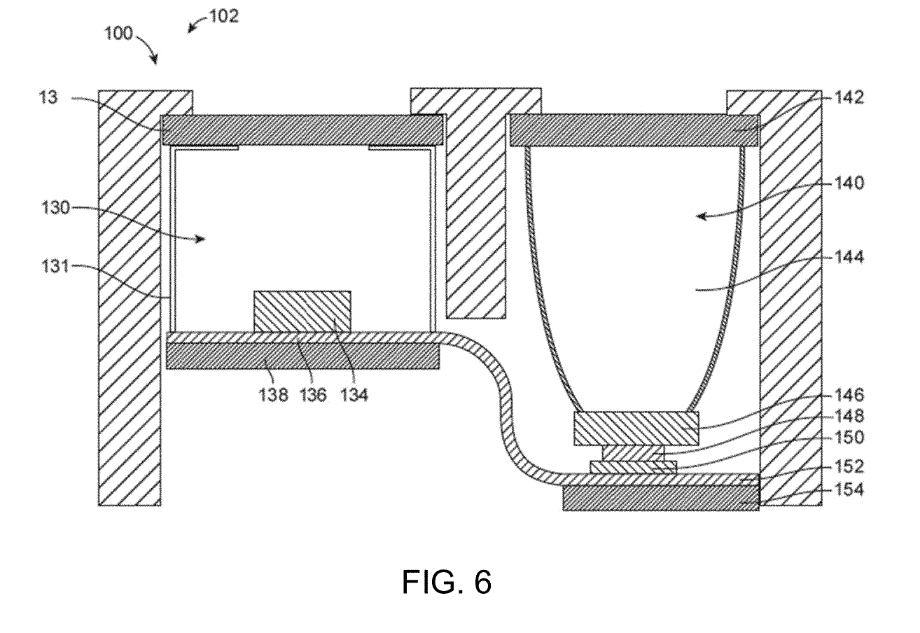

FIG. 6 shows a schematic drawing of cross-section A of the spectrometer head of FIG. 3, in accordance with examples. In order to lessen the noise and/or spectral shift produced from fluctuations in temperature, a spectrometer head 102 comprising a temperature sensor module 130 can be used to measure and record the temperature during the measurement. In some instances, the temperature sensor element can measure the temperature of the sample in response to infrared radiation emitted from the sample, and transmit the temperature measurement to a processor. Accurate and/or precise temperature measurement can be used to standardize or modify the spectrum produced. For example, different spectra of a given sample can be measured in response to the temperature at which the spectrum was taken. In some instances, a spectrum can be stored with metadata relating to the temperature at which the spectrum was measure. In many instances, the temperature sensor module 130 comprises a temperature sensor window 132. The temperature sensor window can seal the sensor module. The temperature sensor window 132 can be made of material that is substantially non-transmissive to visible light and transmits light in the infrared spectrum. In some instances, the temperature sensor window 132 comprises germanium, for example. In some instances, the temperature sensor window is about 0.2, 0.3, 0.4, 0.5, 0.6, 0.7, 0.8, 0.9 or 1.0 mm thick.

In many instances, the spectrometer head comprises illumination module 140. The illumination module can illuminate a sample with light. In some instances, the illumination module comprises an illumination window 142. The illumination window can seal the illumination module. The illumination window can be substantially transmissive to the light produced in the illumination module. For example, the illumination window can comprise glass. The illumination module can comprise a light source 148. In some instances, the light source can comprise one or more light emitting diodes (LED). In some instances, the light source comprises a blue LED. In some instances, the light source comprises a red or green LED or an infrared LED.

The light source 148 can be mounted on a mounting fixture 150. In some instances, the mounting fixture comprises a ceramic package. For example, the light fixture can be a flip-chip LED die mounted on a ceramic package. The mounting fixture 150 can be attached to a flexible printed circuit board (PCB) 152 which can optionally be mounted on a stiffener 154 to reduce movement of the illumination module. The flex PCB of the illumination module and the PCT of temperature sensor modules may comprise different portions of the same flex PCB, which may also comprise portions of spectrometer PCB.

The wavelength of the light produced by the light source 148 can be shifted by a plate 146. Plate 146 can be a wavelength shifting plate. In some instances, plate 146 comprises phosphor embedded in glass. Alternatively or in combination, plate 146 can comprise a nano-crystal, a quantum dot, or combinations thereof. The plate can absorb light from the light source and release light having a frequency lower than the frequency of the absorbed light. In some instances, a light source produces visible light, and plate 146 absorbs the light and emits near infrared light. In some instances, the light source is in close proximity to or directly touches the plate 146. In some instances, the light source and associated packaging is separated from the plate by a gap to limit heat transfer. For example the gap between the light source and the plate can be at least 0.1, 0.2, 0.3, 0.4, 0.5, 0.6, 0.7, 0.8, 0.9, 1.0, 1.5, 2.0, 2.5, 3.0, 3.5, 4.0, 5.0, 6.0, 7.0, 8.0, 9.0, or 10.0 mm. In many alternative instances, the light source packaging touches the plate 146 in order to conduct heat from the plate such that the light source packaging comprises a heat sink.

The illumination module can further comprise a light concentrator such as a parabolic concentrator 144 or a condenser lens in order to concentrate the light. In some instances, the parabolic concentrator 144 is a reflector. In some instances, the parabolic concentrator 144 comprises stainless steel. In some instances, the parabolic concentrator 144 comprises gold-plated stainless steel. In some instances, the concentrator can concentrate light to a cone. For example, the light can be concentrated to a cone with a field of view of about 30-45, 25-50, or 20-55 degrees.

In some instances, the illumination module is configured to transmit light and the spectrometer module is configured to receive light along optical paths extending substantially perpendicular to an entrance face of the spectrometer head. In some instances, the modules can be configured such that light can be transmitted from one module to an object (such as a sample 108) and reflected or scattered to another module which receives the light.

In some instances, the optical axes of the illumination module and the spectrometer module can be configured to be non-parallel such that the optical axis representing the spectrometer module is at an offset angle to the optical axis of the illumination module. This non-parallel configuration can be provided in one or more of many ways. For example, one or more components can be supported on a common support and offset in relation to an optic such as a lens in order to orient one or more optical axes toward each other. Alternatively or in combination, a module can be angularly inclined with respect to another module. In some cases, the angle between where a light is directed from and where the light is received is the offset angle. In some cases, the angle between a light source and spectrometer module is the offset angle. In some cases, the optical axis of each module is aligned at an offset angle. In some cases, the illumination module and the spectrometer module are configured to be aligned at an offset angle. In some cases, the offset angle is greater than 0, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. In some cases, the offset angle is less than 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. In some instances, the optical axis of each module is aligned at an offset angle of greater than 1, 2, 3, 4, 5, 6, 7, 8, 9, 10, 12, 14, 16, 18, 20, 25, 30, 35, 40, 45, or 50 degrees. In some instances, the illumination module and the spectrometer module are configured to be aligned at an offset angle of less than 1, 2, 3, 4, 5, 6, 7, 8, 9, 10, 12, 14, 16, 18, 20, 25, 30, 35, 40, 45, or 50 degrees. In some instances, the illumination module and the spectrometer module are configured to be aligned at an offset angle between than 1-10, 11-20, 21-30, 31-40 or 41-50 degrees. In some cases, the offset angle of the modules can be set firmly and is not adjustable. In some instances, the offset angle of the modules can be adjustable. In some cases, the offset angle of the modules can be automatically selected in response to the distance of the spectrometer from the sample. In some cases, two modules can have parallel optical axes. In some cases, two or more modules can have offset optical axes. In some instances, the modules can have optical axes offset such that they converge on a sample. The modules can have optical axes offset such that they converge at a set distance. For example, the modules can have optical axes offset such that they converge at a distance of about 10, 20, 30, 40, 50, 60, 70, 80, 90, 100, 150, 200, 250, 300, 350, 400, or 500 mm away.

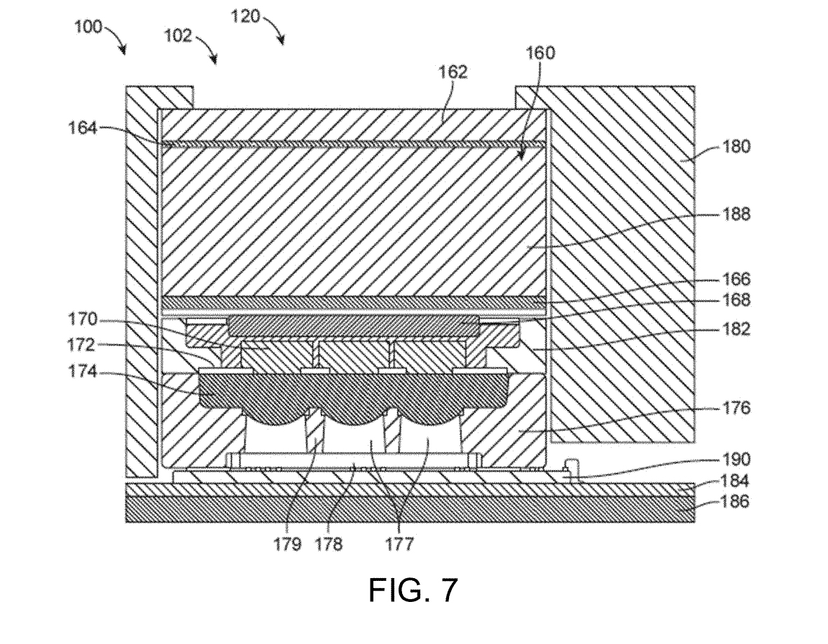

FIG. 7 shows a schematic drawing of cross-section B of the spectrometer head of FIGS. 3 and 4, in accordance with examples. In many instances, the spectrometer head 102 comprises spectrometer module 160. The spectrometer module can be sealed by a spectrometer window 162. In some instances, the spectrometer window 162 is selectively transmissive to light with respect to the wavelength in order to analyze the spectral sample. For example, spectrometer window 162 can be an IR-pass filter. In some instances, the window 162 can be glass. The spectrometer module can comprise one or more diffusers. For example, the spectrometer module can comprise a first diffuser 164 disposed below the spectrometer window 162. The first diffuser 164 can distribute the incoming light. For example, the first diffuser can be a cosine diffuser. Optionally, the spectrometer module comprises a light filter 188. Light filter 188 can be a thick IR-pass filter. For example, filter 188 can absorb light below a threshold wavelength. In some instances, filter 188 absorbs light with a wavelength below about 1000, 950, 900, 850, 800, 750, 700, 650, or 600 nm. In some instances, the spectrometer module comprises a second diffuser 166. The second diffuser can generate Lambertian light distribution at the input of the filter matrix 170. The filter assembly can be sealed by a glass plate 168. Alternatively or in combination, the filter assembly can be further supported by a filter frame 182, which can attach the filter assembly to the spectrometer housing 180. The spectrometer housing 180 can hold the spectrometer window 162 in place and further provide mechanical stability to the module.

The first filter and the second filter can be arranged in one or more of many ways to provide a substantially uniform light distribution to the filters. The substantially uniform light distribution can be uniform with respect to an average energy to within about 25%, for example to within about 10%, for example. In many instances, the first diffuser distributes the incident light energy spatially on the second diffuser with a substantially uniform energy distribution profile. In some instances, the first diffuser makes the light substantially homogenous with respect to angular distribution. The second diffuser further diffuses the light energy of the substantially uniform energy distribution profile to a substantially uniform angular distribution profile, such that the light transmitted to each filter can be substantially homogenous both with respect to the spatial distribution profile and the angular distribution profile of the light energy incident on each filter. For example, the angular distribution profile of light energy onto each filter can be uniform to within about +/−25%, for example substantially uniform to within about +/−10%.

In many instances, the spectrometer module comprises a filter matrix 170. The filter matrix can comprise one or more filters. In many instances, the filter matrix comprises a plurality of filters.

In some instances, each filter of the filter matrix 170 is configured to transmit a range of wavelengths distributed about a central wavelength. The range of wavelengths can be defined as a full width half maximum (hereinafter “FWHM”) of the distribution of transmitted wavelengths for a light beam transmitted substantially normal to the surface of the filter as will be understood by a person of ordinary skill in the art. A wavelength range can be defined by a central wavelength and by a spectral width. The central wavelength can be the mean wavelength of light transmitted through the filter, and the band spectral width of a filter can be the difference between the maximum and the minimum wavelength of light transmitted through the filter. In some instances, each filter of the plurality of filters is configured to transmit a range of wavelengths different from other filters of the plurality. In some instances, the range of wavelengths overlaps with ranges of said other filters of the plurality and wherein said each filter comprises a central wavelength different from said other filters of the plurality.

In many instances, the filter array comprises a substrate having a thickness and a first side and a second side, the first side oriented toward the diffuser, the second side oriented toward the lens array. In some instances, each filter of the filter array comprises a substrate having a thickness and a first side and a second side, the first side oriented toward the diffuser, the second side oriented toward the lens array. The filter array can comprise one or more coatings on the first side, on the second side, or a combination thereof. Each filter of the filter array can comprise one or more coatings on the first side, on the second side, or a combination thereof. In some instances, each filter of the filter array comprises one or more coatings on the second side, oriented toward the lens array. In some instances, each filter of the filter array comprises one or more coatings on the second side, oriented toward the lens array and on the first side, oriented toward the diffuser. The one or more coatings on the second side can be an optical filter. For example, the one or more coatings can permit a wavelength range to selectively pass through the filter. Alternatively or in combination, the one or more coatings can be used to inhibit cross-talk among lenses of the array. In some instances, the plurality of coatings on the second side comprises a plurality of interference filters, said each of the plurality of interference filters on the second side configured to transmit a central wavelength of light to one lens of the plurality of lenses. In some instances, the filter array comprises one or more coatings on the first side of the filter array. The one or more coatings on the first side of the array can comprise a coating to balance mechanical stress. In some instances, the one or more coatings on the first side of the filter array comprise an optical filter. For example, the optical filter on the first side of the filter array can comprise an IR pass filter to selectively pass infrared light. In many instances, the first side does not comprise a bandpass interference filter coating. In some instances, the first does not comprise a coating.

In many instances, the array of filters comprises a plurality of bandpass interference filters on the second side of the array. The placement of the fine frequency resolving filters on the second side oriented toward the lens array and apertures can inhibit cross-talk among the filters and related noise among the filters. In many instances, the array of filters comprises a plurality of bandpass interference filters on the second side of the array, and does not comprise a bandpass interference filter on the first side of the array.

In many instances, each filter defines an optical channel of the spectrometer. The optical channel can extend from the filer through an aperture and a lens of the array to a region of the sensor array. The plurality of parallel optical channels can provide increased resolution with decreased optical path length.

The spectrometer module can comprise an aperture array 172. The aperture array can prevent cross talk between the filters. The aperture array comprises a plurality of apertures formed in a non-optically transmissive material. In some instances, the plurality of apertures is dimensioned to define a clear lens aperture of each lens of the array, wherein the clear lens aperture of each lens is limited to one filter of the array. In some instances, the clear lens aperture of each lens is limited to one filter of the array.

In many instances, the spectrometer module comprises a lens array 174. The lens array can comprise a plurality of lenses. The number of lenses can be determined such that each filter of the filter array corresponds to a lens of the lens array. Alternatively or in combination, the number of lenses can be determined such that each channel through the support array corresponds to a lens of the lens array. Alternatively or in combination, the number of lenses can be selected such that each region of the plurality of regions of the image sensor corresponds to an optical channel and corresponding lens of the lens array and filter of the filter array.

In many instances, each lens of the lens array comprises one or more aspheric surfaces, such that each lens of the lens array comprises an aspherical lens. In many instances, each lens of the lens array comprises two aspheric surfaces. Alternatively or in combination, one or more individual lens of the lens array can have two curved optical surfaces wherein both optical surfaces are substantially convex. Alternatively or in combination, the lenses of the lens array may comprise one or more diffractive optical surfaces.

In many instances, the spectrometer module comprises a support array 176. The support array 176 comprises a plurality of channels 177 defined with a plurality of support structures 179 such as interconnecting annuli. The plurality of channels 177 may define optical channels of the spectrometer. The support structures 179 can comprises stiffness to add rigidity to the support array 176. The support array may comprise a stopper to limit movement and fix the position the lens array in relation to the sensor array. The support array 176 can be configured to support the lens array 174 and fix the distance from the lens array to the sensor array in order to fix the distance between the lens array and the sensor array at the focal length of the lenses of the lens array. In many instances, the lenses of the array comprise substantially the same focal length such that the lens array and the sensor array are arranged in a substantially parallel configuration.

The support array 176 can extend between the lens array 174 and the stopper mounting 178. The support array 176 can serve one or more purposes, such as 1) providing the correct distance between each lens of lens array 170 and each region of the plurality of regions of the image sensor 190, and/or 2) preventing stray light from entering or exiting each channel, for example. In some instances, the height of each support in support array 176 is calibrated to the focal length of the lens within lens array 174 that it supports. In some instances, the support array 176 is constructed from a material that does not permit light to pass such as substantially opaque plastic. In some instances, support array 176 is black, or comprises a black coating to further reduce cross talk between channels. The spectrometer module can further comprise a stopper mounting 178 to support the support array. In many instances, the support array comprises an absorbing and/or diffusive material to reduce stray light, for example.

In many instances, the support array 176 comprises a plurality of channels having the optical channels of the filters and lenses extending therethrough. In some instances, the support array comprises a single piece of material extending from the lens array to the detector (i.e. CCD or CMOS array).

The lens array can be directly attached to the aperture array 172, or can be separated by an air gap of at least 1, 2, 3, 4, 5, 6, 7, 8, 9, 10, 12, 14, 16, 18, 20, 30, 40, or 50 micrometers. The lens array can be directly on top of the support array 178. Alternatively or in combination, the lens array can be positioned such that each lens is substantially aligned with a single support stopper or a single optical isolator in order to isolate the optical channels and inhibit cross-talk. In some instances, the lens array is positioned to be at a distance approximately equal to the focal length of the lens away from the image sensor, such that light coming from each lens is substantially focused on the image sensor.

In some instances, the spectrometer module comprises an image sensor 190. The image sensor can be a light detector. For example, the image sensor can be a CCD or 2D CMOS or other sensor, for example. The detector can comprise a plurality of regions, each region of said plurality of regions comprising multiple sensors. For example, a detector can be made up of multiple regions, wherein each region is a set of pixels of a 2D CMOS. The detector, or image sensor 190, can be positioned such that each region of the plurality of regions is directly beneath a different channel of support array 176. In many instances, an isolated light path is established from a single of filter of filter array 170 to a single aperture of aperture array 172 to a single lens of lens array 174 to a single stopper channel of support array 176 to a single region of the plurality of regions of image sensor 190. Similarly, a parallel light path can be established for each filter of the filter array 170, such that there are an equal number of parallel (non-intersecting) light paths as there are filters in filter array 170.

The image sensor 190 can be mounted on a flexible printed circuit board (PCB) 184. The PCB 184 can be attached to a stiffener 186. In some instances, the stiffener comprises a metal stiffener to prevent motion of the spectrometer module relative to the spectrometer head 120.

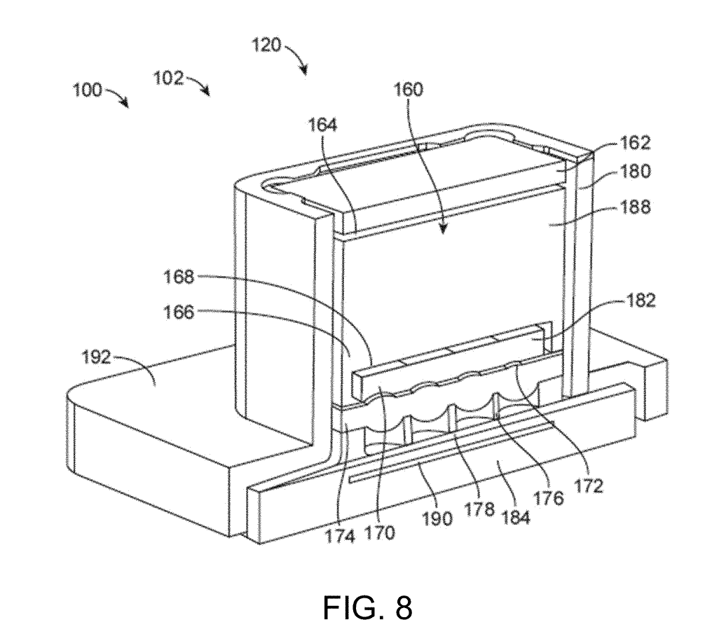

FIG. 8 shows an isometric view of a spectrometer module 160 in accordance with examples. The spectrometer module 160 comprises many components as described herein. The support array 176 can be positioned on a package on top of the sensor. The support array can be positioned over the top of the bare die of the sensor array such that an air gap is present. The air gap can be less than 10, 9, 8, 7, 6, 5, 4, 3, 2 or 1 micrometer(s).

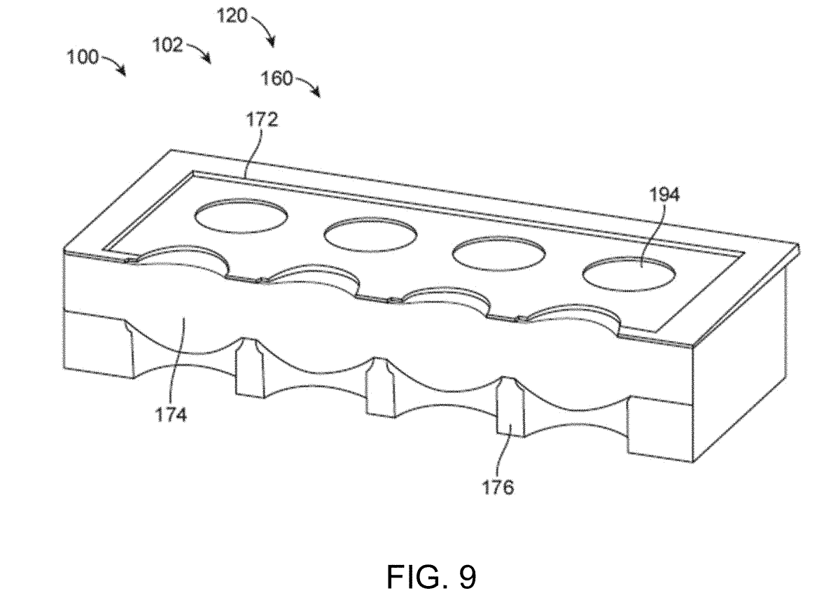

FIG. 9 shows the lens array 174 within the spectrometer module 160, in accordance with examples. This isometric view shows the apertures 194 formed in a non-transmissive material of the aperture array 172 in accordance with examples. In many instances, each channel of the support array 176 is aligned with a filter of the filter array 170, a lens of the lens array 174, and an aperture 194 of the aperture array in order to form a plurality of light paths with inhibited cross talk.

In some instances, the glass-embedded phosphor of plate 146 may be a near-infrared (NIR) phosphor, capable of emitting infrared or NIR radiation in the range from about 700 nm to about 1100 nm.

In some instances, the light filter 188 is configured to block at least a portion of visible radiation included in the incident light.

In some instances, first wavelength range of the first filter and the second wavelength range of the second filter fall within a wavelength range of about 400 nm to about 1100 nm. In some instances, the second wavelength range overlaps the first wavelength range by at least 2% of the second wavelength range. In some instances, the second wavelength range overlaps the first wavelength range by an amount of about 1% to about 5% of the second wavelength range. The overlap in the range of wavelengths of the filters may be configured to provide algorithmic correction of the gains across different channels, for example across the outputs of a first filter element and a second filter element.

In some instances, the coating of the filter array and/or the support array may comprise a black coating configured to absorb most of the light that hits the coated surface. For example, the coating may comprise a coating commercially available from Anoplate (as described on http://www.anoplate.com/capabilities/anoblack_ni.html), Acktar (as described on the world wide web at the Acktar website, www.acktar.com), or Avian Technologies (as described on http://www.aviantechnologies.com/products/coatings/diffuse_black.php), or other comparable coatings.

The stopper and the image sensor may be configured to have matching coefficients of thermal expansion (CTE). For example, the stopper and the image sensor may be configured to have a matching CTE of about 7 10⁻⁶ K⁻¹. In order to match the CTE between the stopper and the image sensor where the stopper and image sensor have different CTEs, a liquid crystal polymer, such as Vectra E130, may be applied between the stopper and the image sensor.

The lens may be configured to introduce some distortion in the output of the lens, in order to improve performance in analyzing the obtained spectral data. The filters described herein may typically allow transmission of a specific wavelength for a specific angle of propagation of the incident light beam. As the light transmitted through the filters pass through the lens, the output of the lens may generate concentric rings on the sensor for different wavelengths of incident light. With typical spherical lens performance, as the angle of incidence grows larger, the concentric ring for that wavelength becomes much thinner (for a typical light bandwidth of ˜5 nm). Such variance in the thickness of the rings may cause reduced linearity and related performance in analyzing the spectral data. To overcome this non-linearity, some distortion may be introduced into the lens, so as to reduce the thickness of the rings that correspond to incident light having smaller angles of propagation, and increase the thickness of the rings that correspond to incident light having larger angles of propagation, wherein non-linearity of ring size related to incident angle is decreased. Lenses configured to produce such distortion in the output can produce a more even distribution of ring thicknesses along the supported range of angles of incidence, consequently improving performance in the analysis of the generated spectral data. The distortion can be provided with one or more aspheric lens profiles to increase the depth of field (DoF) and increase the size of the point spread function (PSF) as described herein.

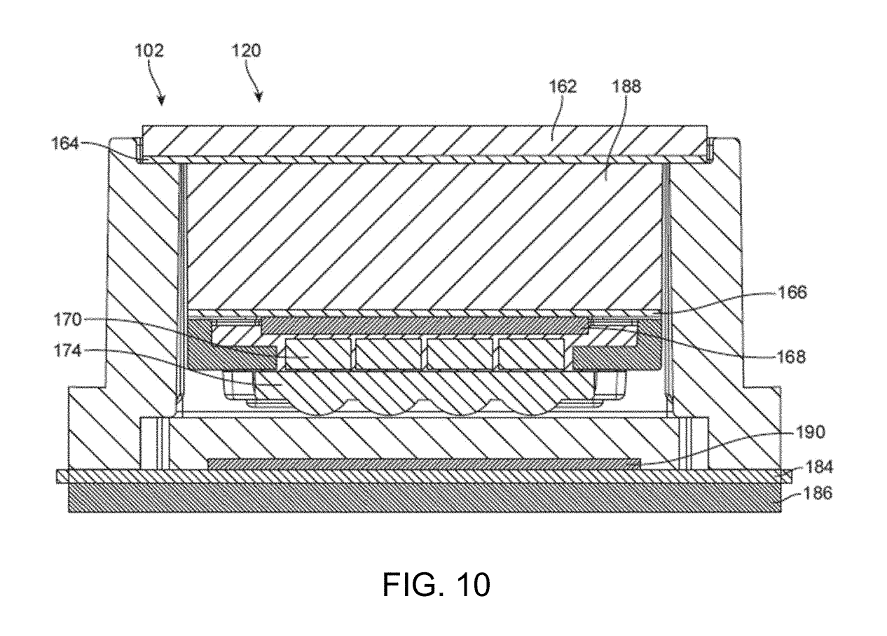

FIG. 10 shows a schematic drawing of a cross-section B of an alternative embodiment of the spectrometer head of FIG. 5. In some instances, the spectrometer module may be configured to purposefully induce cross-talk among sensor elements. For example, the spectrometer module may comprise the filter matrix and lens array as shown in FIG. 7, but omit one or more structural features that isolate the optical channels, such as the aperture array 172 or the isolated channels 177 of the support array 176. Without the isolated optical channels, light having a particular wavelength received by the first filter may result in a pattern of non-concentric rings on the detector. In addition, a first range of wavelengths associated with a first filter may partially overlap a second range of wavelengths associated with a second filter. Without the isolated optical channels, at least one feature in the pattern of light output by a first filter may be associated with at least one feature in the pattern of light output by a second filter. For example, when light comprising two different wavelengths, separated by at least five times the spectral resolution of the device, passes through the filter matrix, the light from at least two filters of the filter matrix may impinge on at least one common pixel of the detector. The spectrometer module may further comprise at least one processing device configured to stitch together light output by multiple filters to generate or reconstruct a spectrum associated with the incident light. Inducing cross-talk among sensor elements can have the advantage of increasing signal strength, and of reducing the structural complexity and thereby the cost of the optics.

### Spectrometer Using Multiple Illumination Sources

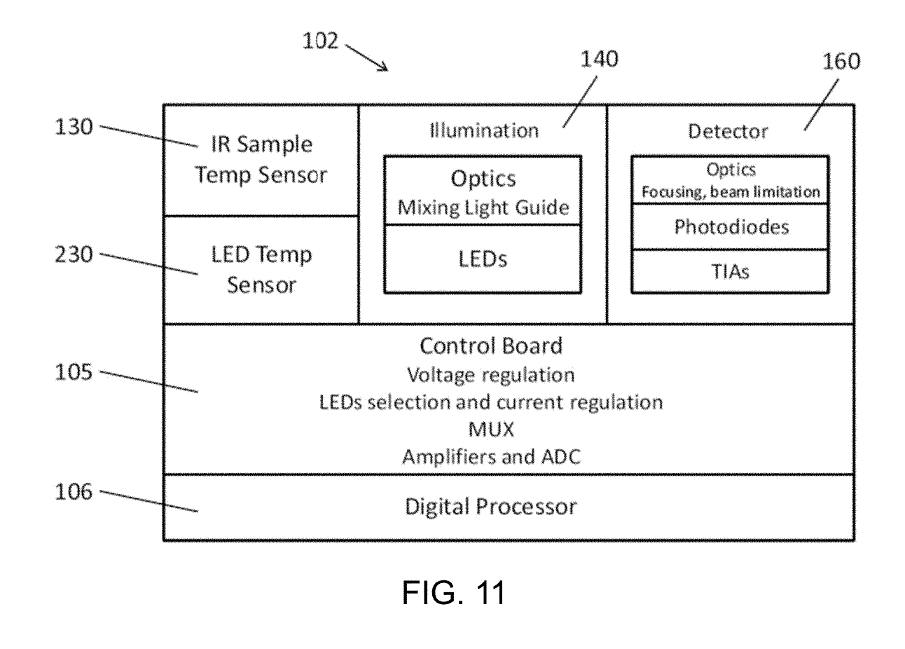

FIG. 11 shows a schematic diagram of an alternative embodiment of the spectrometer head 102. The spectrometer head 102 comprises an illumination module 140, a spectrometer module 160, a control board 105, and a processor 106. The spectrometer 102 further comprises a temperature sensor module 130 as described herein, configured to measure and record the temperature of the sample in response to infrared radiation emitted from the sample. In addition to the temperature sensor module 130, the spectrometer 102 may also comprise a separate temperature sensor 230 for measuring the temperature of the light source in the illumination module 140.

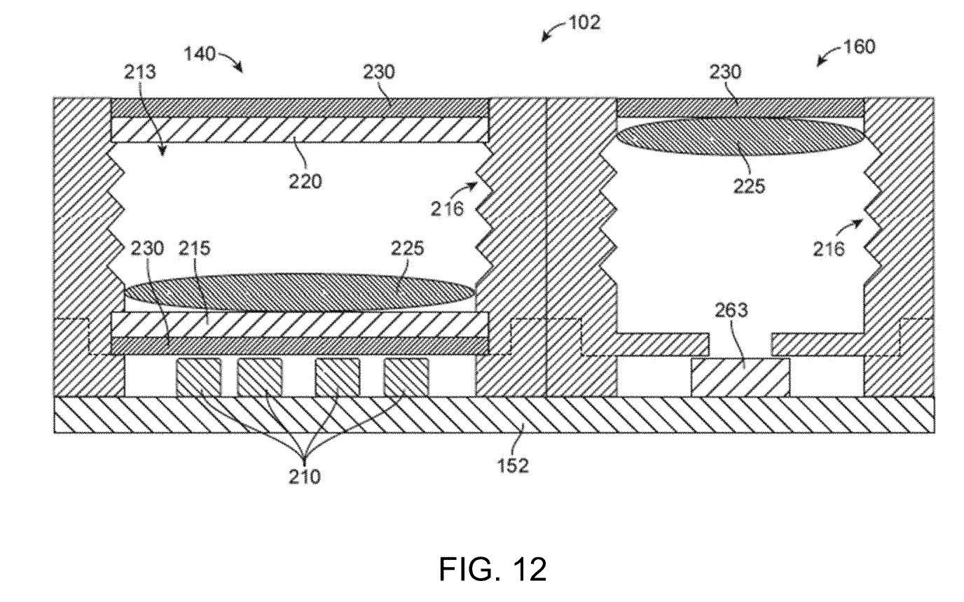

FIG. 12 shows a schematic diagram of a cross-section of the spectrometer head of FIG. 11 (the sample temperature sensor 130 and the light source temperature sensor 230 are not shown). The spectrometer head comprises an illumination module 140 and a spectrometer module 160.

The illumination module 140 comprises at least two light sources, such as light-emitting diodes (LEDs) 210. The illumination module may comprise at least about 10 LEDs. The illumination module 140 further comprises a radiation diffusion unit 213 configured to receive the radiation emitted from the array of LEDs 210, and provide as an output illumination radiation for use in analyzing a sample mixture. The radiation diffusion unit may comprise one or more of a first diffuser 215, a second diffuser 220, and one lens 225 disposed between the first and second diffusers. The radiation diffusion unit may further comprise additional diffusers and lenses. The radiation diffusion unit may comprise a housing 214 to support the first diffuser and the second diffuser with fixed distances from the light sources. The inner surface of the housing 214 may comprise a plurality of light absorbing structures 216 to inhibit reflection of light from an inner surface of the housing. For example, the plurality of light absorbing structures may comprise one or more of a plurality of baffles or a plurality of threads, as shown in FIG. 12. A cover glass 230 may be provided to mechanically support and protect each diffuser. Alternatively or in combination with the LEDs, the at least two light sources may comprise one or more lasers.

The array of LEDs 210 may be configured to generate illumination light composed of multiple wavelengths. Each LED may be configured to emit radiation within a specific wavelength range, wherein the wavelength ranges of the plurality of LEDs may be different. The LEDs may have different specific power, peak wavelength and bandwidth, such that the array of LEDs generates illumination that spans across the spectrum of interest. There can be between a few LEDs and a few tens of LEDs in a single array.

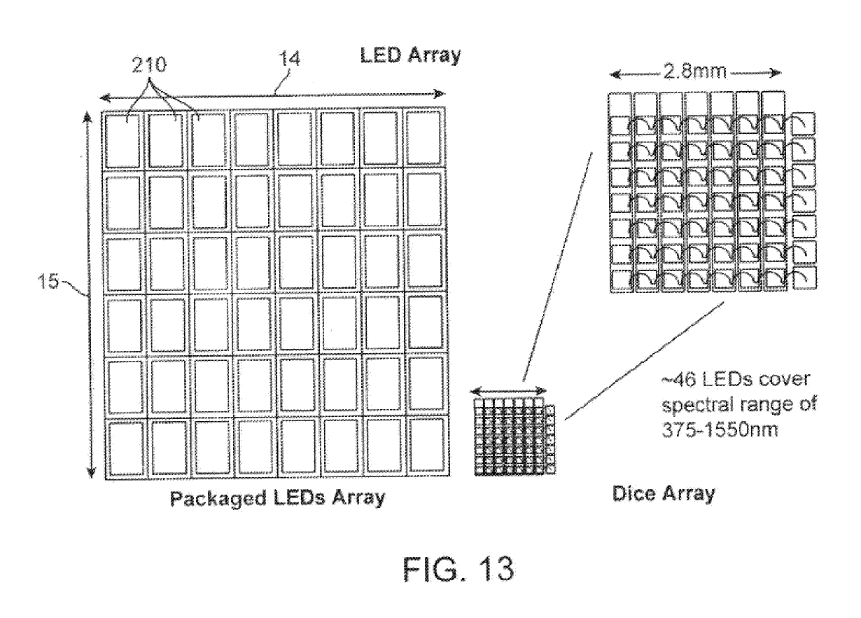

In some instances, the LED array is placed on a printed circuit board (PCB) 152. In order to reduce the size, cost and complexity of the PCB and LED driving electronics and reduce the number of interconnect lines, the LEDs may preferably be arranged in rows and columns, as shown in FIG. 13. All anodes on the same row may be connected together and all cathodes on the same column may be connected together (or vice versa). For example, the LED in the center of the array may be turned on when a transistor connects the driving voltage to the anodes' fourth row and another transistor connects the cathodes' fourth column to a ground. None of the other LEDs is turned on at this state, as either its anodes are disconnected from power or its cathodes are disconnected from the ground. Preferably, the LEDs are arranged according to voltage groups, to simplify the current control and to improve spectral homogeneity (LEDs of similar wavelengths are placed close together). While bi-polar transistors are provided herein as examples, the circuit may also use other types of switches (e.g., field-effect transistors).

The LED currents can be regulated by various means as known to those skilled in the art. In some instances, Current Control Regulator (CCR) components may be used in series to each anode row and/or to each cathode column of the array. In some instances, a current control loop may be used instead of the CCR, providing more flexibility and feedback on the actual electrode currents. Alternatively, the current may be determined by the applied anode voltages, though this method should be used with care as LEDs can vary significantly in their current to voltage characteristics.

An optional voltage adjustment diode can be useful in reducing the difference between the LED driving voltages of LEDs sharing the same anode row, so that they can be driven directly from the voltage source without requiring a current control circuit. The optional voltage adjustment diode can also help to improve the stability and simplicity of the driving circuit. These voltage adjustment diodes may be selected according to the LEDs' expected voltage drops across the row, in opposite tendency, so that the total voltage drop variation along a shared row is smaller.

Referring to FIG. 12, the radiation diffusion unit 213, positioned above the LED array, is configured to mix the illumination emitted by each of the LEDs at different spatial locations and with different angular characteristics, such that the spectrum of illumination of the sample will be as uniform as possible across the measured area of the sample. What is meant by a uniform spectrum is that the relations of powers at different wavelengths do not depend on the location on the sample. However, the absolute power can vary. This uniformity is highly preferable in order to optimize the accuracy of the reflection spectrum measurement.

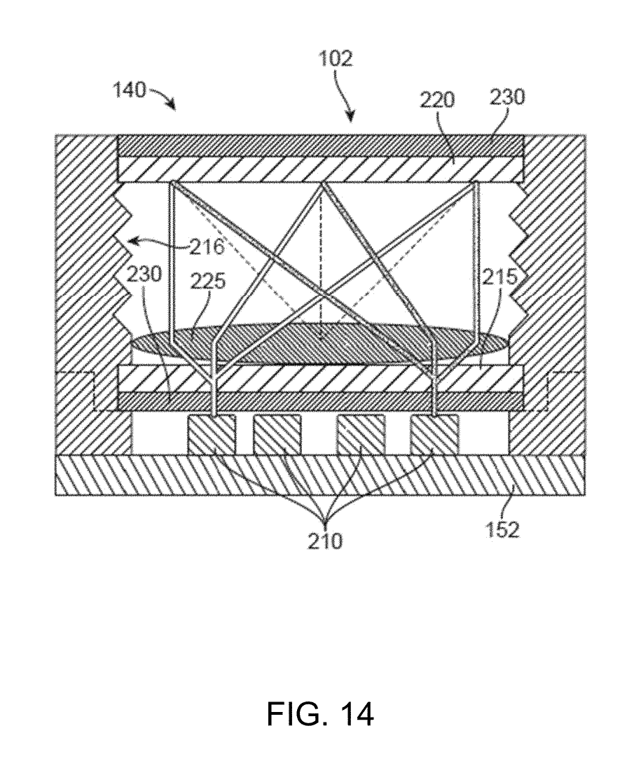

The first diffuser 215, preferably mechanically supported and protected by a cover glass 230, may be placed above the array of LEDs 210. The diffuser may be configured to equalize the beam patterns of the different LEDs, as the LEDs will typically differ in their illumination profiles. Regardless of the beam shape of any LED, the light that passes through the first diffuser 215 can be configured to have a Lambertian beam profile, such that the emitted spectrum at each of the directions from first diffuser 215 is uniform. Ideally, the ratios between the illuminations at different wavelengths do not depend on the direction to the plane of the first diffuser 215, as observed from infinity. Such directions are indicated schematically by the dashed lines shown in FIG. 14, referring to the directions of rays at the output of the first diffuser 215 towards the first surface of lens 225.

The first diffuser 215 is preferably placed at the aperture plane of the lens 225. Thus, parallel rays can be focused by the lens to the same location on the focal plane of the lens, where the second diffuser 220 is placed (preferably supported and protected by cover glass 230). Since all illumination directions at the output of the first diffuser 215 have the same spectrum, the spectrum at the input plane of the second diffuser 220 can be uniform (though the absolute power may vary). The second diffuser 220 can then equalize the beam profiles from each of the locations in its plane, so that the output spectrum is uniform both in location and in direction, leading to uniform spectral illumination across the sample irrespective of the sample distance from the device (when the sample is close to the device it is more affected by the spatial variance of spectrum, and when the sample is far from the device it is more affected by the angular variation of the spectrum).

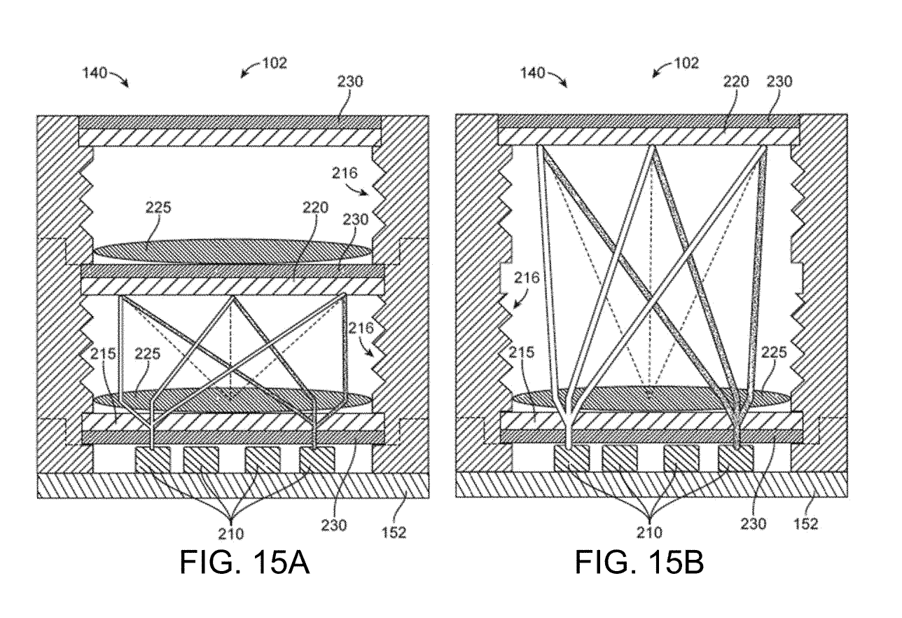

In designing the radiation diffusion unit 213 configured to improve spectral uniformity, size and power may be traded off in order to achieve the required spectral uniformity. For example, as shown in FIG. 15a, the radiation diffusion unit 213 may be duplicated (additional diffusers and lenses added), or as shown in FIG. 15b, the radiation diffusion unit 213 may be configured with a longer length between the first and second diffusers, in order to achieve increased uniformity while trading off power. Alternatively, if uniformity is less important, some elements in the optics can be omitted (e.g., first diffuser or lens), or simplified (e.g., weaker diffuser, simpler lens).

Referring back to FIG. 12, the spectrometer module 160 comprises one or more photodiodes 263 that are sensitive to the spectral range of interest. For example, a dual Si—InGaAs photodiode can be used to measure the sample reflection spectrum in the range of about 400 nm to about 1750 nm. The dual photodiode structure is composed of two different photodiodes positioned one above the other, such that they collect illumination from essentially the same locations in the sample.

The one or more photodiodes 263 are preferably placed at the focal plane of lens 225, as shown in FIG. 12. The lens 225 can efficiently collect the light from a desired area in the sample to the surface of the photodiode. Alternatively, other light collection methods known in the art can be used, such as a Compound Parabolic Concentrator.

The photodiode current can be detected using a trans-impedance amplifier. For the dual photodiode architecture embodiment, the photocurrent can first be converted from current to voltage using resistors with resistivity that provides high gain on the one hand to reduce noise, while having a wide enough bandwidth and no saturation on the other hand. An operational amplifier can be connected in photovoltaic mode amplification to the photodiodes, for minimum noise. Voltage dividers can provide a small bias to the operational amplifier (Op Amp) to compensate for possible bias current and bias voltage at the Op Amp input. Additional amplification may be preferable with voltage amplifiers.

In the embodiment of the spectrometer head shown in FIG. 12, each photodiode 263 is responsive to the illumination from typically many LEDs (or wavelengths). In order to identify the relative contribution of light from each of the LEDs, the LED current may be modulated, then the detected photocurrent of the photodiodes may be demodulated.

In some instances, the modulation/demodulation may be achieved by time division multiplexing (TDM). In TDM, each LED is switched “on” in a dedicated time slot, and the photocurrent sampled in synchronization to that time slot represents the contribution of the corresponding LED and its wavelength. Black level and ambient light is measured at the “off” times between “on” times.

In some instances, the modulation/demodulation may be achieved by frequency division modulation (FDM). In FDM, each LED is modulated at a different frequency. This modulation can be with any waveform, and preferably by square wave modulation for best efficiency and simplicity of the driving circuit. This means that at any given time, one or more of the LEDs can be “on” at the same time, and one of more of the LEDs can be “off” at the same time. The detected signal is decomposed to the different LED contributions, for example by using matched filter or fast Fourier transform (FFT), as known to those skilled in the art.

FDM may be preferable with respect to TDM as FDM can provide lower peak current than TDM for the same average power, thus improving the efficiency of the LEDs. The higher efficiency allows for lower LED temperatures, which in turn provide better LED spectrum stability. Another advantage of FDM is that FDM has lower electromagnetic interference than TDM (since slower current slopes can be used), and smaller amplification channel bandwidth requirement than TDM.

In some instances, the modulation/demodulation may be achieved by amplitude modulation, each at a different frequency.

When the LED array uses a shared-electrodes architecture, a single LED can be turned “on” when the corresponding row and column are connected (e.g., anode to power and cathode to GND). However, when more than one row and one column are switched “on”, all the LEDs sharing the connected rows and columns will be switched on. This can complicate the modulation/demodulation scheme. In order to resolve such a complication, TDM may be used, wherein a single row and a single column is enabled at each “on” time slot. Alternatively, combined TDM and FDM may be used, wherein a single row is selected with TDM, and FDM is applied on the columns (or vice versa). Alternatively, a 2-level FDM may be used, wherein each row and each column is modulated at different frequencies. The LEDs can be decoupled using matched filter or spectrum analysis, while taking special care to avoid overlapping harmonics of base frequencies.

### Spectrometer Positioned on a Mixer

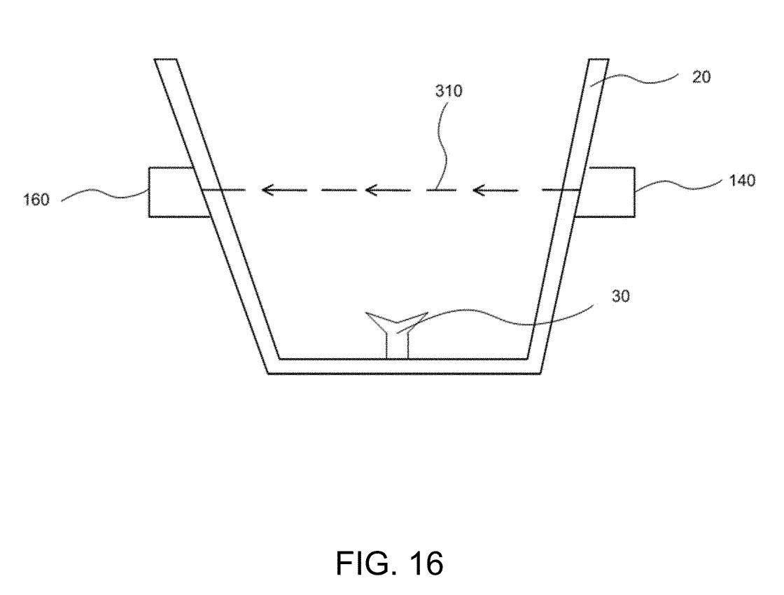

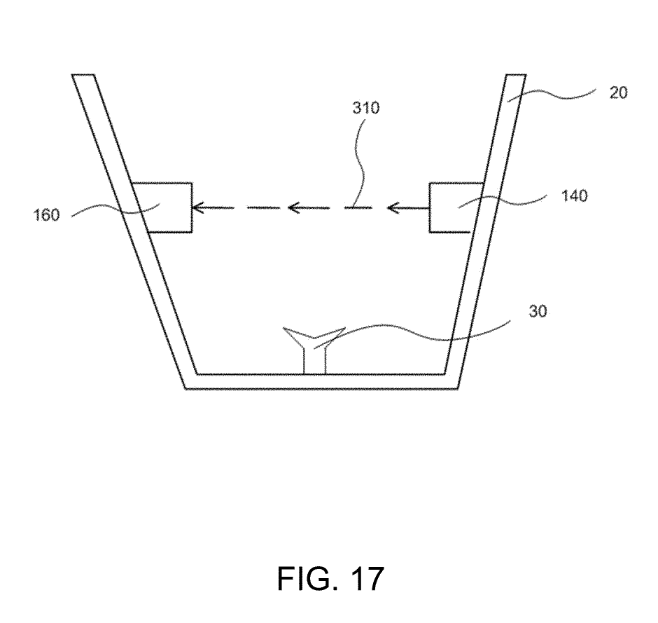

A light source or a spectrometer module may be positioned with respect to a location on a mixing container. FIG. 16 and FIG. 17 show schematic diagrams of a light 310 directed into a mixture, in accordance with examples of the present disclosure.

Spectra may be measured at one or more locations of a mixture or at one or more locations on a mixer. A location on a mixer or mixing container may include, but is not limited to, a lid, cap, fill cap, center cap, feed tube, plunger, rod, cover, base, housing, jar, mixing container, bowl, blade, mixing component, mixing component shield, shaft, beaker, spout, and any combination thereof. In some cases, a light source and/or a spectrometer module is positioned externally to a housing of the mixing container as shown in FIG. 16. In particular, FIG. 16 shows a schematic diagram of a light 310 directed from an externally positioned light source 140 to an externally positioned spectrometer module 160, in accordance with examples. Light source 140 and spectrometer module 160 are positioned on an external portion of housing 20 of a mixing container having a mixing component 30. Additionally, a light source and/or a spectrometer module may be positioned internally within a housing of the mixing container as shown in FIG. 17. In particular, FIG. 17 shows a schematic diagram of a light 310 directed from an internally positioned light source 140 to an internally positioned spectrometer module 160, in accordance with examples. Light source 140 and spectrometer module 160 are positioned on an internal portion of housing 20 of a mixing container having a mixing component 30. Further, a light source and/or a spectrometer module may be positioned at one or more of many locations on a mixer or mixing container. In some cases, a light source and/or spectrometer module is coupled to a mixing container or is coupled to a location on a mixing container. In some cases, the housing of the mixing container comprises a light source and/or spectrometer module, for example, the light source and/or spectrometer module may be built into or encased within the housing.

In some cases, absorption of the light is reduced or minimized. In some cases, absorption of the light is about or up to about 1%, 2%, 3%, 4%, 5%, 6%, 7%, 8%, 9%, 10%, 15%, 20%, 25%, 30%, 35%, 40%, 45%, or 50%. In some cases, the light source produces a powerful light. In some cases, the housing, mixing container, or container is small. In some cases, the housing, mixing container, or container has a volume of about or at least about 5, 8, 10, 15, 16, 20, 30, 32, 40, 50, 60, 64, 70, 80, 90, 100, 128, or 200 fluid ounces. In some cases, the housing, mixing container, or container has a volume of up to about 5, 8, 10, 15, 16, 20, 30, 32, 40, 50, 60, 64, 70, 80, 90, 100, 128, or 200 fluid ounces. In some cases, the housing, mixing container, or container has a volume of about or at least about 10, 50, 100, 200, 300, 400, 500, 600, 700, 800, 900, 1,000, 2,000, or 5,000 mL. In some cases, the housing, mixing container, or container has a volume of up to about 10, 50, 100, 200, 300, 400, 500, 600, 700, 800, 900, 1,000, 2,000, or 5,000 mL. In some cases, the distance between the light source and the spectrometer module (e.g., separation distance) is small (e.g., within the range from 5 mm to 30 mm).

In some cases, a spectrometer, light source, and/or spectrometer module is removable. In some cases, a spectrometer, light source, and/or spectrometer module is not removable. In some cases, the position of a spectrometer, light source, and/or spectrometer module is adjustable. In some cases, a spectrometer, light source, and/or spectrometer module is washable, machine washable, hand washable, water resistant, and/or waterproof.

In some instances, as illustrated in FIG. 16 and FIG. 17, a light source 140 and a spectrometer module 160 may be positioned on opposite sides of the housing 20. The light source may illuminate a mixture within the mixing container with a light 310 which is received at the spectrometer module. In other cases, a light source and a spectrometer module may be positioned at an angle to one another. In additional cases, a spectrometer module may be positioned at an angle relative to more than one light source. A second spectrometer module can be placed on the same side of the housing as the light source, which can be helpful to measure backscattered light from the sample in combination with light transmitted through the sample. Alternatively or in combination, the second spectrometer module can be located on the opposite of the housing away from a direct path of light in order to measure forward scattered light. The combination of spectrometer modules at different locations can provide information related to light scatter and absorption. The spectral data from the combination of spectrometers can provide improved determination of the mixture within the container.

In some instance (similar to using multiple spectrometers to measure absorption, back-scatter and forward-scatter), it may be preferable (and cheaper) to use a single spectrometer and multiple illumination sources for the same principle, but it is also contemplated that multiple spectrometers can be used. For example the light sources may be switched on alternately to distinguish between their contributions to the measured spectrum. In a more general case two or more illumination sources and two or more spectrometers can be used. Alternatively, a single illumination module or a single spectrometer may preferably be alternately placed in multiple locations instead of using multiple devices in order to reduce cost and size, and also improve accuracy and repeatability of the measurements. Similarly, the illumination module or spectrometer can be rotated relative to the light directions in order to be alternately sensitive to absorption spectrum or scattering spectrum. Yet another option is to use a revolving mirror in the optical path (for example near the illumination module in order to steer the illumination beam to different directions. These options can also be combined. For example, multiple spectrometers and illumination modules that can be moved between different positions and also rotated, to provide the most interesting and informative spectrum on the specific mixture under test.

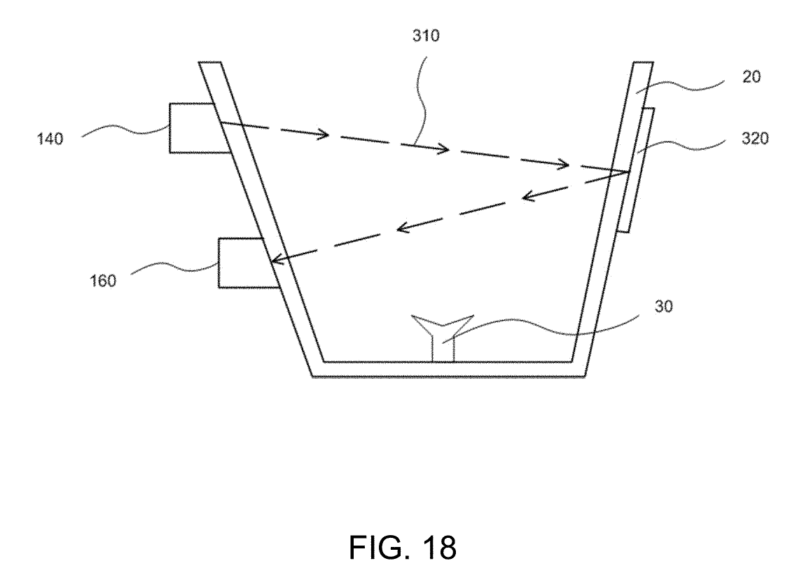

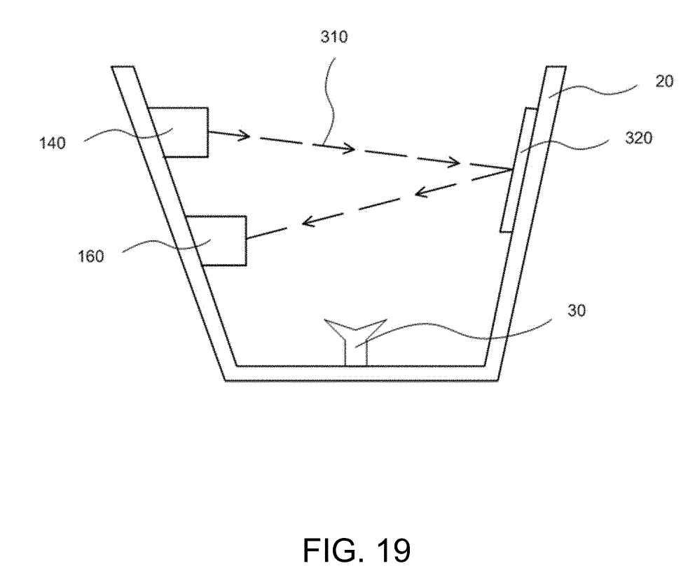

In some cases, as illustrated in FIG. 18 and FIG. 19, a light source and a spectrometer module may be positioned on one side of the housing while an optional optical element 320 may be positioned opposite the light source and spectrometer module. The optical element may comprise a reflective element or a diffuser, for example.

In examples, at least one of the light source, spectrometer module, and optical element may be positioned external to a housing of the mixing container. In particular, FIG. 18 shows a schematic diagram of a light 310 directed from an externally positioned light source 140 to an externally positioned spectrometer module 160 after contacting an externally positioned optical element 320, in accordance with examples. As seen in FIG. 18, light source 140, spectrometer module 160, and optical element 320 are positioned on an external portion of housing 20 of a mixing container having a mixing component 30. In other examples, at least one of the light source, spectrometer module, and optical element may be positioned internal to a housing of the mixing container. In particular, FIG. 19 shows a schematic diagram of a light 310 directed from an internally positioned light source 140 to an internally positioned spectrometer module 160 after contacting an internally positioned optical element 320, in accordance with examples. As seen in FIG. 19, light source 140, spectrometer module 160, and optical element 320 are positioned on an internal portion of housing 20 of a mixing container having a mixing component 30. In further examples, at least one of a light source, spectrometer module, and optical element may be positioned within the housing of a mixing container itself. In some cases, an optical element is able to be detachably coupled to a mixing container or is able to be detachably coupled to a location on a housing of the mixing container or on the lid, and combinations thereof, for example. In some cases, the housing of the mixing container comprises an optical element, for example, the optical element may be built into or encased within the housing.

A reflective element may reflect light directed from the light source to the spectrometer module. A reflective element can comprise a material that is a diffuse reflector or a specular reflector. The reflective element can be configured in many ways, and may comprise a material of the housing or a separate material, for example. The housing may comprise a reflective material such as stainless steel, for example. Alternatively or in combination the housing may comprise a reflective high index material such as a high index plastic. The reflective element may comprise a portion of the housing shaped to reflect light, for example. Alternatively or in combination, the reflective material can be configured to diffuse light, for example with a rough surface to scatter light, for example.

The reflective element can be embedded in the mixing container, for example placed in a recess of housing. The reflective element can comprise a material that is both a specular and diffuse reflector. The reflective element can comprise a smooth coating (e.g., polished gold coating) to permit specular reflection. The reflective element can comprise a material that is metallic, for example gold. The reflective element may comprise a mirror, and can be shaped in many ways. The reflective element can be curved to focus light with convergence toward the spectrometer module, or to diverge reflected light. Alternatively, the reflective element can be shaped such that the incident light appears infinite to the detector, e.g. collimated.

A protective layer can be provided over the reflective element to protect the reflective element from liquid. A protective layer can be provided over the reflective element to prevent the reflective element from contacting the liquid and/or from getting wet. The protective layer can be transparent. The protective layer can be glass, plastic, or a cured transparent resin. In some cases, the reflective material can be formed from a material that is resistant to liquids. The reflective material can be formed from a material that can be exposed to a liquid without breaking, eroding, reacting, or becoming unusable, for example. In some cases, the reflective element can be formed from opal glass or sand blasted metal (e.g., aluminum, steel, copper, brass, or iron). In cases, where the reflective element is resistant to liquids the protective layer can be omitted.

The reflective element can increase the amount of light reflected towards the spectrometer module or increase the intensity of light reflected towards the spectrometer module. The reflective element can increase accuracy by increasing signal from liquids that are transparent (e.g., transparent to light in the IR range). The reflective element can increase accuracy by increasing signal from liquids with low scattering characteristics.

At least a fraction of the inside of the mixing container can be coated with a reflective material. The reflective material can be a metallic material. The reflective material can reflect at least a fraction of the light emitted by a light source.

The spectrometer module may comprise a diffuser. The main function of the diffuser in the Spectrometer is to generate internal illumination in all angles of interest, irrespective of the angular distribution of the incoming illumination. The diffuser can provide improved measurement of the scattering material. The diffuser can decrease sensitivity of the spectrometer to changes in amounts of light scattering of the mixture, and can allow the spectrometer to work well with both substantially transparent low scattering materials and highly scattering materials such as blended foods. In many configurations, a diffuser can be placed in front of other elements of the spectrometer. The diffuser can be placed in a light path between a light source and a spectrometer module and/or filter. Collimated (or partially collimated light) can impinge on the diffuser, which then produces diffuse light which then impinges on other aspects of the spectrometer, e.g., an optical filter or spectrometer module. The diffuser may comprise any material well-known in the art to have light-diffusing properties, such as opal glass, Spectralon™, Polytetrafluoroethylene (PTFE), sandblasted glass, and ground glass. The diffuser may comprise a diffusing layer deposited, coated, fused, or otherwise coupled to an optical substrate such as glass.

The mixer or mixing container can comprise an insert comprising a structure configured to hold a light source, spectrometer module, diffuser, and/or reflective element in a predetermined position and orientation.

In some instances, the total optical path between the light source and the spectrometer module is within a range defined by any two of: 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, or 70 mm; or more than 30 mm, for example. In some cases, the total optical path between the light source and the spectrometer module is within a range from about 5 mm to about 30 mm, such as within a range from about 10 mm to about 20 mm. In some cases, one or more of the light source, spectrometer module, and/or optical element are not positioned across the entire length of the housing. In some cases, one or more of the light source, spectrometer module, and/or optical element are positioned in a section of the housing or are in proximity to one another. Preferably, the total optical path from the source to the detector is on the order of 30 mm due to water absorption; an optical path that is too long, for example ˜70 mm or more, may lead to too large a signal due to water absorption for a mixture that includes mostly water that may obscure the signal of interest. It is also contemplated, however, that the total optical path can be longer, for example up to 70 mm, depending on the optical signal of interest.

In some cases, a light source and a spectrometer module may be positioned near a spout of a mixing container. In particular, the spout may form a part of the housing of the mixing container. When a light source and a spectrometer module are positioned at the spout, the light source and spectrometer module may be used as a spectrometer system to measure properties of a mixture that is poured from the mixing container. In particular, one or more properties of a mixture that is poured from the mixing container may be measured as the mixture leaves the mixing container. In some examples, the one or more properties of the mixture may be assessed continually.

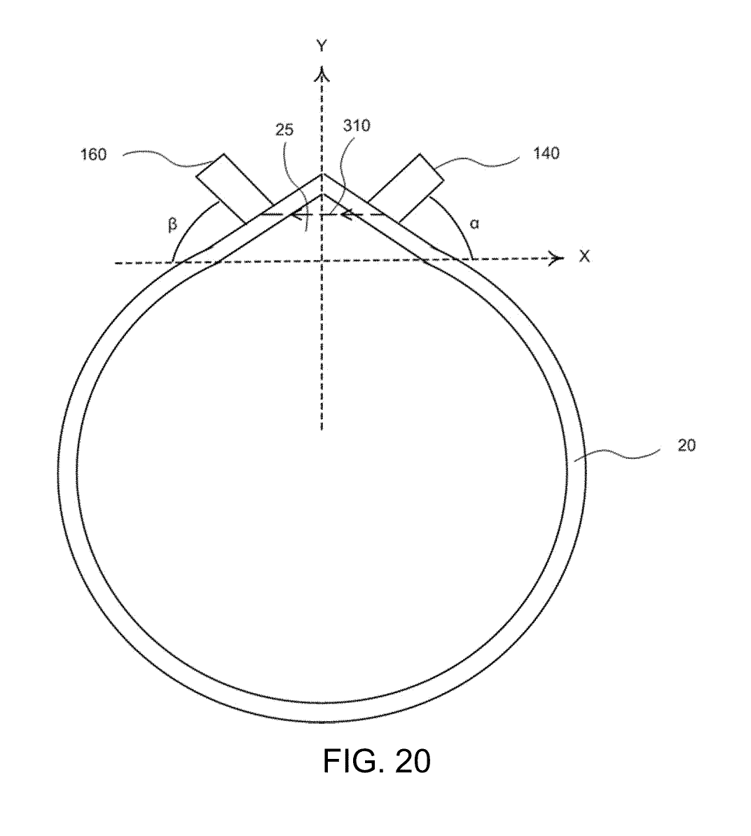

In some examples, a light source and/or a spectrometer module may be positioned externally to the spout. This is illustrated in FIG. 20, which shows a schematic diagram of a light directed from an externally positioned light source to an externally positioned spectrometer module near a mixing container spout, in accordance with examples. In particular, FIG. 20 illustrates a light 310 that passes through a mixing container at the location of a spout 25 within the housing 20 of the mixing container. The light 310 passes from a light source 140 to a spectrometer module 160. In FIG. 20, the light source 140 is at an angle to spectrometer module 160.

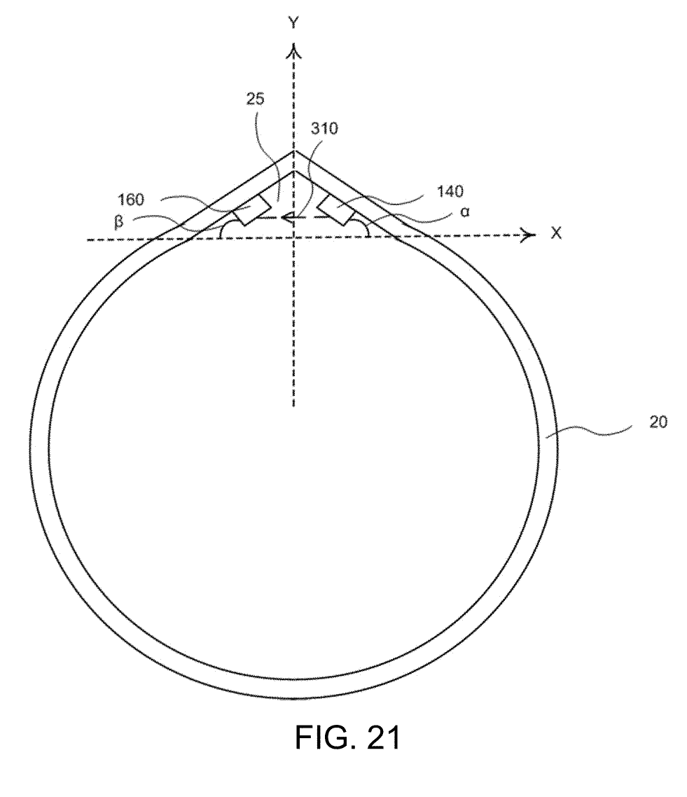

In other examples, a light source and/or a spectrometer module may be positioned internally to the spout. This is seen in FIG. 21, which shows a schematic diagram of a light directed from an internally positioned light source to an internally positioned spectrometer near a mixing container spout, in accordance with examples. In particular, FIG. 21 illustrates a light 310 that passes through a mixing container at the location of a spout 25 within the housing 20 of the mixing container. The light 310 passes from a light source 140 to a spectrometer module 160. In FIG. 21, the light source 310 is at an angle to spectrometer module 160.

In some cases, a light source and/or spectrometer module may be detachably coupled to the spout, either separately or together as parts of a module that can be placed on the blender housing. In some cases, the spout comprises a light source and/or spectrometer module, for example, the light source and/or spectrometer module may be built into or encased within the spout. In some cases, a light source is positioned at an angle α with respect to a referential X-axis, such as the X-axis that is illustrated in FIGS. 20 and 21. In some cases, a spectrometer module is positioned at an angle β with respect to a referential X-axis. In some cases, α and/or β are within the range from about 0-90 degrees, such as with the range from about 0-80, 0-70, 0-60, 0-50, 0-40, 0-30, 0-20, or 0-10 degrees. In some cases, α and/or β are 0. For example, in applications where the measured spectrum is of scattered illumination, the angles α and β are preferably substantially different from 0°, such that an optical axis of the light beam initially points into the mixture away from the detector and is scattered into the detector. In applications where the measurement is of illumination that is essentially absorbed by the fluid, the angles α and β are preferably close to 0°, such that an optical axis of the light beam points toward the spectrometer.

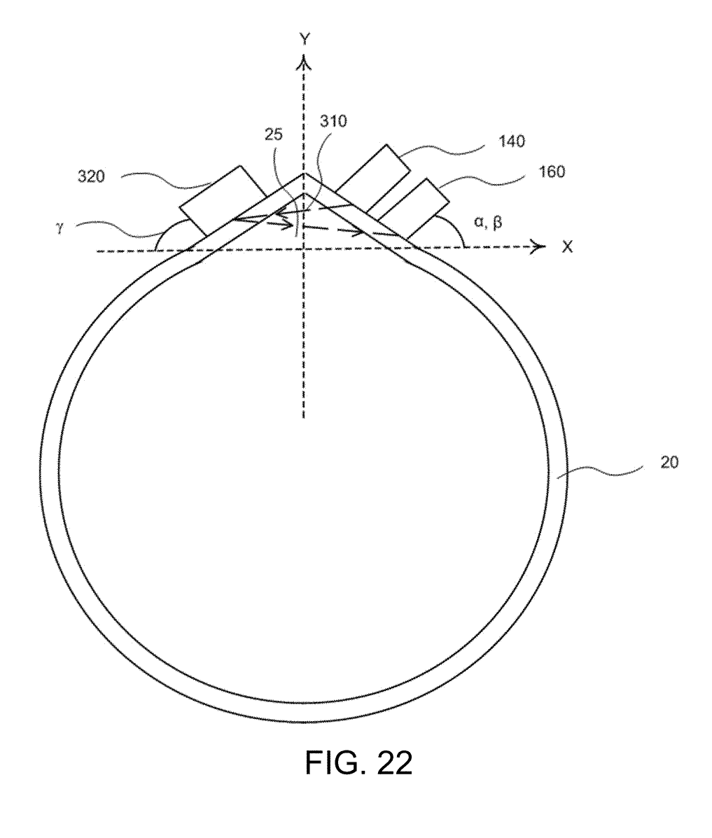

In some cases, a light source and a spectrometer module may be positioned on one side of a spout of the housing of a mixing container. Additionally, an optical element may be positioned opposite the light source and spectrometer module. The optical element may be a reflective element or a diffuser. In some cases, a light source, spectrometer module, and/or optical element may be positioned externally to the spout as shown in FIG. 22. In particular, FIG. 22 shows a schematic diagram of a light 310 directed from an externally positioned light source 140 to an externally positioned spectrometer module 160 after contacting an externally positioned optical element 320 near a mixing container spout 25, in accordance with examples. As seen in FIG. 22, the light source 140 and the spectrometer module 160 are positioned on the same side of the spout 25 that is within the housing 20 of the mixing container. As such, light 310 crosses a mixture holding area within the mixing container before contacting optical element 320. Additionally, light 310 passes through housing 20 so as to reach the optical element 320.

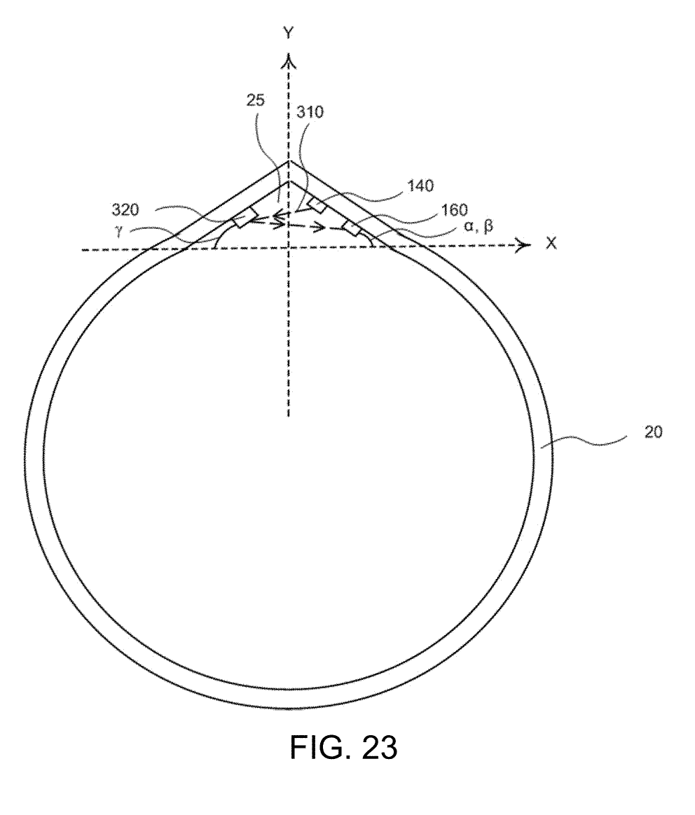

Alternatively or in combination, in some cases, a light source, spectrometer module, and/or optical element may be positioned internally to the spout as shown in FIG. 23. In particular, FIG. 23 shows a schematic diagram of a light 310 directed from an internally positioned light source 140 to an internally positioned spectrometer module 160 after contacting an internally positioned optical element 320 near a mixing container spout 25, in accordance with examples. As seen in FIG. 23, the light source 140 and the spectrometer module 160 are positioned on the same side of the spout 25 that is within the housing 20 of the mixing container before contacting the optical element 320. As such, light 310 crosses a mixture holding area within the mixing container. Additionally, as each of the light source 140, spectrometer module 160, and optical element 320 are within the mixing container, light 310 does not need to pass through a part of housing 20 to measure spectra of a mixture within a mixing container.

In some cases, a light source, spectrometer module, and/or optical element is detachably coupled to the spout. In some cases, the spout comprises a light source, spectrometer module, and/or optical element, for example, the light source, spectrometer module, and/or optical element may be built into or encased within the spout. In some cases, a light source is positioned at an angle α with respect to a referential X-axis, in which the X-axis extends transverse to the direction of flow of the material out of the spout. The Y-axis can extend in a direction between a center of the blender and the spout, such that the X-axis extends transverse to the Y-axis and the direction of material flow along the spout. In some cases, a spectrometer module is positioned at an angle β with respect to the X-axis. In some cases, an optical element is positioned at an angle γ with respect to the X-axis. In some cases, α, β, and/or γ are within the range from about 0-90 degrees, such as with the range from about 0-80, 0-70, 0-60, 0-50, 0-40, 0-30, 0-20, or 0-10 degrees. In some cases, α, β, and/or γ are 0.

In some cases, the spectrometer module may be positioned at the base of the mixing container, for example the spectrometer module may be coupled to an arm coupled to the mixing component, and the light source may be placed above facing the spectrometer module. In some cases, the light source may be positioned at the base of the mixing container, for example the light source may be coupled to an arm coupled to the mixing component, and the spectrometer module may be placed above facing the light source.

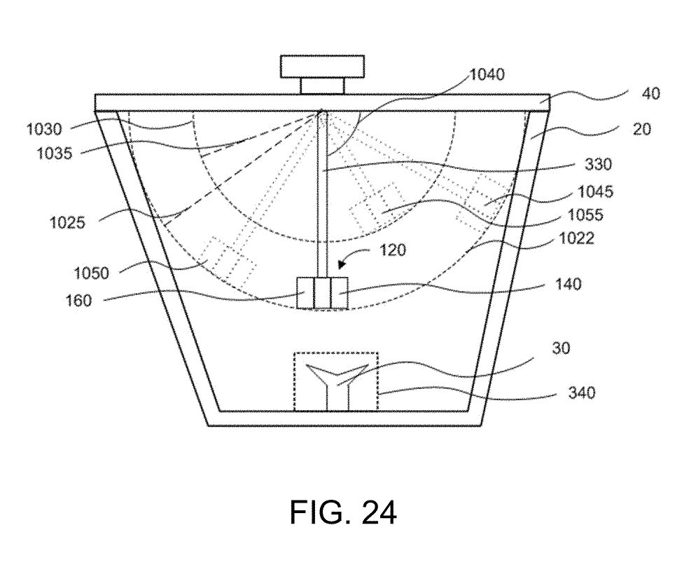

In some cases, as shown in FIG. 24, a light source 140 and/or spectrometer module 160 may be coupled to an elongate member such as a rod 330, wherein the rod is coupled to the lid 40 of the mixing container. In some cases, the light source and/or spectrometer module is contained in a spectrometer head 120 or a support or casing. In some cases, the rod and/or head is moveable. For example, a user may control the position of the light source and/or spectrometer module in the mixing container. The rod may be moved downward or upward. For example, the rod may be moved within a first hemisphere 1022 at a first radius 1025, or within a second hemisphere 1030 at a second radius 1035. The rod may be positioned at an angle 1040 with respect to the lid of the mixing container. In some cases, the angle 1040 is within the range from about 0-180 degrees, such as with the range from about 0-180, 10-170, 20-160, 30-150, 40-140, 50-130, 60-120, 70-110, or 80-100 degrees. In some cases, the angle 1040 is 90. The rod, support, light source, and/or spectrometer module may be moved within the mixture or mixing container to one or more positions, such as position 1045, position 1050, or position 1055. The rod, support, light source, and/or spectrometer module may be moved prior to mixing, during mixing, or after mixing.

In some cases, the rod may be inserted into the mixing container 14 from the sides of the container, for example from the sides of the mixer housing.

In some cases, the mixing component 30 may be protected by a mixing component shield 340, where the shield may prevent the rod or support from interfering with the mixing component, or where the shield may prevent the rod, support, light source and/or spectrometer module from being damaged by the mixing component. In some cases, the mixing component shield is permeable. In some cases, the length of the rod is designed to prevent contact with the mixing component.

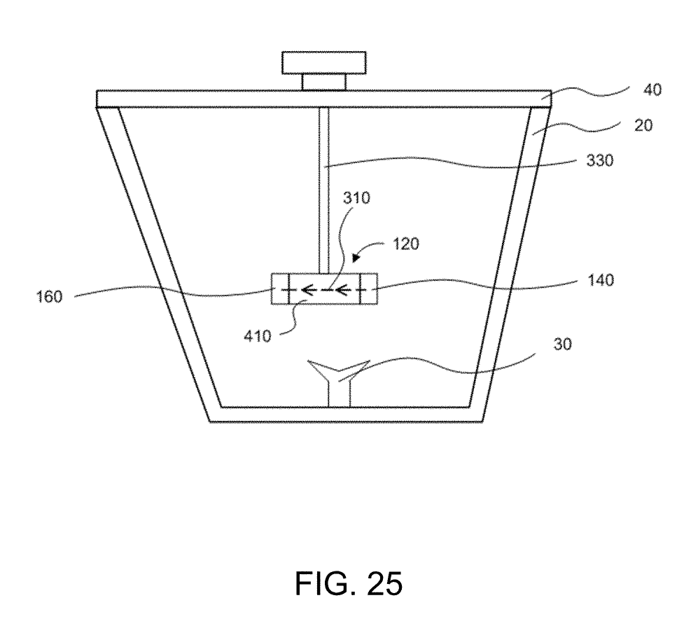

In some cases, as shown in FIG. 25, a light source 140 and/or spectrometer module 160 may be coupled to a rod 330 within a housing 20 of a mixing container. The rod 330 may be detachably coupled to a lid 40 of the mixing container. Additionally, the light source may direct light 310 into a mixture within the mixing container to the spectrometer module. The mixture within the mixing container may be mixed using mixing component 30. In some cases, the light source and/or spectrometer module is contained in a spectrometer head 120 or a support or casing. In some cases, the spectrometer head comprises a channel 410 between the light source and spectrometer module and through which the mixture may pass and light may be directed.

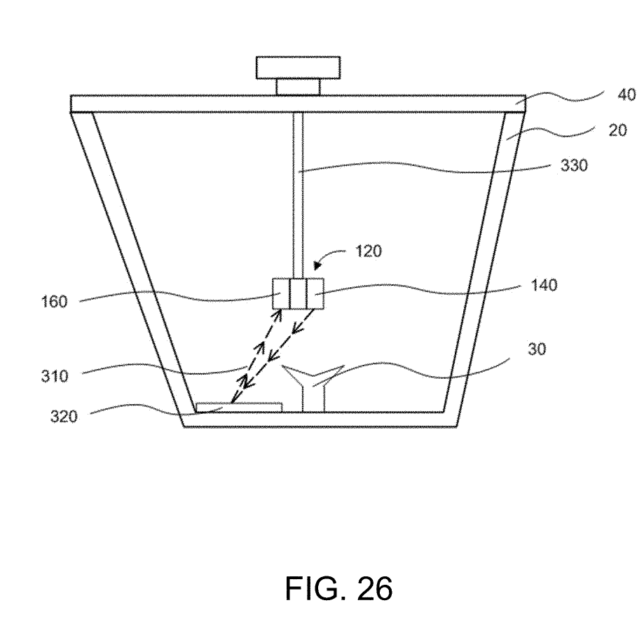

In some cases, as shown in FIG. 26, a light source 140 and/or spectrometer module 160 may be coupled to a rod 330 within a mixing container. The mixing container may have a housing 20 and a mixing component 30. Additionally, the light source 140 and/or spectrometer module 160 may be held within a spectrometer head 120. An optical element 320 may be positioned opposite the light source and spectrometer module. The optical element may be a reflective element or a diffuser. In some cases, the optical element is positioned externally to a housing of the mixing container, within a mixing container as shown in FIG. 26, or in a location on a mixer or mixing container. In some cases, an optical element is coupled to a mixing container or is coupled to a location on a mixing container. In some cases, the housing of the mixing container comprises an optical element, for example, the optical element may be built into or encased within the housing. In some instances, a light source and/or spectrometer module is coupled to the lid of the mixing container, for example to the inside of the lid 40.

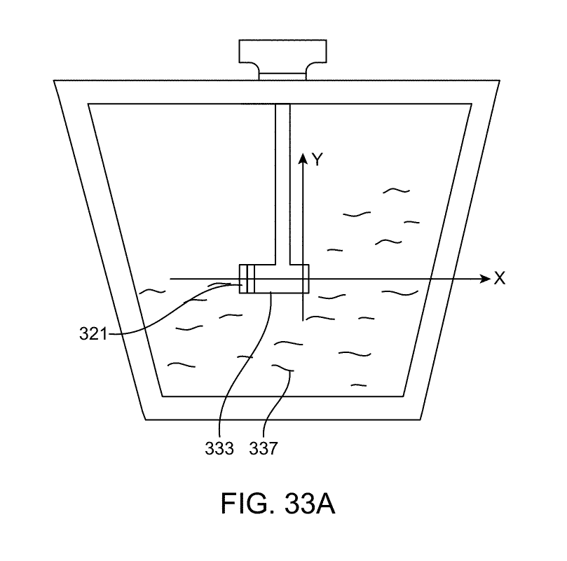

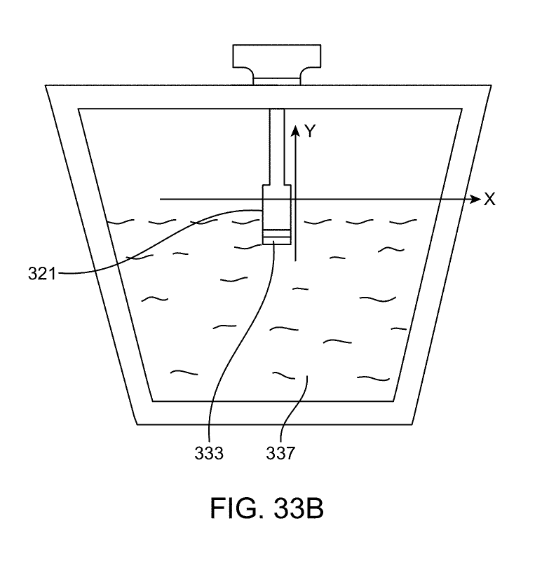

In some cases, as shown in FIGS. 33A and 33B an optical element 321 or a calibration element may be attached to or included in an accessory 333 such as the liquid accessory.

For example, as shown in FIG. 33 the optical head may be positioned horizontally in parallel to axis X and fluid such as a mixture may enter into the gap between the optical head and the accessory.

In some cases, as shown in FIG. 33B the optical head and the accessory may be positioned vertically in parallel to axis Y thus enabling fluid to enter easily into the liquid accessor (e.g., the gap between the optical element and the accessory).

In some cases, an optical head is an optical head of the spectrometer. In some cases, the terms “optical head” and “spectrometer head” are used interchangeably.

In some cases, the optical element or the accessory may be coupled to the rod 330, placed for example in proximity to the optical element.

In some cases, as shown in FIG. 36 the optical element may positioned above and/or in proximity to the mixing component 30 while the optical head is attached to the mixer cover.

In some cases, the optical head may positioned above and/or in proximity to the mixing component 30 while the optical element is attached to the mixer cover.

For example a holder 29, such as attachable holder comprising a plurality of legs 31, may be used to hold the optical element in the center of the container in front of the optical head.

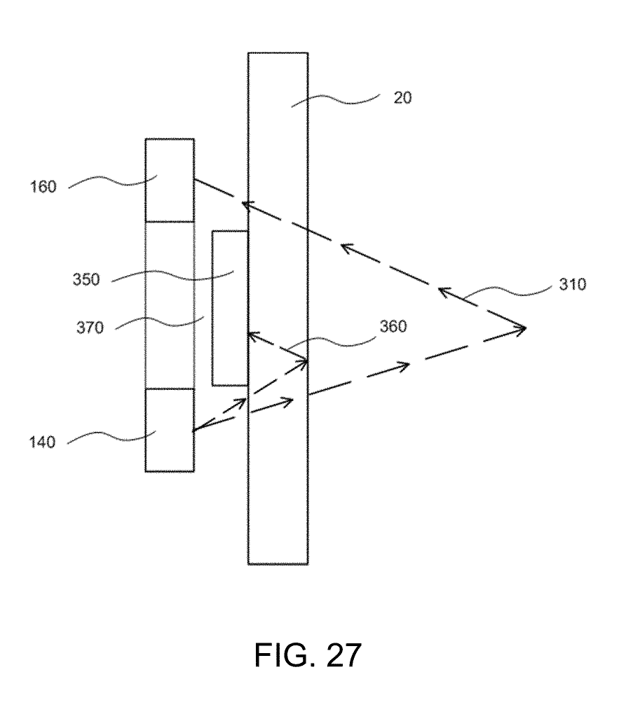

In some cases, as shown in FIG. 27, the mixing container comprises a light blocker 350. The light blocker may be configured to block light such as scattered light reflected from the housing of the mixing container. In some cases, the light blocker is positioned between a spectrometer module 160 and the housing 20 of the mixing container. In some cases, a light blocker is coupled to the mixing container. In some cases, the light blocker may be built into or encased within the mixing container, for example, in the housing of the mixing container. In some cases, the light blocker is configured to block light such as scatter light 360 reflected from the housing.

A light blocker 350 can be arranged with the source and detector in order to block light 360 that does not enter the mixture such that the light from the source that does not enter the spectrometer does not enter the spectrometer module. For example, reflections of the light 360 from the surface of the mixing container housing may be blocked, when the illumination module and spectrometer module are placed in proximity to one other on the same side of the mixing container housing. Alternatively, the blocker can be integrated into the blender housing.

In some cases, the light blocker can be directly attached to the spectrometer module, or can be separated by an air gap 370. The air gap can be at least 1, 2, 3, 4, 5, 6, 7, 8, 9, 10, 12, 14, 16, 18, 20, 30, 40, or 50 micrometers. The air gap can be at least 0.1, 0.2, 0.3, 0.4, 0.5, 0.6, 0.7, 0.8, 0.9, 1.0, 1.5, 2.0, 2.5, 3.0, 3.5, 4.0, 5.0, 6.0, 7.0, 8.0, 9.0, or 10.0 mm. The air gap can be less than 10, 9, 8, 7, 6, 5, 4, 3, 2 or 1 micrometers. In some cases, the light blocker touches the spectrometer module. Preferably, the air gap is sufficiently small to substantially inhibit leakage of light from the illumination module to the spectrometer module. The gap can be as small as possible to eliminate light leakage from the illumination module side of the blocker to the spectrometer side of the blocker, for example.

In some cases, the mixer, mixing container, or spectrometer may be configured to block ambient light interfering with the measurement process. For example, the light source may provide shade, or strong enough illumination combined with short sensor exposure time for sampling the ambient light before and/or after the sample illumination is turned on. The sampling of ambient light before and/or after the sample illumination is turned on can be subtracted from the mixture sample measurement to remove an effect of ambient light on the measurement.

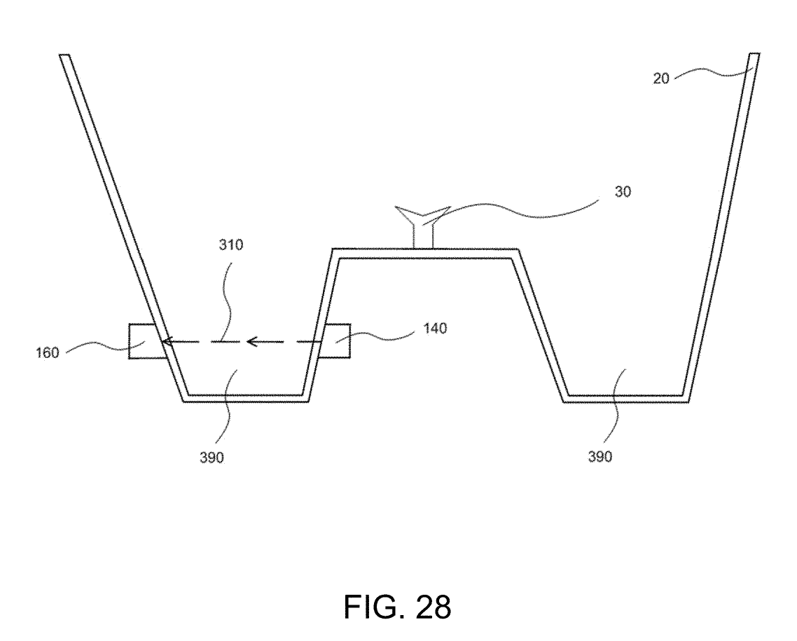

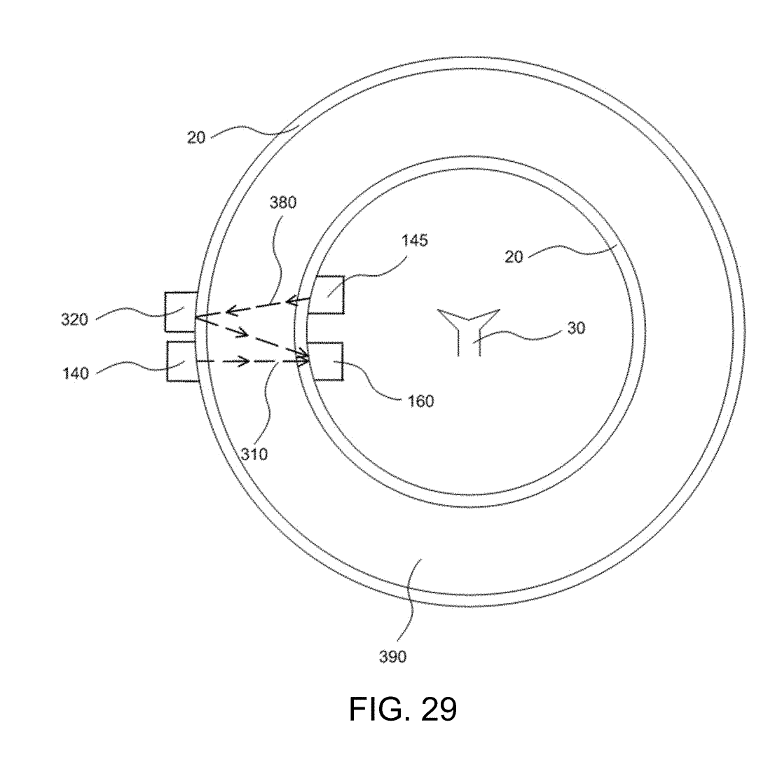

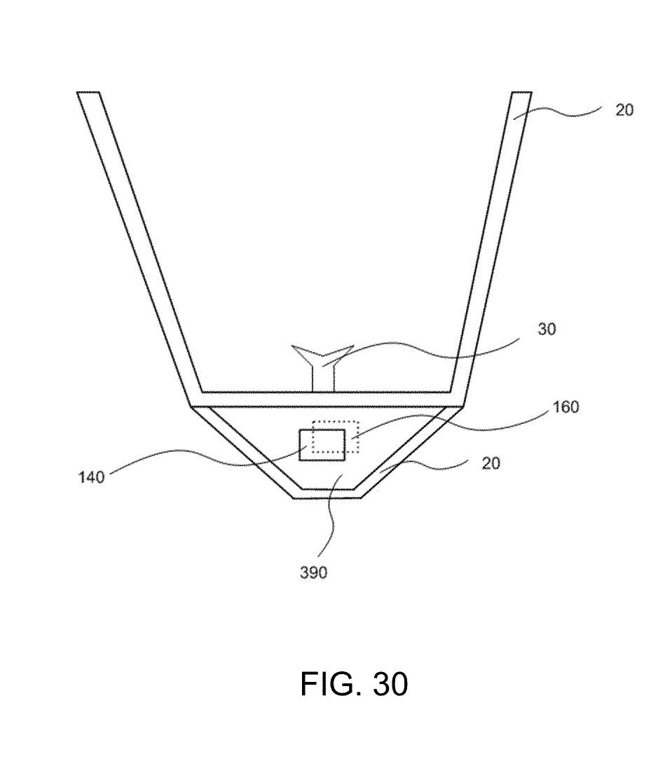

In some cases, as shown in FIG. 28, FIG. 29, and FIG. 30, the mixing container comprises a recessed channel 390. An illumination module 140, spectrometer module 160, optical element 320, and/or light blocker 350 may be positioned on any side of the recessed channel 390 of the mixing container.

FIGS. 28, 29 and 30A-C illustrate additional examples for positioning the spectrometer and illumination relative to the blender and container.

FIG. 28 shows a schematic diagram of a cross section of a mixing container with a recessed annular channel, in accordance with examples. In some cases, an illumination module 140 is positioned on an inner wall of a recessed channel 390 at the bottom of the mixing container and may direct a light 310 towards a spectrometer module 160 on an outer wall of the recessed channel or vice versa. The illumination can enter from the outer wall of a recessed ring at the bottom of the container towards the spectrometer on the inner wall of the ring. However, this can be the other way round (illumination from the inner wall towards a spectrometer at the outer wall).

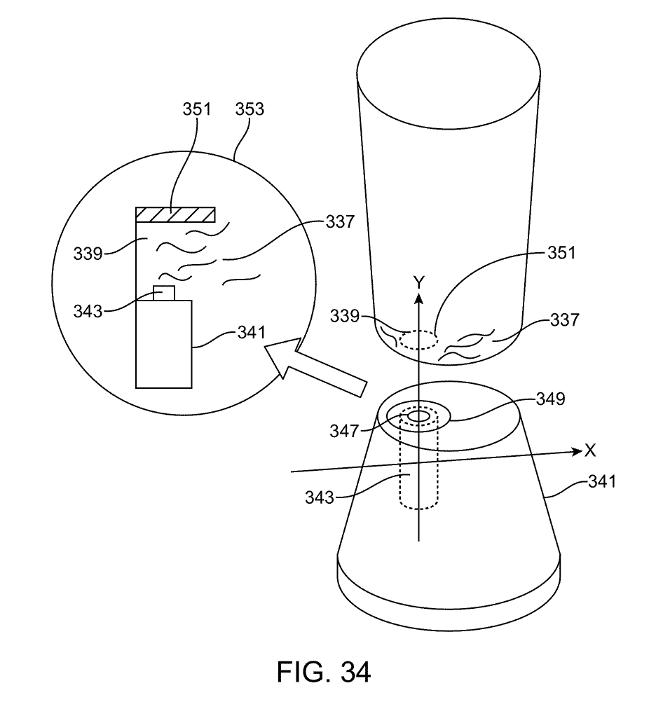

FIG. 34 shows a schematic diagram of a mixing container wherein the spectrometer and/or the optical head and/or the light source may be part of or may be attached to the mixer base 341. For example, according to some cases, the optical head 343 may be positioned in parallel to axis Y where the optical head window 347 may illuminate the bottom part of the mixing container. In some cases, the mixer box may include a dedicated opening or window 349 and the optical head may be attached below the window 349 for illuminating the mixer content along the Y axis.

In some cases, an optical element head may be positioned in front of the optical element. For example, the optical element may be attached to the mixing chamber bottom. In some cases, the optical element may be embedded in the mixing chamber housing.

In some cases, a gap 339 is formed between the elements (e.g., between element 343 and element 351) to enable mixture 337 to enter the gap.

A detailed cross section view 353 of the optical head and the optical element position is illustrated in FIG. 34.

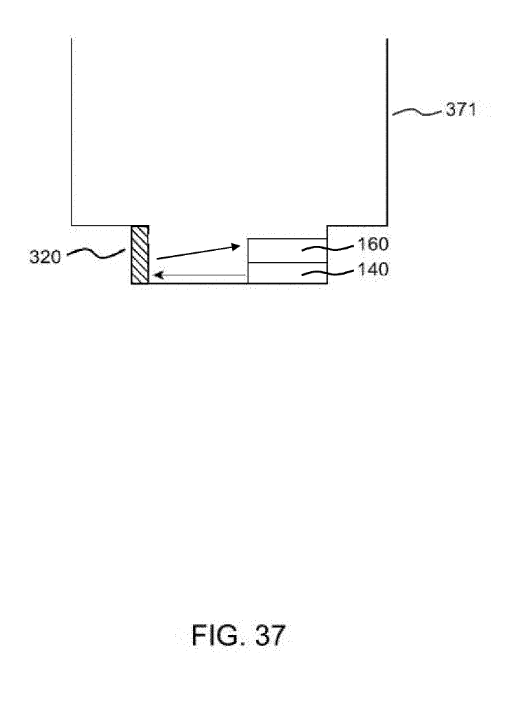

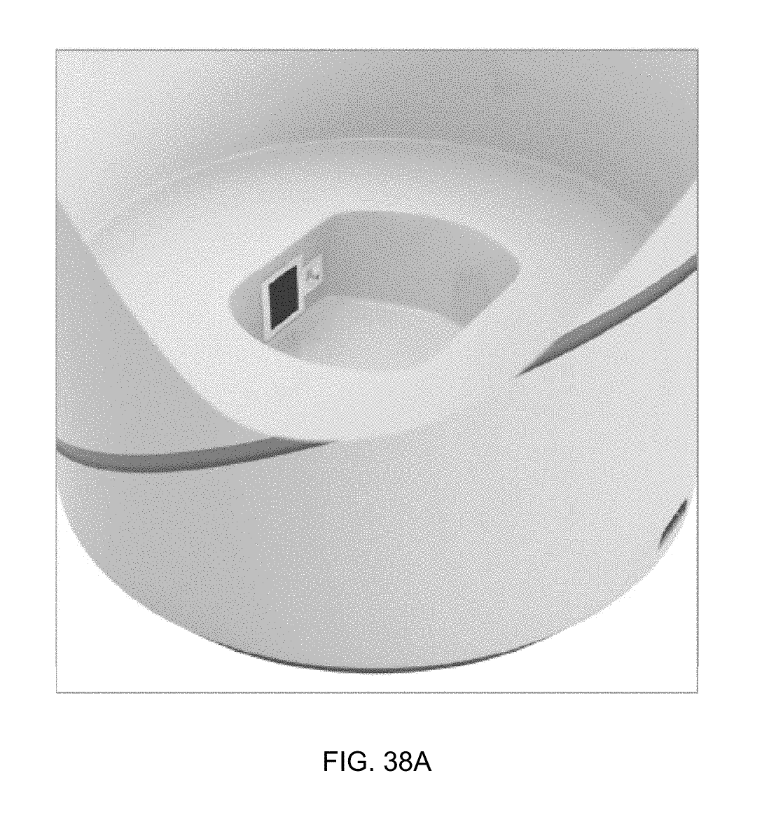

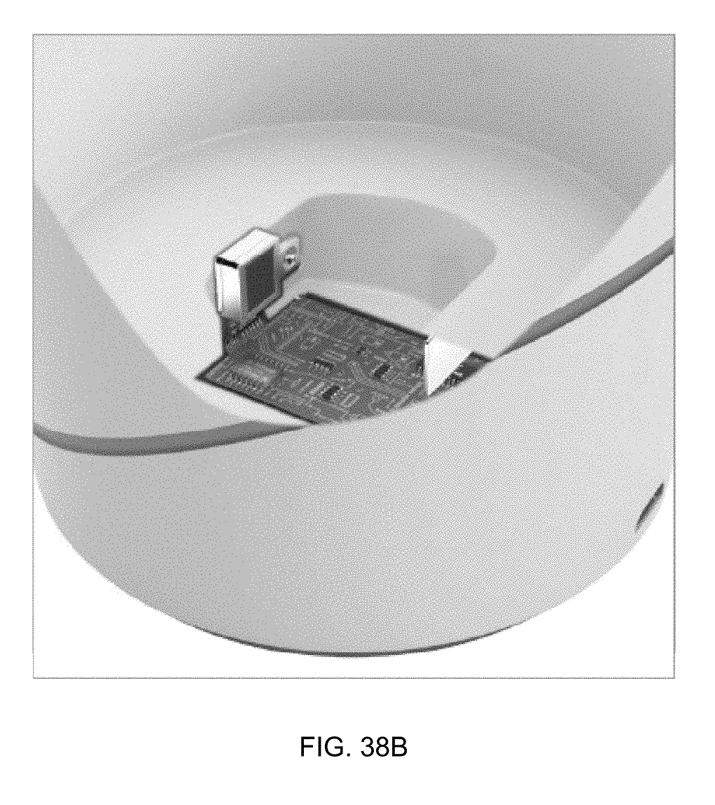

FIG. 37 shows a schematic diagram of a cup or container 371 comprising a light source and spectrometer module, in accordance with examples. In some cases, a container can be configured as described herein for a mixing container with or without a mixing component 30. In some cases, an illumination module 140 can direct a light to a reflecting optical element 320 from which the light can be reflected back towards a spectrometer module 160. In some cases, an illumination module 140 can direct a light directly to a spectrometer module 160. FIGS. 38A and 38B show cutaway diagrams of a cup comprising a light source and spectrometer module, in accordance with examples.

In some cases, a container can include, but is not limited to, a cup, jar, mason jar, mixing container, bowl, pot, pan, beaker, mug, coffee mug, beer mug, beer stein, thermos, insulated drinkware, tea cup, drinkware, glassware, glass, drinking glass, water bottle, baby bottle, cocktail glass, martini glass, and wine glass. In some cases, the distance between the light source and spectrometer module can be reduced or minimized, for example by placing the light source and spectrometer module at a spout, a narrower end of the container (e.g., at a narrower base or lip), or in a well, recess (e.g., recessed channel), or indentation within a base or wall of the container.

A container or mixing container disclosed herein or a method disclosed herein may monitor or track liquid consumption (e.g., daily liquid consumption), monitor one or more nutritional parameters (e.g., calories, carbohydrates, sugars, fats, protein), identify type of beverage or mixture, measure volume consumed, or analyze nutritional ingredients.

FIG. 29 shows a schematic diagram of a top view of a mixing container with a recessed channel, in accordance with examples. In some cases, an illumination module 140 is positioned on an outer wall of a recessed channel 390 at the bottom of the mixing container and may direct a light 310 towards a spectrometer module 160 on an inner wall of the recessed channel or vice versa. In some cases, a second illumination module 145 is positioned on the opposite wall of the recessed channel from the first illumination module 140. The second illumination module can direct a second light 380 towards a reflecting optical element 320 from which the second light is reflected back towards the spectrometer module 160. The recessed channel may be filled with the sample mixture. The additional module 145 is positioned adjacent to the inner wall of the ring, illuminating a reflecting optical element from which the illumination is reflected back towards the spectrometer adjacent to the inner wall of the ring. The ring is filled with the blended mixture.

The sample mixture in the recessed channel is preferably representative of the mixture at other locations in the mixing container. In some cases, the recessed channel is deeper at the location where the illumination module and/or spectrometer module are positioned and is shallower elsewhere. FIG. 30 shows a schematic diagram of another cross section of a mixing container with a recessed channel, in accordance with examples. The viewpoint of FIG. 30 is orthogonal to that of FIG. 28 and FIG. 29. The width of the recessed channel 390 is preferably between 5 mm and 20 mm, such that the optical path through the mixture provides a strong signal. The material of the mixing container housing 20 may be transparent in the wavelength range of interest (e.g., 700 nm to 1000 nm) and durable (e.g., with a stable transmission spectrum). In some instances, glass, quartz, or sapphire windows may be embedded in the mixing container housing along the optical path from the illumination module 140 to the reflecting optical element 320 and/or spectrometer module 160.

In some cases, the spectrometer system may include one or more optical fibers, optical light pipes, and/or optical light guides to guide light to the illumination module, spectrometer module, and/or reflecting optical element. In some cases, the directed light passes into the sample mixture at least once before being detected by the spectrometer module. The use of optical fibers, light pipes, or light guides may allow flexible positioning of the illumination module, spectrometer module, and/or reflecting optical element without compromising industrial design and/or aesthetic considerations. A person of ordinary skill in the art will recognize many combinations in accordance with the present disclosure.

In some cases, the distance between a mixture and where a light is directed from is the contact distance. In some cases, the distance between a mixture and a light source is the contact distance. In some cases, a contact distance may be 0 cm, about 0.1 cm, about 0.2 cm, about 0.3 cm, about 0.4 cm, about 0.5 cm, about 0.6 cm, about 0.7 cm, about 0.8 cm, about 0.9 cm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 30 cm, about 35 cm, about 40 cm, about 45 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, about 10 m, or more than about 10 m.

In some cases, the distance between a mixture and where a light is received is the reception distance. In some cases, the distance between a mixture and a spectrometer module is the reception distance. In some cases, a reception distance may be 0 cm, about 0.1 cm, about 0.2 cm, about 0.3 cm, about 0.4 cm, about 0.5 cm, about 0.6 cm, about 0.7 cm, about 0.8 cm, about 0.9 cm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 30 cm, about 35 cm, about 40 cm, about 45 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, about 10 m, or more than about 10 m.

In some cases, a contact distance and a reception distance of a light may be similar or different. In some cases, a contact distance and a reception distance of a light are equal. In some cases, a contact distance and a reception distance of a light may differ by about 0 cm, about 0.1 cm, about 0.2 cm, about 0.3 cm, about 0.4 cm, about 0.5 cm, about 0.6 cm, about 0.7 cm, about 0.8 cm, about 0.9 cm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 30 cm, about 35 cm, about 40 cm, about 45 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, about 10 m, or more than about 10 m. In some cases, a contact distance and a reception distance of a light may differ by about 0%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 250%, 300%, 350%, 400%, 450%, 500%, 550%, 600%, 650%, 700%, 750%, 800%, 850%, 900%, 950%, 1000%, or more than 1000%.

Light that is directed from a light source to the mixture may travel through the mixture. In particular, the light may reach a penetration depth. As such, light may travel into a mixture to a penetration depth. Alternatively or in combination, scattered light can be measured with one or more spectrometer modules positioned away from an optical path of a transparent mixture. The penetration depth of the light may be correlated with the separation distance between the light source and the spectrometer module. The penetration depth may be controlled or adjusted by setting a specific separation distance between the light source and the spectrometer module. In some cases, the penetration depth of a light may be about 0.1 cm, about 0.2 cm, about 0.3 cm, about 0.4 cm, about 0.5 cm, about 0.6 cm, about 0.7 cm, about 0.8 cm, about 0.9 cm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 30 cm, about 35 cm, about 40 cm, about 45 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, about 10 m, or more than about 10 m. In some cases, penetration depth may be calculated as the depth at which the intensity of the light inside a mixture falls to a fraction (e.g., 1%, 5%, 10%, 15%, 20%, 25%, 30%, 35%, 40%, 45%, 50%, 55%, 60%, 65%, 70%, 75%, 80%, 85%, 90%, 95%, ⅓, ⅔, or 1/e) of its original value, such as the intensity of the light at the light source or the intensity of the light outside a mixture.

A portion of the light from a mixture may be received, e.g., by a spectrometer module or through a spectrometer's aperture. In some cases, about 0.01%, about 0.05%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 25%, about 30%, about 40%, about 50%, about 60%, about 70%, about 80%, about 90%, or more than 90% of the input light is received by the spectrometer module. In some cases, the percentage of the input light received by the spectrometer module may be calculated as the intensity of the received light divided by the intensity of the light directed by the light source. The intensity of the light source can be adjusted in response to the amount of measured light.

The wavelength(s), power, and/or intensity of a received light may depend on the input light, interaction between a mixture and the light directed into the mixture, and/or particular use for the spectrometer. In some cases, a wavelength of a received light is in the infrared, near-infrared, visible, white, red, orange, yellow, green, blue, violet, ultraviolet, ultraviolet A, near ultraviolet, or any combination thereof. In some cases, a wavelength of a received light is not in the microwave. In some cases, a wavelength of a received light is within the range from about 350 nm to about 1350 nm, such as within the range from about 350 nm to about 1100 nm. In some cases, a range of wavelengths of a received light is within a ranged defined by any two of: about 350, about 375, about 400, about 425, about 450, about 475, about 500, about 525, about 550, about 575, about 600, about 610, about 620, about 630, about 640, about 650, about 660, about 670, about 680, about 690, about 700, about 710, about 720, about 730, about 740, about 750, about 760, about 770, about 780, about 790, about 800, about 810, about 820, about 830, about 840, about 850, about 860, about 870, about 880, about 890, about 900, about 910, about 920, about 930, about 940, about 950, about 1000, about 1050, about 1060, about 1070, about 1080, about 1090, about 1100, about 1110, about 1120, about 1130, about 1140, about 1150, about 1175, about 1200, about 1225, about 1250, about 1275, about 1300, about 1325, about 1350, and more than 1350 nm.

In some cases, the power of a received light is within the range from about 0.1 mW to about 500 mW. In some cases, the power of received light within the container may be within a range defined by any two of: about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, about 10, about 15, about 20, about 25, about 30, about 35, about 40, about 45, about 50, about 55, about 60, about 65, about 70, about 75, about 80, about 85, about 90, about 95, about 100, about 110, about 120, about 130, about 140, about 150, about 175, about 200, about 225, about 250, about 275, about 300, about 325, about 350, about 375, about 400, about 425, about 450, about 475, about 500, or more than 500 mW.

In some cases, the intensity, irradiance, or power per unit area of a received light within the container is within a range defined by any two of: about 0.1 mW/cm², about 1 mW/cm², about 10 mW/cm², about 100 mW/cm², about 1 W/cm², about 10 W/cm², or more than 10 W/cm². In some cases, the intensity, irradiance, or power per unit area of a received light is within the range from about 0.1 mW/cm² to about 100 mW/cm².

A spectrometer module receives a portion of the light from the mixture. In some cases, the distance between where a light is directed from and where the light is received is the separation distance. In some cases, the distance between a light source and spectrometer module is the separation distance. In some cases, the separation distance may be within a range defined by any two of: about 0 mm, 0.05 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 30 cm, about 35 cm, about 40 cm, about 45 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, about 10 m, or more than about 10 m.

In some instances, the optical axes of the illumination module and the spectrometer module can be configured to be non-parallel such that the optical axis representing the spectrometer module is at an offset angle to the optical axis of the illumination module. This non-parallel configuration can be provided in one or more of many ways. For example, one or more components can be supported on a common support and offset in relation to an optic such as a lens in order to orient one or more optical axes toward each other. Alternatively or in combination, a module can be angularly inclined with respect to another module. In some cases, the angle between where a light is directed from and where the light is received is the offset angle. In some cases, the angle between a light source and spectrometer module is the offset angle. In some cases, the optical axis of each module is aligned at an offset angle. In some cases, the illumination module and the spectrometer module are configured to be aligned at an offset angle. In some cases, the offset angle is greater than 0, 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. In some cases, the offset angle is less than 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees. In some cases, the offset angle of the modules can be set firmly and is not adjustable. In some instances, the offset angle of the modules can be adjustable. In some cases, the offset angle of the modules can be automatically selected in response to the distance of the spectrometer from the sample. In some cases, two modules can have parallel optical axes. In some cases, two or more modules can have offset optical axes. In some instances, the modules can have optical axes offset such that they converge on a sample. The modules can have optical axes offset such that they converge at a set distance. For example, the modules can have optical axes offset such that they converge at a distance of about 10, 20, 30, 40, 50, 60, 70, 80, 90, 100, 150, 200, 250, 300, 350, 400, or 500 mm away.

One or more of the spectrometer, the light source, or spectrometer module as described herein can have a size and weight such that the spectrometer, light source, or spectrometer module can be held by a user with only one hand or coupled to a mixer that can be held by a user with only one hand. The spectrometer, light source, or spectrometer module can have a size and weight such that the spectrometer, light source, or spectrometer module can be portable. The spectrometer, light source, or spectrometer module can have a weight of about 1 gram (g), 5 g, 10 g, 15 g, 20 g, 25 g, 30 g, 35 g, 40 g, 45 g, 50 g, 55 g, 60 g, 65 g, 70 g, 80 g. 85 g, 90 g, 95 g, 100 g, 110 g, 120 g, 130 g, 140 g, 150 g, 160 g, 170 g, 180 g, 190 g, or 200 g. The spectrometer, light source, or spectrometer module can have a weight less than 1 g. The spectrometer, light source, or spectrometer module can have a weight greater than 200 g. The spectrometer, light source, or spectrometer module can have a weight that is between any of the two values given above. For example, the spectrometer, light source, or spectrometer module can have a weight within a range from about 1 g to about 200 g, about 1 g to about 100 g, about 5 g to about 50 g, about 5 g to about 40 g, about 10 g to about 40 g, about 10 g to about 30 g, or about 20 g to about 30 g.

The spectrometer, light source, or spectrometer module can have a total volume of about 200 cm³, 150 cm³, 100 cm³, 95 cm³, 90 cm³, 85 cm³, 80 cm³, 75 cm³, 70 cm³, 65 cm³, 60 cm³, 55 cm³, 50 cm³, 45 cm³, 40 cm³, 35 cm³, 30 cm³, 25 cm³, 20 cm³, 15 cm³, 10 cm³, 5 cm³, or 1 cm³. The spectrometer, light source, or spectrometer module can have a volume less than 1 cm³. The spectrometer, light source, or spectrometer module can have a volume greater than 100 cm³. The spectrometer, light source, or spectrometer module can have a volume that is between any of the two values given above. For example, the spectrometer, light source, or spectrometer module may have a volume within a range from about 1 cm³ to about 200 cm³, about 40 cm³ to about 200 cm³, about 60 cm³ to about 150 cm³, about 80 cm³ to about 120 cm³, about 80 cm³ to about 100 cm³, or about 90 cm³.

The spectrometer, light source, or spectrometer module shape can comprise a rectangular prism, cylinder, or other three-dimensional shape. The spectrometer, light source, or spectrometer module can have a length of about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The spectrometer, light source, or spectrometer module can have a length less than 5 mm. The spectrometer, light source, or spectrometer module can have a length greater than 500 mm. The spectrometer, light source, or spectrometer module can have a length that is between any of the two values given above. For example, the spectrometer, light source, or spectrometer module can have a length within a range from about 10 mm to about 100 mm, about 25 mm to about 75 mm, or about 50 mm to about 70 mm. The spectrometer, light source, or spectrometer module can have a maximum width of about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The spectrometer, light source, or spectrometer module can have a width less than 5 mm. The spectrometer, light source, or spectrometer module can have a width greater than 500 mm. The spectrometer, light source, or spectrometer module can have a width that is between any of the two values given above. For example, the spectrometer, light source, or spectrometer module may have a width within a range from about 10 mm to about 75 mm, about 20 mm to about 60 mm, or about 30 mm to about 50 mm. The spectrometer, light source, or spectrometer module can have a height (transverse to the with) within a range defined by any two of: about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The spectrometer, light source, or spectrometer module can have a height less than 5 mm. The spectrometer, light source, or spectrometer module can have a height greater than 500 mm. The spectrometer, light source, or spectrometer module can have a height that is between any of the two values given above. For example, the spectrometer, light source, or spectrometer module may have a height within a range from about 1 mm to about 50 mm, about 5 mm to about 40 mm, or about 10 mm to about 20 mm. The spectrometer, light source, or spectrometer module may, for example, have dimensions within a range from about 0.1 cm×0.1 cm×2 cm to about 5 cm×5 cm×10 cm. In the case of a cylindrical spectrometer, light source, or spectrometer module, the spectrometer, light source, or spectrometer module can have a radius of at most about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The spectrometer, light source, or spectrometer module can have a radius less than 5 mm. The spectrometer, light source, or spectrometer module can have a radius greater than 500 mm. The spectrometer, light source, or spectrometer module can have a radius that is between any of the two values given above.

Preferably, an illumination module, spectrometer module, and/or optical head of a spectrometer has a volume of 1 cm³ or less and/or a weight of 1 g or less. The dimensions of an illumination module, spectrometer module, and/or optical head of a spectrometer are between 2 mm and 15 mm. In some instances, the preferred volumes and/or dimensions do not relate to the driving electronic circuits which may be placed at various locations, for example, on the blender printed circuit board (PCB) or distributed between several PCBs.

One or more of the components of the mixer, spectrometer, light source, or spectrometer module can be powered by a battery. Alternatively they can be powered by a power supply within the mixer or blender. The battery can be on-board the mixer, spectrometer, light source, or spectrometer module. The battery can have a weight of at most about 50 g, 45 g, 40 g, 35 g, 30 g, 25 g, 20 g, 15 g, 10 g, 5 g, 1 g, or 0.1 g. The battery can have a weight less than 0.1 g. The battery can have a weight greater than 50 g. The battery can have a weight that is between any of the two values given above. For example, the batter may have a weight that is within a range from about 2 g to about 6 g, about 3 g to about 5 g, or about 4 g.

The spectrometer may have an optical resolution of less than 10 nm, less than 5 nm, less than 4 nm, less than 3 nm, less than 2 nm, less than 1 nm, less than 0.5 nm, or less than 0.1 nm. The spectrometer can have an optical resolution that is between any of the two values given above. For example, the spectrometer may have an optical resolution that is within a range from about 0.1 nm to about 100 nm, about 1 nm to about 50 nm, about 1 nm to about 10 nm, or about 2 nm to about 5 nm. The spectrometer may have an optical resolution of approximately 5 nm, which is equivalent to approximately 100 cm⁻¹ at a wavelength of about 700 nm and equivalent to approximately 40 cm⁻¹ at a wavelength of about 1100 nm. The spectrometer may have an optical resolution that is between 100 cm⁻¹ and 40 cm⁻¹. The spectrometer can have a temporal signal-to-noise ratio (SNR) of about 1000 for a single sensor reading (without averaging, at maximum spectral resolution) for a wavelength of about 1000 nm, or an SNR of about 2500 for a wavelength of about 850 nm. The compact spectrometer, when configured to perform algorithmic processing or correction of measured spectral data, may be able to detect changes in normalized signals in the order of about 1×10⁻³ to about 1×10⁻⁴, or about 5×10⁻⁴. The light source of the illumination module may be configured to have a stabilization time of less than 1 min, less than 1 s, less than 1 ms, or about 0 s.

A spectrometer, light source, spectrometer module, or optical element as described herein may be placed in a protective sheath cover and/or a removable accessory container, in accordance with configurations. In many cases, the cover can comprise a protective sheath sized to receive the spectrometer, light source, spectrometer module, or optical element. The cover can be configured to fit over a portion of the spectrometer, light source, spectrometer module, or optical element. The spectrometer, light source, spectrometer module, or optical element can be removed from the sheath cover and placed in the sheath cover with an appropriate orientation to measure samples or calibrate the spectrometer. In many cases, the cover can have an open end and a closed end. In many instances, the spectrometer, light source, spectrometer module, or optical element can comprise a protective housing sized to fit within the protective sheath. The spectrometer, light source, spectrometer module, or optical element comprising the housing can be placed in the cover sheath with the optics of the spectrometer directed toward a closed end of the cover sheath in order to calibrate the spectrometer. The cover may comprise a reflective calibration material to couple to the light source to the spectrometer module in order to reflect light from a calibration material to the spectrometer module in a repeatable manner. The reflective material may be a diffusive reflective material. The cover can be removable. To measure a sample, the spectrometer can be placed in the cover such that the spectrometer head faces the open end of the cover. In some cases, the cover can be configured to be removed and/or replaced by a user. The cover can provide a protective covering for the spectrometer during storage and use. In many instances, the cover can comprise a reference material for calibration of the spectrometer. The cover can additionally couple to an accessory to provide a controlled measurement environment for conducting measurements of a sample.

In some cases, ambient light may not be permitted to enter the mixing container. The mixing container can comprise a non-optically transmissive or non-optically transparent material having a channel formed therein to receive light energy from the light source. The mixing container can have walls that are coated with a material that does not reflect light energy. In some cases, the mixing container can comprise at least one surface with a highly reflective coating. Alternatively or in combination, the mixing container can have walls coated with a black coloring or coating. The black coloring or coating may not reflect light energy or may reflect a substantially small percentage of light energy.

At least one inner surface of the mixing container can be covered with or contain an optically reflective surface or entity. Alternatively or in combination, an outer surface of an optically transmissive or transparent mixing container can be covered with or contain an optically reflective surface or entity. The optically reflective surface or entity can have predetermined optical properties. The mixing container can transmit reflected light, for example reflected light off the reflective surface or entity, to the spectrometer module. The cover can inhibit or prevent interference from ambient light. In many instances, ambient light can be light outside of the mixing container. In some cases, the reflective material can be a reflective material with a size and shape configured to fit within a recess formed in the mixing container. The reflective material can have known optical properties. For example, an optical property that can be known for the reflective material can be reflectivity, absorptivity, and/or transmissivity. The known optical properties of the reflective material can be constant with respect to one or more environmental properties, for example, temperature, humidity, and/or pressure. The known optical properties of the reflective material can be constant with respect to the properties of light incident on the reflective material. In many instances, properties of the light incident on the reflective material can include wavelength, intensity, and/or frequency. In some cases, the mixing container can comprise a second reflective material on a wall to reflect light energy from the light source toward the reflective material and from the reflective material toward the spectrometer module. The second reflective material can have a size and shape such that it is configured to fit along a wall of the mixing container. The second reflective material can have known optical properties.

The spectrometer can further comprise a support to engage the cover and place the reflective material at a predetermined distance from the light source and the spectrometer module. The predetermined distance can be a fixed or variable distance. The cover can comprise an engagement structure to engage the support on the spectrometer. The support can be shaped to receive, couple to, and/or mate with the engagement structure. The engagement structure can be removably coupled to the support. The cover can be attached to the spectrometer when the support and engagement structure are positively mated or coupled. The engagement structure can permit placement and removal of the cover on the spectrometer. The engagement structure can couple the cover to the spectrometer such that ambient light cannot enter the container. In some cases, the engagement member can comprise one or more of a protrusion, a rim, a flange, a recess, or a magnet. The support can comprise one or more of a protrusion, a rim, a flange, a recess, or a magnet configured to engage a corresponding portion of the engagement structure. In some cases, a locking mechanism can further couple the spectrometer and the cover. A user can release the locking mechanism to remove the cover from the spectrometer. In many instances, a locking mechanism can be a pin and tumbler locking mechanism.

The mixing container can place the mixture at a known distance from the light source and/or spectrometer module. The mixing container can inhibit noise signals from ambient light sources. Ambient light sources can be any light sources that do not originate from the light source of the spectrometer.

The mixer can further comprise a support to engage the light source, spectrometer module, diffuser, and/or reflective material at predetermined distances from one another or from the mixture. The predetermined distance can be a fixed or variable distance. The cover can comprise an engagement structure to engage the support on the mixer. The support can be shaped to receive, couple to, and/or mate with the engagement structure. The engagement structure can be removably coupled to the support.

In many instances, the calibration material can be spaced apart from the optics head with a calibration distance in the calibration orientation and wherein the mixing container is sized and shaped to place the mixture spaced apart from the optics head with a measurement distance in the measurement orientation similar to the calibration distance to within about 1000%.

In many cases, the mixing container and the spectrometer can comprise mating or coupling attachment structural features. The mixing container can be mounted on the optical head side of the spectrometer. In many cases, the coupling attachment structural features can be complementary structural features on the mixing container and the spectrometer. The complementary structural features can comprise one or more of a protrusion, a rim, a flange, a recess, or a magnet configured to couple the mixing container to the spectrometer.

The mixing container and/or the cover can comprise asymmetric mating structural features such that the mixing container can connect to the spectrometer only in a preferred orientation. In many instances, asymmetric mating structural features can be grooves, channels, pins, or other shape factors provided on either or both of the container and/or cover and the spectrometer. The asymmetric mating structural features can prevent the mixing container from connecting to the spectrometer in at least one orientation. The asymmetric structural features can force the spectrometer to be mounted on the mixing container such that a mixture in the mixing container is in a known location relative to the spectrometer. The known location can be a known location relative to the light source and/or the spectrometer module. In some instances, the known location relative to the light source and/or the spectrometer module is a horizontal or vertical distance. In some cases, the known location relative to the light source and/or the spectrometer module is an angular orientation in relation to the light source and/or the spectrometer module.

The housing can comprise one or more magnets. The magnets can be exposed to the outer surface of the housing or the magnets can be embedded in the housing such that they are not exposed on the outer surface. The magnets can be configured to mate with, attract, or couple to magnets or magnetic materials provided on the cover and/or the mixing container. The magnets can be the support on the spectrometer configured to couple to the engagement structure on the cover. The engagement structure can comprise a cover magnetic material configured to couple to the support magnetic material. In some cases, the engagement structure and the support can comprise corresponding asymmetric engagement structures to position the cover at a predetermined position and angular orientation with respect to the light source and the spectrometer module. In many cases, the polarity of the magnets can be an asymmetric engagements structure when the polarity is chosen such that some orientations of the cover and spectrometer are permitted while other configurations are prevented.

In some instances, the mixer or mixing container may include a temperature sensor. For example, the temperature sensor may be separated from the spectrometer, for example attached or embedded within the mixing container. In another embodiment the temperature sensor may be attached to the spectrometer.

In some cases the calibration may be provided utilizing the mixing component. For example, the mixing components may be blades that also reflect light such that it serves as a reflecting element. The illumination may be modulated in synchronization to the timing of the blades passage above the spectrometer and illumination. The synchronization may use for example a rotary encoder than measure the angular position of the blades with respect to the spectrum measurement system. The illumination can be modulated such that light is either reflected by the blades, or such that light pass into the mixture (e.g. when the blades are not above the spectrometer and illumination). This way, either trans-reflection measurement or backscattering measurement schemes can be performed by just selecting the timing of the illumination relative to the blades. Also, when there is no mixture in the container, the reflection from the blades can be used for calibration.

In some embodiments of the invention it is preferable to control the blades speed to allow for accurate synchronization with the illumination module. Specifically, the rotation speed should not be higher than the maximum modulation rate of the illumination. In some embodiments, the illumination may not be modulated, and the effect of the reflections from the blades is averaged. In some instances, the apparatus may include a dedicated calibration housing for calibrating the spectrometer. In operation, a user may use a calibration housing to calibrate the spectrometer and replace it with the mixing container housing for further measurements.

In some instances, the calibration process may be activated when the mixing container or calibration housing is empty or contains water or a predefined composition such as distilled water.

In some instances, the housing may include a liquid accessory structure. For example, the mixer may include a first window for a light source and a second window for a spectrometer module. The housing can comprise a diffuser and/or a reflective element. The diffuser reflector can be arranged to reflect light transmitted through the diffuser with the reflective element. The accessory can be configured with an engagement structure to place the diffuser and the reflective element at a fixed distance from the spectrometer module. The accessory can comprise a plurality of energy transmission channels to transmit energy to and from the mixture. The plurality of energy transmission channels can comprise one or more of an optical window or a heat transfer energy channel. In some cases, the heat transfer channel can comprise a layer of metal to conduct heat from the mixture in contact with a first side of the layer to an opposite side of the layer. The optical window can comprise a plurality of optical windows with an opaque material between the plurality of optical windows to inhibit optical cross-talk of a light beam projected to the mixture and light received from the mixture. The plurality of optical windows can comprise a light transmission window and a light receiving window with the opaque material located in between.

A reflective material can be used to calibrate the spectrometer. The calibration can eliminate or correct for non-uniformities in the light source and/or the spectrometer.

A cover can be provided to calibrate the spectrometer. The calibration can be performed automatically by the spectrometer in response to a user instruction to perform the calibration. A user can instruct the spectrometer to perform the calibration by attaching the cover with the reflective material on the spectrometer, or by a physical user input (e.g., pushing a button or flipping a switch). In the case of automatic calibration, the spectrometer can be calibrated without an input signal from a user. The automatic calibration can be initiated by a processor on or off board the spectrometer. The processor can be configured to detect that the device requires calibration and initiate the calibration. Examples of suitable covers, spectrometers and calibration sheaths are described in U.S. Pat. App. Ser. No. 62/112,592, filed Feb. 5, 2015, entitled “Accessories for Handheld Spectrometer” (attorney docket no. 45151-705.103), the entire disclosure of which is incorporated herein by reference.

In many instances, an automatic calibration algorithm can be initiated when a user turns the spectrometer on (e.g., presses the power button to complete a battery circuit to provide power to the spectrometer components). The spectrometer can be calibrated prior to placing material in the blender, for example when the blender has been cleaned. One or more of the spectrometer module, illumination module, or other components as described herein may comprise a moisture and heat resistant housing such that the spectrometer can be washed in a dishwasher and washing exposed to heat during the drying cycle. The processor can assume that the device is in the cover and aimed at a reflective material in the cover, or has been placed on an empty and/or washed blender. The assumption can be confirmed by a sensor. For example, a sensor can be a switch indicating that the cover is mounted, or performing a quick reading with or without light source illumination to verify presence of the reflective material. Alternatively, the automatic calibration algorithm can be initiated when stored data in the cloud based storage system for the calibration standard (e.g., reflective material) is older than a threshold age or below a threshold accuracy.

Calibration of the spectrometer can result in a more accurate measurement of a mixture. The cover can comprise a single piece of optically non-transmissive material for calibration. The optically non-transmissive material can comprise the reflective material. The reflective material can be a reference material with known optical properties. In some cases, the reference material can be a “white reference” material. A white reference material can be a material with a flat spectral response. The white reference material may comprise one or more of many known white reference materials, such as Spectralon™, commercially available from Labsphere, as published on the world wide web at the domain “labsphere.com”.

In some cases, a calibration element is coupled to the mixer or embedded in the mixing container. Preferably, the calibration element can be moved into the optical path during the calibration process, and can moved out of the optical path after calibration. For example, a mixing container may be turned in the blender base to lock it firmly in place, and safety levers may be activated. Such an activation step may also turn a calibration element between its calibration state and its measurement state. Alternatively, the calibration element can be the same element as a reflective optical element in a normal measurement. In some cases, remnants of a mixture do not affect the measured spectrum during a calibration step.

Measurements of the white reference material can be used to remove non-uniformities in the light source and/or the spectrometer when measuring a mixture. The cover can provide the white reference material in a controlled environment for calibration. In some cases, the cover can provide the white reference material in an environment substantially free from ambient light and with a constant and known distance between the sensor and the mixture (e.g., white reference). Other possible materials are glass coated sheets, sand-blasted aluminum and other metals.

In many instances, calibration measurements are obtained with the “white reference” (hereinafter “WR”) material with light or dark signals, and combinations thereof. In some cases, the measurement may comprise a “WR-dark” measurement when the illuminator is turned off. For many WR measurements, the sheath and reference material are placed on the spectrometer as described herein.

In many instances, the spectrometer can be calibrated by taking a “WR-dark” measurement. The “WR-dark” measurement can be a spectrometer measurement of the reference material without the light source. The “WR-dark” measurement can provide data on ambient light and other effects like sensor dark noise. Ambient light and other effects like sensor dark noise can inhibit measurement interpretation, therefore it can be helpful to quantify these parameters in order to subtract them out or disregard them in sample measurements. The “WR-dark” measurement can be repeated at least about 5, 10, 15, 20, 25, or 30 trials and the “WR-dark” measurement can be averaged over the repeated trials. The “WR-dark” measurement can be at least about 15 milliseconds long. After the “WR-dark” measurement is performed the white reference (WR) signal can be measured. In some cases, the “WR-dark” signal may not be measured and the calibration method can begin by measuring the WR signal. The WR signal can also be measured repeatedly or a series of repeated trials. The WR signal can be repeated for at least about 10, 20, 30, 40, 50, 60, 70, 80, 90, or 100 trials. Each measurement can take at least about 15 milliseconds. All of the WR signal measurement trials can be averaged. If a “WR-dark” measurement was taken the “WR-dark” measurement average can be subtracted from the average WR signal measurement. The WR signal measurement can be transmitted or otherwise communicated to the cloud based storage system. The cloud based storage system can further validate the signal measurement and if valid the signal can be stored as a reference signal.

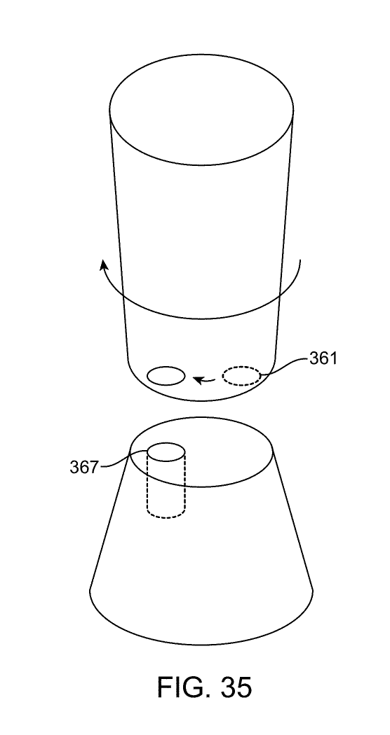

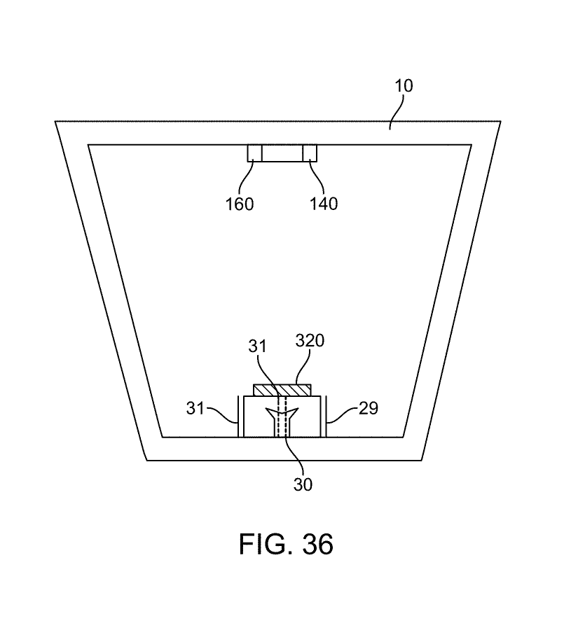

In some cases a locking mechanism of the mixer may be utilized to control the position of the calibration reference in a natural way and to automatically calibrate the optical head. For example as shown in FIG. 35 the calibration reference 361 may be placed in front of the optical head 367 by rotating the mixing chamber, such as in a clockwise direction.

In operation, the user places the container on the base. At the next step the user rotates the chamber. Once the chamber is rotated a locking mechanism may lock the chamber as the calibration reference is placed in front or substantially in front of the optical head.

In some cases, the mixer cover may be used to push the calibration element out of the optical path (at the same time as it enables the turning of the blade as a safety mechanism). Calibration can then take place during the unlocked phase when the calibration element passes above the spectrometer and illumination elements. An electro-mechanical or opto-mechanical switch such as known to those skilled in the art can be used to monitor the position of the calibration element.

The accessory can comprise a protective cover. The spectrometer can be fitted in the protective cover when the spectrometer is connected to the accessory. The spectrometer and the protective cover can form a liquid tight seal. The spectrometer and the protective cover can form an air tight seal. When the spectrometer is fitted and connected to the accessory liquid may not be able to permeate a boundary between the spectrometer and the protective cover. The protective cover can prevent liquid from contacting the spectrometer. The protective cover can prevent liquid from damaging the spectrometer. The seal located between the spectrometer and the protective cover can comprise a gasket, o-ring, or other mechanical seal, for example. The seal formed between the spectrometer and the protective cover can comprise a rubber, Teflon, plastic, or metal seal, for example.

The spectrometer head, light source, or spectrometer module can be adjacent to a window of the mixer. The window can comprise a single window. The window can comprise two or more windows arranged in a single plane. The window can comprise two or more windows arranged on the same surface. The window can be formed from glass, plastic, or any other material configured to permit transmission of light. The window can be configured to permit transmission of light within a predetermined range of wavelengths. In cases where two or more windows are provided on the window, two or more of the windows can be configured to permit transmission of light in different wavelength ranges, for example.

In response to the received portion of light, the spectrometer module may generate one or more spectra that is associated with the received light. These spectra, in turn, may be used to determine a property of a mixture. In particular, in some instances, one or more light sources are used to direct light into a mixture. One or more spectrometer modules may be used to receive light from a mixture. Spectra may be measured in response to the received light. Examples and descriptions of these instances are described below.

Two or more light sources may be placed at different distances from a spectrometer module. One light source in an illumination module may be closer to a spectrometer module to achieve a shorter penetration depth. Another light source in an illumination module may be farther away from a spectrometer module to achieve a deeper penetration depth. Spectrum in response to light directed and/or generated by each light source may be measured. Each light source may be operated one at a time. In some cases, two or more light sources are within a single illumination module. In some cases, two or more light sources are within two or more illumination modules.

Alternatively or in combination, two or more spectrometer modules may be placed at different distances from a light source. One spectrometer module may be closer to a light source in an illumination module to achieve a shorter penetration depth. Another spectrometer module may be farther away from a light source in an illumination module to achieve a deeper penetration depth. Spectrum in response to light received by each spectrometer module may be measured. Each spectrometer module may be operated one at a time.

In some cases, a method described herein further comprises moving a light source and/or a spectrometer module. By moving a light source, the separation distance between the light source and a spectrometer module and/or the penetration depth of a light directed by the light source may be adjusted. By moving a spectrometer module, the separation distance between the spectrometer module and a light source and/or the penetration depth of a light directed by the light source may be adjusted. As such, multiple separation distances and/or penetration depths may be achieved for a light source and/or spectrometer module.

In some cases, a second illumination module directs a second light into a mixture. In some cases, the second light reaches a penetration depth, which may be similar to or different from the penetration depth of the first light. In some cases, the second light has a separation distance, which may be similar to or different from the separation distance of the first light. In some cases, the second light has a contact distance, which may be similar to or different from the contact distance of the first light. In some cases, the second light has a reception distance, which may be similar to or different from the reception distance of the first light. In some cases, a second spectrometer module receives a portion of the second light from the mixture. In some cases, an illumination module and a second illumination module are the same. In some cases, an illumination module and a second illumination module are different. In some cases, a spectrometer module and a second spectrometer module are the same. In some cases, a spectrometer module and a second spectrometer module are different.

In some cases, a method described herein may comprise one or more steps including, but not limited to, directing a light into the mixture, receiving a portion of the light from the mixture, measuring a spectrum in response to the portion of the light from the mixture, moving a light source, moving a spectrometer module, mixing a mixture, pouring a mixture, determining a property of a mixture, indication of completion of mixing, directing a light into the flowable material and/or fluid, receiving a portion of the light from the flowable material and/or fluid, measuring a spectrum in response to the portion of the light from the flowable material and/or fluid, pouring a flowable material and/or fluid, determining a property of a flowable material and/or fluid, obtaining a spectral result, and any combination thereof. In some cases, one or more steps may be performed in any order, once or more than once, simultaneously with one or more other steps, or sequentially with one or more other steps.

In some cases, a method described herein may further comprise repeating a step, including but not limited to directing a light into the mixture, receiving a portion of the light from the mixture, measuring a spectrum in response to the portion of the light from the mixture, moving a light source, moving a spectrometer module, mixing a mixture, pouring a mixture, determining a property of a mixture, indication of completion of mixing, directing a light into the flowable material and/or fluid, receiving a portion of the light from the flowable material and/or fluid, measuring a spectrum in response to the portion of the light from the flowable material and/or fluid, pouring a flowable material and/or fluid, determining a property of a flowable material and/or fluid, obtaining a spectral result, and any combination thereof. In some cases, a step may be repeated 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 150, 200, 250, 300, 350, 400, 450, 500, 600, 700, 800, 900, 1000, or more than 1000 more times.

In some cases, 1, 2, 3, 4, 5, 6, 7, 8, 9, 10, 11, 12, 13, 14, 15, 16, 17, 18, 19, 20, 25, 30, or more than 30 lights are directed. In some cases, the wavelength(s), power, and/or intensity of two or more lights may be similar or different.

In some cases, the separation distances of two or more lights may be similar or different. In some cases, the separation distance of two or more lights may differ by 0, about 0.05, about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 30, about 35, about 40, about 45, about 50, about 60, about 70, about 80, about 90, about 100, about 110, about 120, about 130, about 140, about 150, about 160, about 170, about 180, about 190, about 200, or more than 200 mm. In some cases, the separation distance of two or more lights may differ by about 0%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 250%, 300%, 350%, 400%, 450%, 500%, 550%, 600%, 650%, 700%, 750%, 800%, 850%, 900%, 950%, 1000%, or more than 1000%.

In some cases, the contact distances of two or more lights may be similar or different. In some cases, the contact distance of two or more lights may differ by about 0 cm, about 0.1 cm, about 0.2 cm, about 0.3 cm, about 0.4 cm, about 0.5 cm, about 0.6 cm, about 0.7 cm, about 0.8 cm, about 0.9 cm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 30 cm, about 35 cm, about 40 cm, about 45 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, about 10 m, about 11 m, about 12 m, about 13 m, about 14 m, about 15 m, about 16 m, about 17 m, about 18 m, about 19 m, about 20 m, or more than about 20 m. In some cases, the contact distance of two or more lights may differ by about 0%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 250%, 300%, 350%, 400%, 450%, 500%, 550%, 600%, 650%, 700%, 750%, 800%, 850%, 900%, 950%, 1000%, or more than 1000%.

In some cases, the reception distances of two or more lights may be similar or different. In some cases, the reception distance of two or more lights may differ by about 0 cm, about 0.1 cm, about 0.2 cm, about 0.3 cm, about 0.4 cm, about 0.5 cm, about 0.6 cm, about 0.7 cm, about 0.8 cm, about 0.9 cm, about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, about 21 cm, about 22 cm, about 23 cm, about 24 cm, about 25 cm, about 30 cm, about 35 cm, about 40 cm, about 45 cm, about 50 cm, about 60 cm, about 70 cm, about 80 cm, about 90 cm, about 1 m, about 2 m, about 3 m, about 4 m, about 5 m, about 6 m, about 7 m, about 8 m, about 9 m, about 10 m, about 11 m, about 12 m, about 13 m, about 14 m, about 15 m, about 16 m, about 17 m, about 18 m, about 19 m, about 20 m, or more than about 20 m. In some cases, the reception distance of two or more lights may differ by about 0%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 250%, 300%, 350%, 400%, 450%, 500%, 550%, 600%, 650%, 700%, 750%, 800%, 850%, 900%, 950%, 1000%, or more than 1000%.

In some cases, the penetration depths of two or more lights may be similar or different. In some cases, the penetration depth of two or more lights may differ by 0, about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, about 10, about 11, about 12, about 13, about 14, about 15, about 16, about 17, about 18, about 19, about 20, or more than 20 mm. In some cases, the penetration depth of two or more lights may differ by about 0%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 110%, 120%, 130%, 140%, 150%, 160%, 170%, 180%, 190%, 200%, 250%, 300%, 350%, 400%, 450%, 500%, 550%, 600%, 650%, 700%, 750%, 800%, 850%, 900%, 950%, 1000%, or more than 1000%.

Measurements may be performed on one or more mixtures, at one or more ambient temperatures, on one or more mixture temperatures, on one or more locations of a mixture, on one or more locations on a mixer, at one or more wavelengths, at one or more pulse rates, at one or more pulse durations, with one or more pulses, at one or more powers, at one or more intensities, at one or more separation distances, at one or more separation angles, at one or more contact distances, at one or more reception distances, with one or more illumination modules, with one or more light sources, with one or more lights, with one or more spectrometer modules, with one or more spectrometers, or any combination thereof.

A database may be assembled with multiple measurements. Spectra may be compared against the database to determine a property of a mixture. A machine learning algorithm may be used to determine a property of a mixture.

A light source may be continuous-wave or pulsed. In some cases, a light source may be pulsed 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 150, 200, 250, 300, 350, 400, 450, 500, 600, 700, 800, 900, 1000, 2000, 3000, 4000, 5000, 6000, 7000, 8000, 9000, 10000, or more than 10000 times. In some cases, a light source may be pulsed at a rate of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 150, 200, 250, 300, 350, 400, 450, 500, 600, 700, 800, 900, 1000, or more than 1000 per second.

In some cases, a light source may be pulsed with a pulse duration of 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 ns, 2 ns, 3 ns, 4 ns, 5 ns, 6 ns, 7 ns, 8 ns, 9 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 μs, 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, 200 μs, 300 μs, 400 μs, 500 μs, 600 μs, 700 μs, 800 μs, 900 μs, 1 ms, 2 ms, 3 ms, 4 ms, 5 ms, 6 ms, 7 ms, 8 ms, 9 ms, 10 ms, 20 ms, 30 ms, 40 ms, 50 ms, 60 ms, 70 ms, 80 ms, 90 ms, 100 ms, 200 ms, 300 ms, 400 ms, 500 ms, 600 ms, 700 ms, 800 ms, 900 ms, 1 s, 2 s, 3 s, 4 s, 5 s, 6 s, 7 s, 8 s, 9 s, 10 s, 20 s, 30 s, 40 s, 50 s, 1 min, 2 min, 3 min, 4 min, 5 min, 6 min, 7 min, 8 min, 9 min, 10 min, 20 min, 30 min, 40 min, 50 min, 60 min, or more than 60 min. In some cases, pulse duration may be calculated as a fraction of the pulse amplitude (e.g., 50%, 60%, 70%, 80%, 90%, 95%, or 1/e of the pulse amplitude) or as the root mean square value of the pulse amplitude.

A spectrum may be measured in response to a portion of a light from a mixture. In some cases, spectra may be measured at a rate of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 150, 200, 250, 300, 350, 400, 450, 500, 600, 700, 800, 900, 1000, or more than 1000 per second. In some cases, spectra may be measured at the same rate as a light source is pulsed. Spectra may be measured with a time delay after a light is directed. In some cases, spectra may be measured 0 ps, 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 ns, 2 ns, 3 ns, 4 ns, 5 ns, 6 ns, 7 ns, 8 ns, 9 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1 μs, 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, 200 μs, 300 μs, 400 μs, 500 μs, 600 μs, 700 μs, 800 μs, 900 μs, 1 ms, 2 ms, 3 ms, 4 ms, 5 ms, 6 ms, 7 ms, 8 ms, 9 ms, 10 ms, 20 ms, 30 ms, 40 ms, 50 ms, 60 ms, 70 ms, 80 ms, 90 ms, 100 ms, 200 ms, 300 ms, 400 ms, 500 ms, 600 ms, 700 ms, 800 ms, 900 ms, 1 s, 2 s, 3 s, 4 s, 5 s, 6 s, 7 s, 8 s, 9 s, 10 s, 20 s, 30 s, 40 s, 50 s, 1 min, or more than 1 min after a light is directed. In some cases, 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 150, 200, 250, 300, 350, 400, 450, 500, 600, 700, 800, 900, 1000, or more than 1000 spectra may be measured.

A light source may be pulsed and/or spectra may be measured at a rate at least as high as a mixing, spinning, shaking, or rotation rate of the mixing component. In some cases, the ratio of number of light source pulses and/or spectra measurements to rotations of the mixing component may be about 0.001, 0.005, 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, or more than 100.

Once spectra are determined for a mixture, the spectra may be processed. Processing steps may include, but are not limited to, smoothing functions, noise reduction, and derivation. Additionally, vectors may be generated in response to spectra. A vector may correspond to a single wavelength bin. A vector may include the data for a single wavelength bin from all spectra measured. For example, vectors S(λ) may represent the measured spectra, and vectors T may correspond to a single wavelength bin, where T=λᵢ(t), ‘i’ is a single wavelength bin, and ‘t’ is time.

Once a spectrum is obtained, it can be analyzed. In some cases, the analysis may not be contemporaneous. In some cases, the analysis can occur in real time. The spectrum can be analyzed using any appropriate analysis method. Non-limiting examples of spectral analysis techniques that can be used include Principal Components Analysis, Partial Least Squares analysis, and the use of a neural network algorithm to determine the spectral components.

An analyzed spectrum can determine whether a complex mixture being investigated contains a spectrum associated with components. The components can be, e.g., a substance, mixture of substances, or microorganisms (e.g., bacteria, virus, pathogen, parasite, yeast, foodborne illness-causing organism, organism used in fermentation or culturing, Lactobacillus bulgaricus, Streptococcus thermophilus, Saccharomyces cerevisiae, Escherichia coli, Vibrio vulnificus, Clostridium botulinum, Clostridium perfringens, Salmonella, Campylobacter, Listeria, Toxoplasma, norovirus). In some cases, a method disclosed herein can detect or determine the presence and/or concentration of one or more organisms, for example to detect food poisoning, spoiled food, or appropriate levels of culturing organisms.

### Computer Control Systems

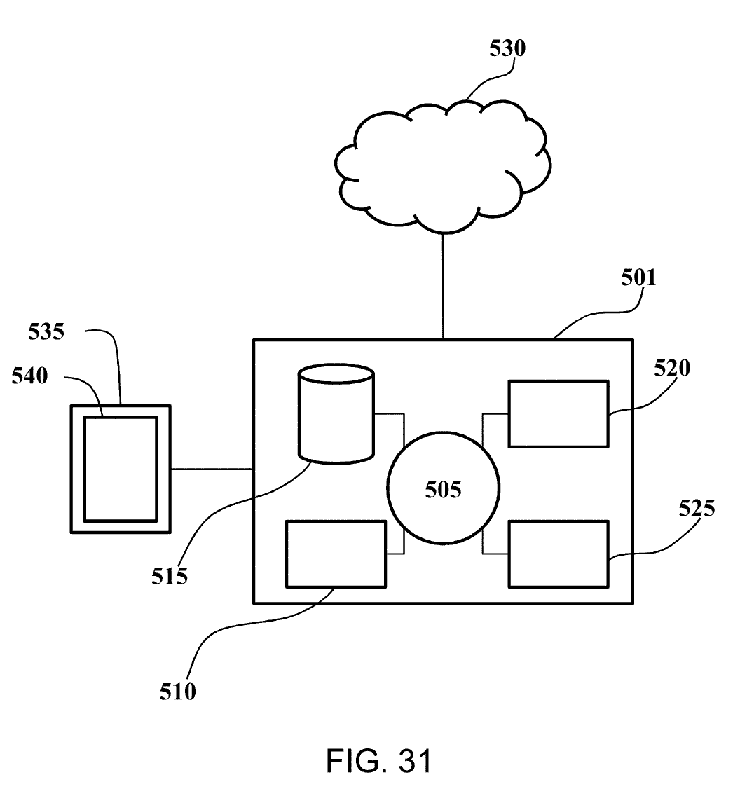

The present disclosure provides computer control systems that are programmed to implement methods of the disclosure, for example with the spectrometer apparatus as disclosed herein. FIG. 31 shows a computer system 501 that is programmed or otherwise configured to implement methods of the present disclosure.

The computer system 501 includes a central processing unit (CPU, also “processor” and “computer processor” herein) 505, which can be a single core or multi core processor, or a plurality of processors for parallel processing. In examples of the present disclosure, the computer processor may be programmed to (i) receive one or more spectra measurements, (ii) process one or more spectra measurements, (iii) direct one or more lights, (iv) display mixture properties, and any combination thereof. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries, and saved programs. The storage unit 515 can store user data. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535. The electronic display 535 can be part of the computer system 501, or coupled to the computer system 501 directly or through the network 530. The electronic display can include a user interface (UI) 540 for providing various features and functionalities described herein. Examples of UI's include, without limitation, a graphical user interface (GUI) and web-based user interface.

The mobile communication device may comprise a processor and wireless communication circuitry to couple to the spectrometer and communicate with a remote server, the processor comprising instructions to transmit spectral data of a mixture to a remote server and receive mixture data in response to the spectral data from the remote server.

In many instances, the mixture data comprises one or more of a temperature of the mixture and a property of the mixture.

In many instances, the processor comprises instructions for a user to tag the spectral data with meta data, the meta data comprising one or more of an identification of the mixture, a date of the spectral data, or a location of the mixture, and to transmit the spectral data with the meta data to a remote server.

In many instances, the spectrometer comprises a hand held spectrometer with a measurement beam capable of being directed at a mixture with user hand manipulations when the mobile communication device is operatively coupled to the hand held spectrometer with wireless communication.

In many instances, the mobile communication device comprises a user interface coupled to the processor for the user to input commands to the spectrometer. The user interface can comprise a touch screen display coupled to the spectrometer with the wireless communication circuitry, wherein the processor may comprise instructions to activate the screen of the user interface in response to a spectrometer user input. The spectrometer user input can comprise one or more buttons.

In many instances, the processor comprises instructions for the user to control the spectrometer in response to user input on the mobile communication device.

In many instances, the hand held spectrometer comprises an optical head, a control board, digital signal processing circuitry and wireless communication circuitry arranged to be supported with a hand of a user.

In many instances, the spectral data comprises compressed spectral data and the processor comprises instructions to transmit the compressed spectral data to the remote server.

In many instances, the spectral data comprises compressed spectral data, and the processor comprises instructions to relay the compressed spectral data to the remote server and receive the mixture data in response to the relayed compressed spectral data.

In many instances, the processor comprises instructions to transmit control instructions to the remote server and to receive control instructions from the remote server. The remote server can comprise a cloud based server. The remote server can comprise a database and a tangible medium embodying instructions of an algorithm to compare the spectral data to the database.

In many instances, the remote server comprises instructions to receive compressed, encrypted spectrometer data, generate a spectrum from the compressed, encrypted spectrometer data, generate a comparison the spectrum with a database of spectral information, and output one or more results of the comparison to the mobile communication device.

In many instances, the processor comprises instructions to provide a plurality of user navigable screens, the plurality of user navigable user interface screen configurations comprising one or more of a home screen, a user data screen, a user tools screen, a scan screen, a screen of a database of mixtures, or a result screen.

In many instances, the processor comprises instructions to receive an identification of the mixture from the remote server and to display the identification to the user.

In many instances, the processor comprises instructions to receive a plurality of possible identifications from the remote server and to display the plurality of possible identifications to the user, and to allow the user to select one of the plurality of possible identifications and to transmit the selected one to the remote server.

In many instances, the processor comprises instructions of a user application downloaded onto the mobile communication device and wherein the mobile communication device comprises a smart phone coupled to the spectrometer with a wireless communication protocol.

In many instances, the processor comprises instructions to display a message on the communication device that the communication device is waiting for a scan of the mixture from the spectrometer.

In many instances, the processor comprises instructions to display one or more spectrometer controls on the mobile communication device.

In many instances, the processor comprises instructions to display one or more user selectable applications for the user to operate spectrometer.

In another aspect, an apparatus to measure spectra of a mixture comprises a processor comprising a tangible medium embodying instructions of an application. The application can be configured to couple a mobile communication device to a spectrometer in order to receive spectral data and to transmit the spectral data to a remote server, and receive spectral data from the remote server.

In another aspect, an apparatus comprises a processor comprising instructions to receive spectral data from a remote spectrometer and compare a database of spectral data to the spectral data in order to identify a mixture in response to the spectral data.

In another aspect, a method of measuring spectra of a mixture comprises providing a spectrometer and providing a mobile communication device. The mobile communication device may comprise a processor and wireless communication circuitry, to couple the mobile communication device to the spectrometer and communicate with a remote server. The processor may comprise instructions to transmit spectral data of a mixture to a remote server and receive mixture data in response to the spectral data from the remote server.

Methods and systems of the present disclosure can be implemented by way of one or more algorithms. An algorithm can be implemented by way of software upon execution by one or more computer processors.

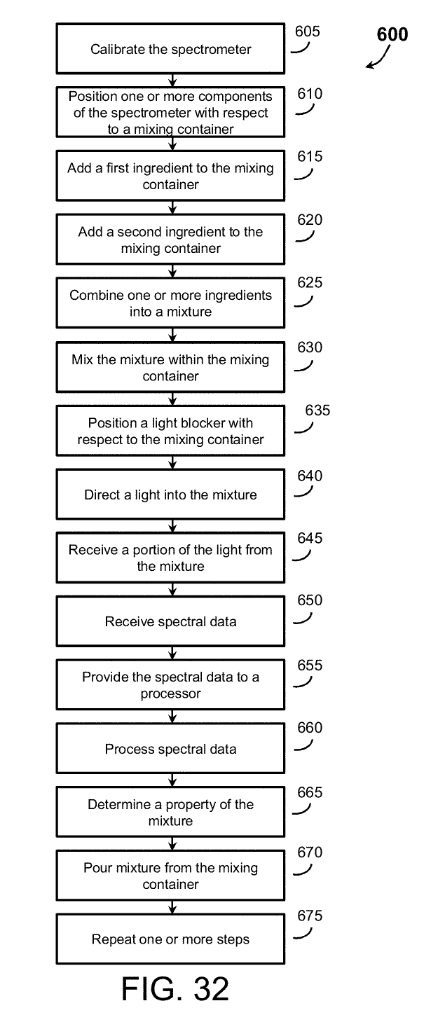

FIG. 32 shows a flowchart 600 of a method of determining a property of a mixture with a spectrometer apparatus as disclosed herein, in accordance with examples. In particular, the method provides a method of determining a property of a mixture in response to spectra associated with the mixture. The method of FIG. 32 may be performed using a processor. Portions of the processor may be within a spectrometer or mixer. Additionally, portions of the processor may be at a separate location from the spectrometer or mixer. The spectra associated with the mixture is obtained by calibrating, at step 605, a spectrometer. In particular, the spectrometer may be a hand-held spectrometer or may be coupled to a mixer, for example, to a mixing container of the mixer. At step 610, one or more components of the spectrometer are positioned with respect to the mixing container. In particular, the one or more components of the spectrometer may be selected from one or more light sources, one or more spectrometer modules, one or more illumination modules, one or more diffusers, one or more reflective elements, one or more light blockers, and any combination thereof. A first ingredient is added to the mixing container at step 615. A second ingredient is added to the mixing container at step 620. At step 625, one or more ingredients are combined into a mixture. The mixture within the mixing container is mixed at step 630. A light blocker is positioned with respect to the mixing container at step 635. A light is directed into the mixture at step 640. At step 645, a portion of the light from the mixture is received. At step 650, spectral data is received. In particular, the spectral data may be received in response to the light that is directed into the mixture. At step 655, the spectral data is provided to a processor.

At step 660, the spectral data is processed. In examples, the spectral data may be processed using smoothing algorithms, noise reduction, derivation, or other processes. At step 665, a property of the mixture is determined. In examples, a property of the mixture is determined in response to the spectral data. At step 670, the mixture is poured from the mixing container. At step 675, one or more steps from steps 605-670 are repeated. In examples, the property of the mixture is received from the processor.

A person of ordinary skill in the art will recognize many variations, alterations and adaptations in response to the disclosure provided herein. For example, the order of the steps of the method can be changed, some of the steps removed, some of the steps duplicated or repeated, some of the steps substituted, and additional steps added as appropriate. Some of the steps may comprise sub-steps. The steps can be performed in any order. Some of the steps may be automated and some of the steps can be manual.

While preferred embodiments of the present disclosure have been shown and described herein, it will be obvious to those skilled in the art that such embodiments are provided by way of example only. Numerous variations, changes, and substitutions will be apparent to those skilled in the art without departing from the scope of the present disclosure. It should be understood that various alternatives to the embodiments of the present disclosure described herein may be employed without departing from the scope of the present invention. Therefore, the scope of the present invention shall be defined solely by the scope of the appended claims and the equivalents thereof.

1. A method for determining a property of a mixture, the method comprising:
mixing a mixture in a mixing container, the mixing container comprising a housing and a mixing component, wherein the mixing the mixture comprises contacting the mixture with the mixing component as the mixing component moves, wherein the mixing component is separate from the housing and movable independent of the housing;
directing a light from a light source into the mixture in the mixing container;
receiving, at a spectrometer module, a portion of the light directed to the mixture in the mixing container, wherein the spectrometer module is positioned at a separation distance away from the light source; and
determining a property of the mixture in response to the received light.

2. The method of claim 1, further comprising:
pouring at least a portion of the mixture out of the mixing container,
wherein the light from the light source is directed into the mixture as the mixture is poured, and the spectrometer module receives the portion of the light from the mixture as the mixture is poured.

3. The method of claim 1, further comprising:
positioning the light source and the spectrometer module within the mixing container.

4. The method of claim 1, wherein a light blocker is located between the light source and the spectrometer module.

5.-9. (canceled)

10. The method of claim 1, wherein the mixing container comprises a light blocker located between the housing of the mixing container and either the light source or the spectrometer module.

11. The method of claim 1, wherein the mixing container comprises a diffuser or a reflective element.

12.-14. (canceled)

15. The method of claim 1, wherein the light source or the spectrometer module is coupled to a lid of the mixing container through a moveable rod.

16.-20. (canceled)

21. The method of claim 1, further comprising measuring a spectrum of the received light and determining the property of the mixture in response to the spectrum.

22. (canceled)

23. The method of claim 1, further comprising calibrating the light source or spectrometer module.

24. (canceled)

25. The method of claim 1, further comprising directing a second light into the mixture, receiving a portion of the second light from the mixture, and measuring a second spectrum of the second received light.

26. The method of claim 1, wherein the separation distance of the light is within a range from 5 millimeters (mm) to 30 mm.

27.-31. (canceled)

32. The method of claim 1, wherein the light comprises a wavelength within a range from 350 nanometers (nm) to 1100 nm.

33. (canceled)

34. The method of claim 1, further comprising repeating the directing a light into the mixture and the receiving a portion of the light from the mixture one or more times.

35.-36. (canceled)

37. The method of claim 34, wherein the directing a light into the mixture and the receiving a portion of the light from the mixture are repeated at a rate of at least 1 per second.

38.-39. (canceled)

40. The method of claim 1, further comprising using a sensor to determine a temperature of the mixture or an orientation of the mixing container.

41. (canceled)

42. The method of claim 1, further comprising measuring a property of the mixture selected from the group consisting of: composition, phase, homogeneity, heterogeneity, stability, solubility, uniformity, density, concentration, consistency, particle size, viscosity, dispersion, miscibility, nutrient content, and any combination thereof.

43.-91. (canceled)

92. The method of claim 1, wherein the mixing container comprises an annular channel and the light source and the spectrometer are arranged to measure the mixture within the annular channel.

93. The method of claim 92, wherein the annular channel is located below the mixing component, and wherein the annular channel is located at a bottom of the mixing container, and wherein the light source directs the light towards the spectrometer module.

94. The method of claim 92, wherein the light source is positioned on an inner wall or outer wall of the annular channel, and wherein the spectrometer module is located on an inner wall or outer wall of the annular channel.

95.-102. (canceled)

103. The method of claim 1, wherein the directing a light, the receiving a portion of the light, or the determining a property of the mixture occurs during the mixing.

104.-120. (canceled)
